(19) United States
(12) Patent Application Publication
(10) Pub. No.: US 2022/0236952 A1
(43) Pub. Date: Jul. 28, 2022

(54) ARITHMETIC APPARATUS AND MULTIPLY-ACCUMULATE SYSTEM

(71) Applicant: SONY GROUP CORPORATION, TOKYO (JP)

(72) Inventor: YASUSHI FUJINAMI, TOKYO (JP)

(21) Appl. No.: 17/596,291

(22) PCT Filed: May 15, 2020
(86) PCT No.: PCT/JP2020/019388

§ 371 Date: Dec. 7, 2021

(30) Foreign Application Priority Data
Jun. 20, 2019 (JP) 2019-114592

(51) Int. Cl. G06F 7/544; G06F 7/523; G06F 7/50; G06N 3/063

(52) U.S. Cl. CPC G06F 7/5443; G06N 3/0635; G06F 7/50; G06F 7/523

(57) ABSTRACT

An arithmetic apparatus includes first and second arithmetic circuit units. Multiply-accumulate signals output from a plurality of output lines of the first arithmetic circuit unit or signals generated on the basis of the multiply-accumulate signals are input into a plurality of input lines of the second arithmetic circuit unit. An extending direction of the plurality of input lines of the first arithmetic circuit unit and an extending direction of the plurality of output lines of the second arithmetic circuit unit are parallel to each other. Assuming that end portions of two endmost output lines of the first arithmetic circuit unit are defined as first and second end portions and end portions of two endmost input lines of the second arithmetic circuit unit are defined as third and fourth end portions, the end portions of the two endmost output lines being located on a side of the second arithmetic circuit unit, the end portions of the two endmost input lines being located on a side of the first arithmetic circuit unit, a position in the first direction of at least one of the first or second end portion a position between a position of the third end portion a position of the fourth end portion. Or, a position in the first direction of at least one of the third or the fourth end portion is between a position of the first end portion and a position of the second end portion.

### TECHNICAL FIELD

The present technology relates to an arithmetic apparatus and a multiply-accumulate system that can be applied to a multiply-accumulate operation using an analog method.

### BACKGROUND ART

Conventionally, a technology for performing a multiply-accumulate operation has been developed. The multiply-accumulate operation is an operation of multiplying each of a plurality of input values by a weight and adding the multiplication results to each other, and is used for, for example, processing of recognizing images, voices, and the like through a neural network or the like.

For example, Patent Literature 1 describes an analog circuit in which multiply-accumulate processing is performed in an analog manner. In this analog circuit, a weight corresponding to each of a plurality of electrical signals is set. Moreover, charges depending on the corresponding electrical signals and weights are respectively output and the output charges are accumulated in a capacitor as appropriate. A value to be calculated, which represents a multiply-accumulate result, is calculated on the basis of the voltage of the capacitor in which the charges are accumulated. Accordingly, it is possible to reduce the power consumption required for the multiply-accumulate operation as compared with, for example, digital processing (paragraphs [0003], [0049] to [0053], and [0062] of specification, FIG. 3, and the like of Patent Literature 1).

### CITATION LIST

### Patent Literature

Patent Literature 1: WO 2018/034163

### DISCLOSURE OF INVENTION

### Technical Problem

The use of such an analog-type circuit is expected to lead to low power consumption of the neural network or the like, and it is desirable to provide a technology capable of improving the accuracy of the multiply-accumulate operation.

In view of the above-mentioned circumstances, it is an object of the present technology to provide an arithmetic apparatus and a multiply-accumulate system, by which the operation accuracy can be improved in an analog-type circuit that performs a multiply-accumulate operation.

### Solution to Problem

In order to accomplish the above-mentioned object, an arithmetic apparatus according to an embodiment of the present technology includes a plurality of arithmetic circuit units.

The plurality of arithmetic circuit units each includes a plurality of input lines and a plurality of output lines.

The plurality of input lines is arranged in parallel using a predetermined direction as an extending direction and electrical signals corresponding to input values are respectively input into the plurality of input lines.

The plurality of output lines is arranged in parallel so as to intersect with the plurality of input lines, using a direction different from the predetermined direction as an extending direction, and each of the plurality of output lines outputs a multiply-accumulate signal representing a sum of product values obtained by multiplying the input values, which are generated on the basis of the electrical signals input into the plurality of input lines, by weight values.

The plurality of arithmetic circuit units includes a first arithmetic circuit unit and a second arithmetic circuit unit.

The multiply-accumulate signals output from the plurality of output lines of the first arithmetic circuit unit or signals generated on the basis of the multiply-accumulate signals output from the plurality of output lines of the first arithmetic circuit unit are input into the plurality of input lines of the second arithmetic circuit unit as the electrical signals corresponding to the input values.

The first direction that is the extending direction of the plurality of input lines of the first arithmetic circuit unit and a second direction that is the extending direction of the plurality of output lines of the second arithmetic circuit unit are configured to be parallel to each other.

Assuming that end portions of two endmost output lines, which are located at endmost positions of the plurality of output lines arranged in parallel in the first arithmetic circuit unit, are defined as a first end portion and a second end portion and end portions of two endmost input lines, which are located at endmost positions of the plurality of input lines arranged in parallel in the second arithmetic circuit unit, are defined as a third end portion and a fourth end portion, the end portions of the two endmost output lines being located on a side of the second arithmetic circuit unit, the end portions of the two endmost input lines being located on a side of the first arithmetic circuit unit,

a position in the first direction of at least one of the first end portion or the second end portion is configured to be a position between a position in the first direction of the third end portion and a position in the first direction of the fourth end portion

or

a position in the first direction of at least one of the third end portion or the fourth end portion is configured to be a position between a position in the first direction of the first end portion and a position in the first direction of the second end portion.

Both the position in the first direction of the first end portion and the position in the first direction of the second end portion may be configured to be positions between the position in the first direction of the third end portion and the position in the first direction of the fourth end portion.

Both the position in the first direction of the third end portion and the position in the first direction of the fourth end portion may be configured to be positions between the position in the first direction of the first end portion and the position in the first direction of the second end portion.

A position in the first direction of at least one of the first end portion or the second end portion may be configured to be a position different from both of the position in the first direction of the third end portion and the position in the first direction of the fourth end portion.

A position in the first direction of at least one of the third end portion or the fourth end portion may be configured to be a position different from both of the position in the first direction of the first end portion and the position in the first direction of the second end portion.

The extending direction of the plurality of output lines of the first arithmetic circuit unit and the extending direction of the plurality of input lines of the second arithmetic circuit unit may be configured to be parallel to each other.

Two arithmetic circuit units of the plurality of arithmetic circuit units, which are in such a relationship that the multiply-accumulate signals output from the plurality of output lines of one arithmetic circuit unit of two arithmetic circuit units or signals generated on the basis of the multiply-accumulate signals output from the plurality of output lines of the one arithmetic circuit unit of the two arithmetic circuit units are input into the plurality of input lines of another arithmetic circuit unit of the two arithmetic circuit units as the electrical signals corresponding to the input values may be configured as the first arithmetic circuit unit and the second arithmetic circuit unit.

In each of the plurality of arithmetic circuit units, the plurality of input lines and the plurality of output lines may be arranged using a predetermined plane as a reference plane. In this case, a first reference plane that is the reference plane of the first arithmetic circuit unit and a second reference plane that is the reference plane of the second arithmetic circuit unit may be positioned on a same plane.

A first reference plane that is the reference plane of the first arithmetic circuit unit and a second reference plane that is the reference plane of the second arithmetic circuit unit may be arranged to be parallel to each other.

A first reference plane that is the reference plane of the first arithmetic circuit unit and a second reference plane that is the reference plane of the second arithmetic circuit unit may be arranged to be perpendicular to each other.

In each of the plurality of arithmetic circuit units, end portions on an input side of the plurality of input lines may be located in a same straight line and end portions on an output side of the plurality of output lines are located on a same straight line. In this case, a straight line direction in which the end portions on the output side of the plurality of output lines of the first arithmetic circuit unit are arranged side by side and a straight line direction in which the end portions on the input side of the plurality of input lines of the second arithmetic circuit unit are arranged side by side may be configured to be parallel to each other.

Pitches of the plurality of output lines arranged in parallel in the first arithmetic circuit unit and pitches of the plurality of input lines arranged in parallel in the second arithmetic circuit unit may be configured to be different from each other.

Each of the plurality of arithmetic circuit units may include a plurality of multiplication units, an accumulation unit, a charging unit, and an output unit.

The plurality of multiplication units generates, on the basis of the electrical signals respectively input into the plurality of input lines, charges corresponding to product values obtained by multiplying the input values by the weight values and outputs the charges to the output lines as the multiply-accumulate signals.

The accumulation unit accumulates the charges corresponding to the product values respectively output to the output lines by the plurality of multiplication units.

The charging unit charges the accumulation unit in which the charges corresponding to the product values are accumulated.

The output unit performs, after the charging unit starts charging, threshold determination on a voltage retained by the accumulation unit with a predetermined threshold, to thereby output a multiply-accumulate result signal including information regarding a timing corresponding to a sum of the product values obtained by multiplying the input values by the weight values.

A positive charge output line and a negative charge output line may be arranged as the output lines. In this case, the plurality of multiplication units may include at least one of a positive weight multiplication unit that generates a positive weight charge corresponding to a product value obtained by multiplying the input value by a positive weight value and outputs the positive weight charge to the positive charge output line as the multiply-accumulate signal or a negative weight multiplication unit that generates a negative weight charge corresponding to a product value obtained by multiplying the input value by a negative weight value and outputs the negative weight charge to the negative charge output line as the multiply-accumulate signal. Moreover, the accumulation unit may include a positive charge accumulation unit capable of accumulating the positive weight charge output to the positive charge output line by the positive weight multiplication unit and a negative charge accumulation unit capable of accumulating the negative weight charge output to the negative charge output line by the negative weight multiplication unit. Moreover, the charging unit may charge the positive charge accumulation unit and the negative charge accumulation unit. Moreover, the output unit may perform threshold determination with respect to each of the positive charge accumulation unit and the negative charge accumulation unit with the predetermined threshold, to thereby output the multiply-accumulate result signal.

A multiply-accumulate system according to an embodiment of the present technology includes the above-mentioned plurality of arithmetic circuit units and a network circuit.

The network circuit is configured by connecting the plurality of arithmetic circuit units.

### BRIEF DESCRIPTION OF DRAWINGS

FIG. 1 A schematic diagram showing a configuration example of an arithmetic apparatus according to an embodiment (one-input one-output configuration).

FIG. 2 A schematic diagram showing a configuration example of an arithmetic apparatus according to an embodiment (two-input two-output configuration).

FIG. 3 A schematic diagram showing an example of an electrical signal to be input (one-input one-output configuration).

FIG. 4 A schematic diagram showing an example of an electrical signal to be input (two-input two-output configuration).

FIG. 5 A schematic diagram showing a configuration example of an arithmetic circuit unit 5 (one-input one-output configuration).

FIG. 6 A schematic diagram showing a configuration example of a neuron circuit (one-input one-output configuration).

FIG. 7 A schematic diagram showing a configuration example of an arithmetic circuit unit 5 (two-input two-output configuration).

FIG. 8 A schematic diagram showing a configuration example of a neuron circuit (two-input two-output configuration).

FIG. 9 A schematic diagram showing an example of an analog circuit according to a PWM method (one-input one-output configuration).

FIG. 10 A diagram for describing a calculation example of a multiply-accumulate result signal by the analog circuit shown in FIG. 9.

FIG. 11 A schematic diagram showing a calculation example of a multiply-accumulate result signal representing a total multiply-accumulate result.

FIG. 12 A schematic diagram showing an example of an analog circuit according to a TACT method (one-input one-output configuration).

FIG. 13 A schematic graph for describing potential of an output line at the end of an input period.

FIG. 14 A schematic diagram showing an example of an analog circuit (two-input two-output configuration).

FIG. 15 A schematic diagram showing an example of a signal pair.

FIG. 16 A schematic circuit diagram showing a configuration example of a synapse circuit (two-input two-output configuration).

FIG. 17 A diagram for describing a calculation example of a multiply-accumulate result signal by the analog circuit shown in FIG. 14.

FIG. 18 A schematic diagram showing an example of positive and negative multiply-accumulate result signals.

FIG. 19 A diagram showing a configuration example of an arithmetic circuit unit in the arithmetic apparatus having the one-input one-output configuration.

FIG. 20 A diagram showing a configuration example of the arithmetic circuit unit in the arithmetic apparatus having the one-input one-output configuration.

FIG. 21 A diagram showing a configuration example of an arithmetic circuit unit in the arithmetic apparatus having the two-input two-output configuration.

FIG. 22 A diagram showing a configuration example of the arithmetic circuit unit in the arithmetic apparatus having the two-input two-output configuration.

FIG. 23 A schematic diagram showing a configuration example of an inference apparatus including the arithmetic apparatus according to the present technology.

FIG. 24 A diagram showing a configuration example of a ReLU circuit.

FIG. 25 A diagram showing a configuration example of an enlargement circuit.

FIG. 26 A timing chart showing an operation timing of the enlargement circuit.

FIG. 27 A timing chart showing an operation example at the time of inference by the inference apparatus shown in FIG. 23.

FIG. 28 A schematic diagram showing a first arithmetic circuit unit and a second arithmetic circuit unit of the inference apparatus.

FIG. 29 A schematic diagram showing an example of an equal-length wiring configuration.

FIG. 30 A schematic diagram showing another example of the equal-length wiring configuration.

FIG. 31 A schematic diagram showing another example of the equal-length wiring configuration.

FIG. 32 A schematic diagram showing an equal-length wiring example in a case where the equal-length wiring configuration is realized.

FIG. 33 A schematic diagram showing another configuration example of the inference apparatus.

FIG. 34 A schematic diagram showing another configuration example of the inference apparatus.

FIG. 35 A timing chart showing an operation example at the time of inference by the inference apparatus shown in FIG. 34.

FIG. 36 A schematic diagram showing variation examples of an arrangement configuration of a plurality of arithmetic circuit units.

FIG. 37 A schematic diagram showing variation examples of the arrangement configuration of the plurality of arithmetic circuit units.

FIG. 38 A schematic diagram showing variation examples of the arrangement configuration of the plurality of arithmetic circuit units.

FIG. 39 A schematic diagram for describing another embodiment of the equal-length wiring configuration.

### MODE(S) FOR CARRYING OUT THE INVENTION

Hereinafter, embodiments according to the present technology will be described with reference to the drawings.

[Configuration of Arithmetic Apparatus]

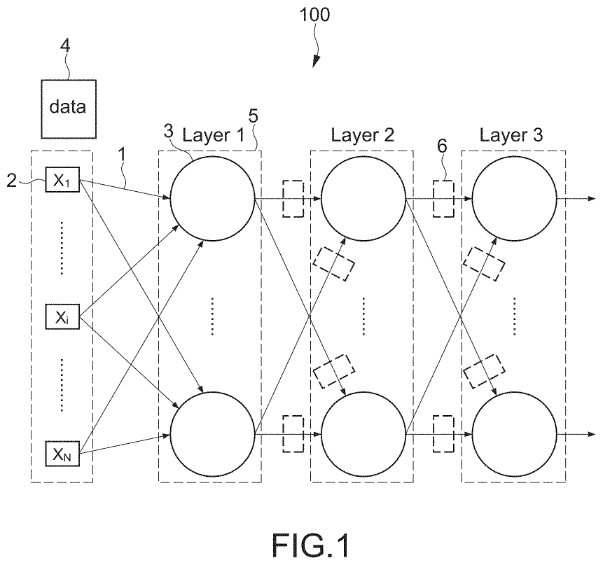

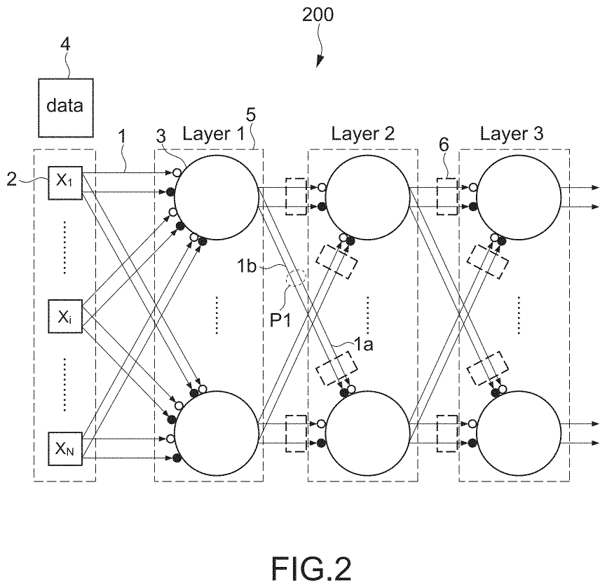

FIGS. 1 and 2 are schematic diagrams showing a configuration example of an arithmetic apparatus according an embodiment of the present technology. An arithmetic apparatus is an analog-type arithmetic apparatus that performs predetermined arithmetic processing including a multiply-accumulate operation. The use of an arithmetic apparatus 100 and an arithmetic apparatus 200 shown in FIGS. 1 and 2 makes it possible to perform arithmetic processing according to a mathematical model such as a neural network, for example.

The arithmetic apparatus 100 shown in FIG. 1 includes a plurality of signal lines 1, a plurality of input units 2, and a plurality of analog circuits 3. Each of the signal lines 1 is a line that transmits a predetermined type of electrical signal.

For example, an analog signal representing a signal value by using an analog amount such as a pulse timing and a pulse width is used as the electrical signal. The directions in which electrical signals are transmitted are schematically shown as the arrows in FIG. 1. In this embodiment, the analog circuits 3 correspond to multiply-accumulate circuits.

For example, the plurality of signal lines 1 is connected to one analog circuit 3. The signal line 1 that transmits an electrical signal to the analog circuit 3 is an input signal line into which an electrical signal is input for the analog circuit 3 to which that signal line 1 is connected.

Moreover, the signal line 1 that transmits an electrical signal output from the analog circuit 3 is an output signal line from which an electrical signal is output for the analog circuit 3 to which that signal line 1 is connected. In this embodiment, the input signal line corresponds to an input line.

The plurality of input units 2 respectively generates a plurality of electrical signals corresponding to input data 4. The input data 4 is, for example, data to be processed using a neural network or the like implemented by the arithmetic apparatus 100. Therefore, it can also be said that each signal value of the plurality of electrical signals corresponding to the input data 4 is an input value to the arithmetic apparatus 100.

For example, arbitrary data such as image data, audio data, and statistical data to be processed by the arithmetic apparatus 100 is used as the input data 4. For example, in a case where image data is used as the input data 4, an electrical signal using a pixel value (RGB value, luminance value, etc.) of each of pixels of the image data as a signal value is generated. In addition, an electrical signal corresponding to the input data 4 may be generated as appropriate in accordance with the type of the input data 4 and the contents of the processing performed by the arithmetic apparatus 100.

The analog circuit 3 is an analog-type circuit that performs a multiply-accumulate operation on the basis of an input electrical signal. The multiply-accumulate operation is, for example, an operation of adding up a plurality of product values obtained by multiplying a plurality of input values by weight values corresponding to input values. Therefore, it can also be said that the multiply-accumulate operation is processing of calculating a sum of the product values (hereinafter, referred to as a multiply-accumulate result).

As shown in FIG. 1, a plurality of input signal lines is connected to a single analog circuit 3 and a plurality of electrical signals is provided to the single analog circuit 3. The plurality of input signal lines and the plurality of analog circuits constitute an arithmetic circuit unit 5 according to this embodiment. Moreover, a plurality of electrical signals is input from each of the input signal lines, and a multiply-accumulate method according to this embodiment is accordingly performed by the multiply-accumulate circuit (analog circuit 3).

Hereinafter, it is assumed that the total number of electrical signals input into one analog circuit 3 is denoted by N. It should be noted that the number N of electrical signals to be input into each analog circuit 3 is set as appropriate for each circuit in accordance with, for example, the model, accuracy, and the like of arithmetic processing.

In the analog circuit 3, for example, wᵢ*xᵢ is calculated which is a product value of an input value xᵢ represented by an electrical signal input from an i-th input signal line and a weight value wᵢ corresponding to the input value xᵢ. Here, i represents a natural number equal to or smaller than N (i=1, 2, . . . , N). The operation of the product value is performed for each electrical signal (input signal line) and N product values are calculated. A value obtained by adding up the N product values is calculated as a multiply-accumulate result (sum of N product values). Therefore, the multiply-accumulate result calculated by one analog circuit 3 is expressed by the following expression.

$${\sum }_{i = 1}^{N} {W}_{i} \cdot {X}_{i} \qquad [ Formula 1 ]$$

The weight value wᵢ is set, for example, in the range of −α≤wᵢ≤+α. Here, a represents an arbitrary real value. Thus, the weight value wᵢ may include a positive weight value wᵢ, a negative weight value wᵢ a zero weight value wᵢ and the like. As described above, by setting the weight value wᵢ to be in a predetermined range, it is possible to avoid the situation where the multiply-accumulate result diverges.

Moreover, for example, the range in which the weight value wᵢ is set may be normalized. In this case, the weight value wᵢ is set to be in a range of −1≤wᵢ≤1. Accordingly, for example, the maximum value, the minimum value, and the like of the multiply-accumulate result can be adjusted, and the multiply-accumulate operation can be performed with a desired accuracy.

In a neural network or the like, a method called binary connect, which sets the weight value wᵢ to be either +α or −α, can be used. The binary connect is used in various fields such as image recognition using a deep neural network (multi-layer neural network).

The use of the binary connect can simplify the setting of the weight value wᵢ without deteriorating the recognition accuracy and the like. In the binary connect, the positive weight value and the absolute value of the negative weight value are fixed to the same value.

As described above, in the binary connect, the weight value wᵢ is binarized into a binary value (±α). Thus, a desired weight value wᵢ can be easily set by changing the weight value wᵢ to be positive or negative, for example. Alternatively, the binarized weight value wᵢ may be normalized and the weight value wᵢ may be set to ±1.

Alternatively, the weight value wᵢ may be multi-valued. In this case, the weight values wᵢ are selected and set from among a plurality of discrete weight value candidates. Examples of the weight value candidates can include an example of (−3, −2, −1, 0, 1, 2, 3) and an example of (1, 2, 5, 10).

Alternatively, normalized weight value candidates (−1, −0.5, 0, 0.5, 1) or the like may be used. Values are selected from among those weight value candidates and are set as the weight values wᵢ. The number of weight value candidates, the method of setting candidate values, and the like are not limited. By making the weight value wᵢ multi-valued, a more versatile neural network or the like can be built, for example.

In addition, the setting range, the setting value, and the like of the weight value wᵢ are not limited, and may be set as appropriate such that desired processing accuracy is realized, for example. For example, the weight value wᵢ may be randomly set.

The input values xᵢ shown in the expression (Formula 1) are, for example, the values of the input data 4 output from the input units 2 and the values of multiply-accumulate results output from the analog circuits 3. Thus, it can also be said that the input units 2 and the analog circuits 3 function as signal sources for outputting the input values xᵢ.

In the example shown in FIG. 1, a single electrical signal (single input value xᵢ) is output from one signal source (input unit 2, analog circuit 3). Therefore, the same electrical signal is input into each of the plurality of signal lines 1 connected to an output side of the one signal source. Moreover, one signal source and the analog circuit 3 into which the electrical signal output from the signal source is input are connected to each other through a single input signal line.

Therefore, for example, an M-number of input signal lines are connected to the analog circuit 3 connected to an M-number of signal sources in the arithmetic apparatus 100 shown in FIG. 1. In this case, the total number N of electrical signals input into the analog circuits 3 is N=M.

As shown in FIG. 1, the arithmetic apparatus 100 has a layered structure in which the plurality of analog circuits 3 is provided in each of a plurality of layers. That is, a plurality of arithmetic circuit units 5 is cascade-connected.

A multi-layer perceptron (MLP)-type neural network or the like, for example, is built by configuring the layered structure of the analog circuits 3. The number of analog circuits provided in each layer, the number of layers, and the like are designed as appropriate such that desired processing can be performed, for example. Hereinafter, the number of analog circuits 3 provided in a j-th layer will be sometimes referred to as Nᵢ.

For example, an N-number of electrical signals generated by an N-number of input units 2 are input into each analog circuit 3 provided in a layer of a first stage (lowest layer). The analog circuits 3 of the first stage calculate multiply-accumulate results related to the input values xᵢ of the input data, and output the calculated multiply-accumulate results to the analog circuits 3 provided in a next layer (second stage) after the non-linear conversion processing.

An N₁-number of electrical signals representing the respective multiply-accumulate results calculated in the first stage are input into the respective analog circuits 3 provided in a second layer (upper layer). Therefore, as viewed from the analog circuits 3 of the second stage, the non-linear conversion processing results of the respective multiply-accumulate results calculated in the first stage are the input values xᵢ of the electrical signals. The analog circuits 3 of the second stage calculate the multiply-accumulate results of the input values xᵢ output from the first stage, and output the calculated multiply-accumulate results to the analog circuits 3 of the upper layer.

In this way, in the arithmetic apparatus 100, the multiply-accumulate results of the analog circuits 3 in the upper layer are calculated on the basis of the multiply-accumulate results calculated by the analog circuits 3 in the lower layer. Such processing is performed multiple times, and the processing results are output from the analog circuits 3 included in the top layer (layer of the third stage in FIG. 1). Accordingly, for example, processing such as image recognition of determining that the object is a cat on the basis of image data (input data 4) obtained by imaging the cat can be performed.

As described above, a desired network circuit can be configured by connecting the arithmetic circuit units 5 including the plurality of analog circuits 3 as appropriate. The network circuit functions as a data flow processing system that performs arithmetic processing by, for example, causing signals to pass therethrough. In the network circuit, various processing functions can be realized by setting, for example, a weight value (synapse connection) as appropriate. With this network circuit, the multiply-accumulate system according to this embodiment is built.

It should be noted that the method of connecting the analog circuits 3 to each other and the like are not limited, and, for example, the plurality of analog circuits 3 may be connected to each other as appropriate such that desired processing can be performed. For example, the present technology can be applied even in a case where the analog circuits 3 are connected to each other so as to configure another structure different from the layered structure.

In the above description, the configuration in which the multiply-accumulate results calculated in the lower layer are input into the upper layer as they are has been described. The present technology is not limited thereto, and, for example, conversion processing or the like may be performed on the multiply-accumulate results. For example, in the neural network model, processing of, for example, performing non-linear conversion on the multiply-accumulate result of each analog circuit 3 by using an activation function and inputting the conversion results to the upper layer is performed.

In the arithmetic apparatus 100, a function circuit 6 or the like that performs non-linear conversion using an activation function on the electrical signal, for example, is used. The function circuit 6 is, for example, a circuit that is provided between a lower layer and an upper layer and that converts a signal value of an input electrical signal as appropriate and outputs an electrical signal corresponding to the conversion result. The function circuit 6 is provided for each of the signal lines 1, for example. The number of function circuits 6, the arrangement of the function circuits 6, and the like are set as appropriate in accordance with, for example, the mathematical model implemented in the arithmetic apparatus 100.

For example, a ReLU function (ramp function) or the like is used as the activation function. The ReLU function outputs the input value xᵢ as it is in a case where the input value xᵢ is 0 or more, for example, and outputs 0 otherwise. For example, the function circuit 6 that implements the ReLU function is connected to each of the signal lines 1 as appropriate. Accordingly, it is possible to realize the processing of the arithmetic apparatus 100.

An enlargement circuit that enlarges the analog signal output as the multiply-accumulate result may be further provided.

In the arithmetic apparatus 200 shown in FIG. 2, the signal line 1 includes a positive signal line 1a and a negative signal line 1b. The positive and negative signal lines 1a and 1b are arranged as a pair. The positive and negative signal lines 1a and 1b are used as a pair of signal lines 1. Hereinafter, the pair of signal lines 1 constituted by the positive and negative signal lines 1a and 1b will be referred to as a signal line pair P1. It should be noted that in FIG. 2, the positive signal line 1a is a signal line 1 connected to the white circle connection point and the negative signal line 1b is a signal line 1 connected to the black circle connection point.

The signal line pair P1 transmits a signal pair corresponding to a single input value (or output value). The signal pair is a pair of electrical signals input into the positive and negative signal lines 1a and 1b, respectively. The respective signal values of this pair of electrical signals represent the input value. That is, it can also be said that the signal line pair P1 functions as a single transmission path that transmits the input value.

An input value x is expressed using a sum of a positive value x⁺ and a negative value x⁻. Here, the positive value x⁺ is a real number equal to or larger than 0 (x⁺ 0). Moreover, the negative value x⁻ is a real number equal to or smaller than 0 (x⁻≤0). Thus, the input value x is expressed as x=x⁺+x⁻ that is the sum of the positive value x⁺ and the negative value x⁻. Here, with an absolute value of the negative value x⁻, the input value x is expressed as x=x⁺−|x⁻ | that is a difference between the positive value x⁺ and the absolute value of the negative value x⁻. In this manner, the input value x can be expressed using a difference between the two positive real numbers.

In this embodiment, the signal pair includes a positive signal and a negative signal. The positive signal is an electrical signal having the positive value x⁺ as the signal value. The positive signal is input into the positive signal line 1a. The negative signal is an electrical signal having the absolute value |x⁻ | of the negative value x⁻ as the signal value. The negative signal is input into the negative signal line 1b. Thus, the positive and negative signals included in the signal pair are electrical signals both representing the positive real numbers.

Thus, in this embodiment, the input value x expressed using the signal pair is the difference between the signal value (positive value x⁺) of the positive signal input into the positive signal line 1a and the signal value (negative value x⁻) of the negative signal input into the negative signal line 1b. In other words, the positive and negative signals (signal pair) are generated such that a value obtained by subtracting the signal value of the negative signal from the signal value of the positive signal is the input value x.

As shown in FIG. 2, a plurality of signal line pairs P1 is connected to a single analog circuit 3. The signal line pair P1 that transmits the signal pair to the analog circuit 3 is an input signal line pair (pair of input signal lines) into which the signal pair is input for the analog circuit 3 to which that signal line pair P1 is connected.

Moreover, the signal line pair P1 that transmits the signal pair output from the analog circuit 3 is an output signal line pair (pair of output signal lines) from which the signal pair is output for the analog circuit 3 to which that signal line pair P1 is connected. In this embodiment, the input signal line pair corresponds to an input line pair.

The plurality of input units 2 each generates a signal pair corresponding to the value (input value x) of the input data 4. The input data 4 is, for example, data to be processed using a neural network or the like implemented by the arithmetic apparatus 100. Therefore, it can also be said that each signal value of the plurality of electrical signals corresponding to the input data 4 is an input value to the arithmetic apparatus 100. Moreover, it can also be said that the signal pair is an input pair.

For example, arbitrary data such as image data, audio data, and statistical data to be processed by the arithmetic apparatus 100 is used as the input data 4. For example, in a case where image data is used as the input data 4, a signal pair corresponding to a pixel value (RGB value, luminance value, etc.) of each of pixels of the image data as a signal value is generated. In addition, a signal pair corresponding to the input data 4 may be generated as appropriate in accordance with the type of the input data 4 and the contents of the processing performed by the arithmetic apparatus 100.

The analog circuit 3 is an analog-type circuit that performs a multiply-accumulate operation on the basis of a plurality of input signal pairs. The multiply-accumulate operation is, for example, an operation of adding up a plurality of product values obtained by multiplying a plurality of input values by weight values corresponding to input values. Therefore, it can also be said that the multiply-accumulate operation is processing of calculating a sum of the product values (a multiply-accumulate result).

Assuming that the total number of signal pairs (input signal line pairs) input into the single analog circuit 3 is denoted by N in the arithmetic apparatus 200, the total number of input signal lines connected to the analog circuit 3 is 2×N.

Moreover, in a multiply-accumulate operation using a signal pair, a signal value (positive value xᵢ⁺) of a positive signal input into the positive signal line 1a and a signal value (negative value xᵢ⁻) of a negative signal input into the negative signal line 1a are each multiplied by the corresponding weight value to calculate two product values. The product value wᵢ*xᵢ of the input value xᵢ and the weight value wᵢ is expressed using those two product values.

As shown in FIG. 2, in the arithmetic apparatus 200, the pair of electrical signals (signal pair) corresponding to the input value xᵢ is output from one signal source (input unit 2, analog circuit 3) via the signal line pair P1. That is, the same signal pair is input into each signal line pair P1 connected to an output side of the one signal source. Moreover, the one signal source and the analog circuit 3 into which an electrical signal output from that signal source is input are connected to each other through a single line pair P1 (input signal line pair).

Therefore, for example, an M-number of input signal line pairs are connected to the analog circuit 3 connected to an M-number of signal sources in the arithmetic apparatus 200 shown in FIG. 2. In this case, the total number N of signal pairs input into the analog circuits 3 is N=M. It should be noted that the total number of electrical signals input into the analog circuit 3, i.e., the total number of signal lines 1 connected to an input side is 2×M.

In the arithmetic apparatus 100 shown in FIG. 1, a single signal corresponding to a single input value xᵢ is input and a single signal is output as the multiply-accumulate result output from the analog circuit 3. In the arithmetic apparatus 200 shown in FIG. 2, a pair of two signals (signal pair) corresponding to a single input value xᵢ is input and a pair of two signals (signal pair) is output as the multiply-accumulate result output from the analog circuit 3.

Hereinafter, the arithmetic apparatus 100 will be referred to as an arithmetic apparatus having a one-input one-output configuration in some cases. Moreover, the arithmetic apparatus 200 will be referred to as an arithmetic apparatus having a two-input two-output configuration in some cases.

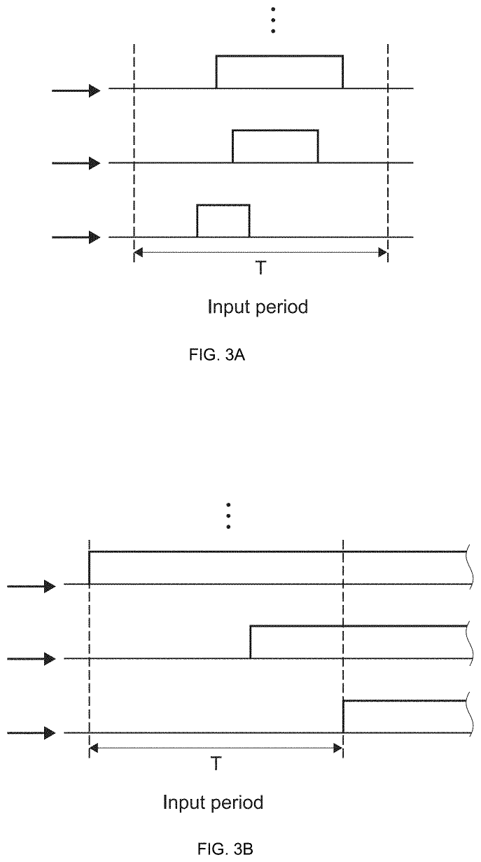

FIG. 3 is a schematic diagram showing an example of the electrical signal input into the analog circuit 3 of the arithmetic apparatus 100 having the one-input one-output configuration.

In each of FIGS. 3A and B, a graph representing a waveform of a plurality of electrical signals is schematically shown. The horizontal axis of the graph indicates the time axis and the vertical axis indicates the voltage of the electrical signal.

An exemplary waveform of an electrical signal according to a pulse width modulation (PWM) method is shown in FIG. 3A. The PWM method is a method of representing an input value xᵢ by using a pulse width of a pulse waveform, for example.

That is, in the PWM method, the pulse width of the electrical signal is a length depending on the input value xᵢ. Typically, the longer the pulse width, the higher the input value xᵢ.

Moreover, the electrical signal is input into the analog circuit 3 within a predetermined input period T. More specifically, the respective electrical signals are input into the analog circuits 3 such that the pulse waveforms of the electrical signals fall in the input period T.

Therefore, the maximum value of the pulse width of the electrical signal is similar to the input period T. It should be noted that the timing at which each pulse waveform (electrical signal) is input and the like are not limited as long as the pulse waveform falls in the input period T.

In the PWM method, for example, a duty ratio Rᵢ (=τᵢ/T) of the pulse width Ti to the input period T can be used to normalize the input value xᵢ. That is, the normalized input value xᵢ is represented as the input value xᵢ=the duty ratio Rᵢ.

It should be noted that the method of associating the input value xᵢ with the pulse width τᵢ is not limited and, for example, the pulse width τᵢ representing the input value xᵢ may be set as appropriate such that the calculation processing or the like can be performed with a desired accuracy.

In a case where the electrical signal according to the PWM method is used, a time-axis analog multiply-accumulate operation using the analog circuit 3 according to the PWM method can be performed.

In FIG. 3B, an exemplary waveform of the electrical signal of a spike timing method (hereinafter, referred to as TACT method) is shown.

The TACT method is a method of representing an input value xᵢ by using the rising timing of the pulse, for example. For example, a pulse is input at a timing corresponding to the input value by using a predetermined timing as a reference.

The electrical signal is input into the analog circuit 3 within the predetermined input period T. The input value xᵢ is represented by the input timing of the pulse within this input period T.

For example, a largest input value xᵢ is represented by a pulse input at the same time as the start of the input period T. A smallest input value xᵢ is represented by a pulse input at the same time as the end of the input period T.

It can also be said that the input value xᵢ is represented by the duration from the input timing of the pulse to the end timing of the input period T.

For example, the largest input value xᵢ is represented by a pulse whose duration from the input timing of the pulse to the end timing of the input period T is equal to the input period T. The smallest input value xᵢ is represented by a pulse whose duration from the input timing of the pulse to the end timing of the input period T is 0.

It should be noted that in FIG. 3B, a continuous pulse signal that rises to a timing corresponding to the input value and keeps the ON level until the multiply-accumulate result is obtained is used as the electrical signal according to the TACT method. The present technology is not limited thereto, and a rectangular pulse or the like having a predetermined pulse width may be used as the electrical signal according to the TACT method.

In a case where the electrical signal according to the TACT method is used, a time-axis analog multiply-accumulate operation using the analog circuit 3 according to the TACT method can be performed.

As illustrated in FIGS. 3A and B, a pulse signal whose duration of the ON time with respect to the input period T corresponds to the input value can be used as an electrical signal corresponding to the input value. It should be noted that hereinafter, the description will be made assuming that the input value xᵢ represented by each electrical signal is a variable of 0 or more and 1 or less.

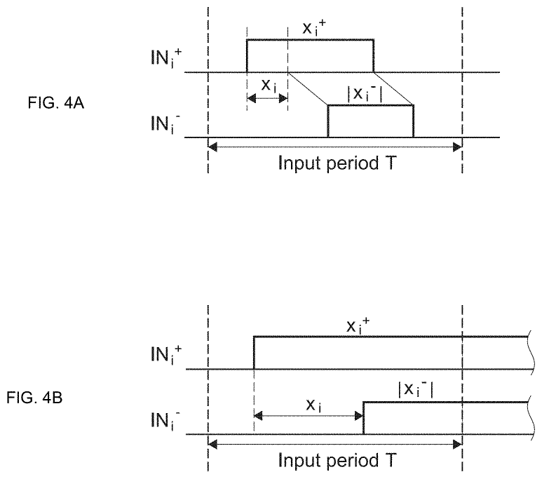

FIG. 4 is a schematic diagram showing an example of the signal pair input into the analog circuit 3 of the arithmetic apparatus 200 having the two-input two-output configuration. FIGS. 4A and B each schematically show a graph representing waveforms of the pair of electrical signals (signal pair).

In FIG. 4 (FIG. 4B), the upper graph represents a waveform of an electrical signal (positive signal IN⁺) input into the positive signal line 1a. Moreover, the lower graph represents a waveform of an electrical signal (negative signal IN⁻) input into the negative signal line 1b. The horizontal axis of the graph indicates the time axis and the vertical axis indicates the voltage of the electrical signal.

FIG. 4A shows an example of a waveform of the electrical signal according to the PWM method. In the PWM method, a positive signal INᵢ⁺ is an electrical signal having a pulse width corresponding to a positive value xᵢ⁺ that is its signal value. Moreover, a negative signal INᵢ⁻ is an electrical signal having a pulse width corresponding to an absolute value |xᵢ⁻ | of a negative value x⁻ that is its signal value. It should be noted that the positive signal INᵢ⁺ and the negative signal INᵢ⁻ may be input at different timings.

Moreover, the input value xᵢ of the signal pair is a value obtained by subtracting the pulse width of the negative signal INᵢ⁻ from the pulse width of the positive signal INᵢ⁺. Thus, in the signal pair according to the PWM method, a difference between the pulse widths of the respective electrical signals (positive signal INᵢ⁺ and negative signal INᵢ⁻) input into the positive and negative signal lines 1a and 1b represents the input value xᵢ.

FIG. 4B shows an example of a waveform of the electrical signal according to the TACT method. In the TACT method, the positive signal INᵢ⁺ is an electrical signal whose pulse is input at a timing corresponding to a positive value xᵢ⁺ that is its signal value. Moreover, the negative signal INᵢ⁻ is an electrical signal whose pulse is input at a timing corresponding to an absolute value of a negative value xᵢ⁻ that is its signal value.

The input value xᵢ of the signal pair is represented by the difference between the positive value xᵢ⁺ and the absolute value of the negative value xᵢ⁻. Thus, the input value xᵢ is a value obtained by subtracting the input timing of the pulse of the negative signal INᵢ⁻ from the input timing of the pulse of the positive signal INᵢ⁺. In this manner, in the signal pair according to the TACT method, the difference between the input timings of the pulses input into the positive and negative signal lines 1a and 1b represents the input value xᵢ.

It should be noted that in FIG. 4B, continuous pulse signals each of which rises to a timing corresponding to the signal value and keeps the ON level until the multiply-accumulate result is obtained, are used as the electrical signals (positive and negative signals) according to the TACT method. The present technology is not limited thereto, and a rectangular pulse or the like having a predetermined pulse width may be used as the electrical signal according to the TACT method.

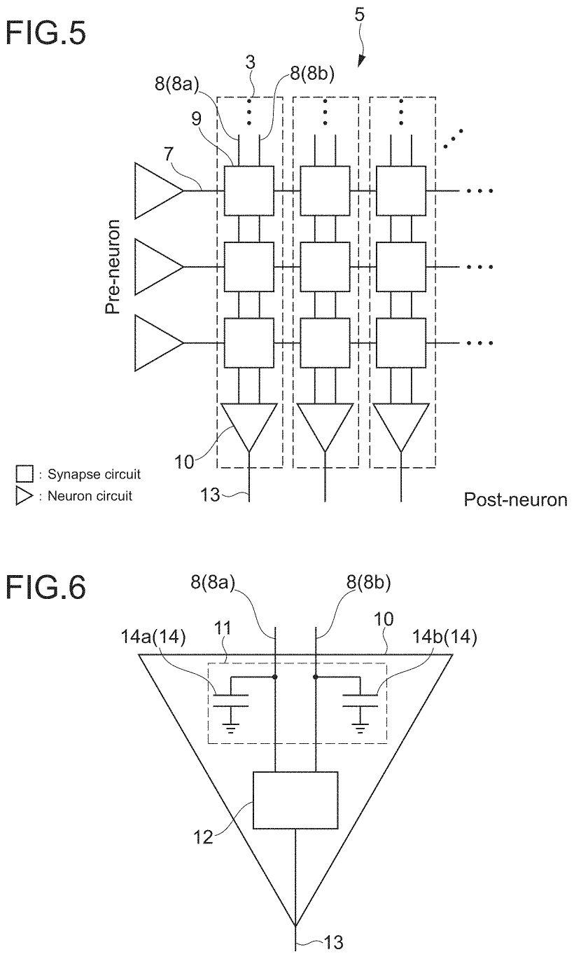

FIG. 5 is a schematic diagram showing a configuration example of the arithmetic circuit unit 5 provided as one layer in the arithmetic apparatus 100 having the one-input one-output configuration.

The arithmetic circuit unit 5 includes a plurality of input signal lines 7 and a plurality of analog circuits 3.

A signal corresponding to the input value xᵢ is input into each of the plurality of input signal lines 7 within the predetermined input period T. For example, the electrical signal according to the PWM method or the TACT method described with reference to FIG. 3 is input into each input signal line 7 during the input period T.

Each analog circuit 3 includes a pair of output lines 8, a plurality of synapse circuits 9, and a neuron circuit 10.

As shown in FIG. 5, one analog circuit 3 is configured to extend in a predetermined direction (vertical direction in the figure). A plurality of such analog circuits 3 extending in the vertical direction are arranged in parallel in the horizontal direction, such that the arithmetic circuit unit 5 is configured as one layer. Hereinafter, it is assumed that the analog circuit 3 disposed on the leftmost side in the figure is a first analog circuit 3.

The pair of output lines 8 is spaced apart from each other. The pair of output lines 8 includes a positive charge output line 8a and a negative charge output line 8b.

Each of the positive charge output line 8a and the negative charge output line 8b is connected to the neuron circuit 10 via the plurality of synapse circuits 9.

The plurality of synapse circuits 9 is arranged respectively corresponding to the plurality of input signal lines 7. A single input signal line 7 is connected to a single synapse circuit 9. The number of synapse circuits 9 provided in the single analog circuit 3 is set to be equal to or smaller than the number of input signal lines 7, for example. That is, the synapse circuit 9 does not need to be connected to all the input signal lines 7.

In this manner, the plurality of synapse circuits 9 is respectively connected to at least some of the plurality of input signal lines 7. The input signal lines 7 to which the synapse circuits 9 are connected (i.e., the arrangement of the synapse circuits 9) is selected as appropriate by, for example, using a mathematical model, a simulation, or the like implemented in the arithmetic apparatus 100.

The synapse circuit 9 calculates a product value (wᵢ*xᵢ) of the input value xᵢ represented by the electrical signal and the weight value wᵢ. Specifically, a charge (current) corresponding to the product value is output to either the positive charge output line 8a or the negative charge output line 8b as a multiply-accumulate signal.

As will be described later, either the positive weight value wᵢ⁺ or the negative weight value wᵢ⁻ is set to the synapse circuit 9. For example, a positive weight charge corresponding to the product value of the positive weight value wᵢ⁺ is output to the positive charge output line 8a. Moreover, for example, a negative weight charge corresponding to the product value of the negative weight value wᵢ⁻ is output to the negative charge output line 8b.

It should be noted that in the synapse circuit 9, a charge with the same sign (e.g., a positive charge) is output as the charge corresponding to the product value irrespective of whether the weight value wᵢ is positive or negative. That is, the positive weight charge and the negative weight charge become charges with the same sign.

In this way, the synapse circuits 9 are each configured to output the charge corresponding to the multiplication result to the different output line 7a or 7b in accordance with the sign of the weight value wᵢ.

In this embodiment, the plurality of synapse circuits 9 functions as a plurality of multiplication units that each generates, on the basis of an electrical signal input into each of the plurality of input lines, a charge corresponding to a product value obtained by multiplying an input value by a weight value and outputs the charge to the output line as the multiply-accumulate signal.

In this embodiment, the single input signal line 7 and the pair of output lines 8 are connected to the single synapse circuit 9. That is, a single electrical signal is input into the single synapse circuit 9 and a charge corresponding to the product value calculated on the basis of the input electrical signal is output to either the charge output line 8a or 8b. Thus, the synapse circuit 9 is a one-input two-output circuit connected to the single input signal line 7 and the pair of output lines 8 (positive charge output line 8a and the negative charge output line 8b).

In one analog circuit 3, the plurality of synapse circuits 9 is arranged along the pair of output lines 8. Each synapse circuits 9 is connected in parallel to the positive charge output line 8a (negative charge output line 8b). Hereinafter, it is assumed that the synapse circuit 9 disposed on a most downstream side (side connected to the neuron circuit 10) is a first synapse circuit.

As shown in FIG. 5, the plurality of input signal lines 7 is arranged so as to intersect with the pair of output lines 8 of each of the plurality of analog circuits 3. Typically, the input signal line 7 is provided to be orthogonal to each output line 8. That is, the arithmetic apparatus 100 has a crossbar configuration in which the input signal lines 7 and the output lines 8 cross each other. With the crossbar configuration, the analog circuits 3 and the like, for example, can be integrated at high density.

Moreover, in the arithmetic apparatus 100, j-th synapse circuits 9 included in the respective analog circuits 3 are connected in parallel to a j-th input signal line 7. Therefore, similar electrical signals are input into the synapse circuits 9 connected to the same input signal line 7. Accordingly, a configuration in which one signal source included in the lower layer is connected to a plurality of analog circuits 3 included in the upper layer can be implemented.

It should be noted that in the example shown in FIG. 5, the analog circuit 3 (pre-neuron) included in the lower layer is schematically shown as a signal source that inputs an electrical signal into each of the input signal lines 7. The present technology is not limited thereto, and, for example, the crossbar configuration can be used also in a case where the input unit 2 is used as the signal source.

As described above, in the arithmetic apparatus 100, the plurality of analog circuits 3 is connected in parallel to each of the plurality of input signal lines 7. Accordingly, for example, it is possible to input an electrical signal in parallel into each analog circuit 3 (each synapse circuit 9) and to achieve arithmetic processing at high speed. As a result, it is possible to exhibit excellent operation performance.

The neuron circuit 10 calculates a multiply-accumulate result shown in the expression (Formula 1) on the basis of the product values calculated by the synapse circuits 9. Specifically, the neuron circuit 10 outputs an electrical signal representing the multiply-accumulate result as a multiply-accumulate result signal on the basis of charges input via the pair of output lines 8.

FIG. 6 is a schematic diagram showing a configuration example of the neuron circuit 10. The neuron circuit 10 includes an accumulation unit 11 and a signal output unit 12. FIG. 6 shows a two-input one-output neuron circuit 10 connected to a pair of output lines 8 and a single output signal line 13.

The accumulation unit 11 accumulates charges output to the pair of output lines 8 by the plurality of synapse circuits 9. The accumulation unit 11 includes two capacitors 14a and 14b. The capacitor 14a is connected between the positive charge output line 8a and the GND. Moreover, the capacitor 14b is connected between the negative charge output line 8b and the GND.

Therefore, charges flowing in from the positive charge output line 8a and the negative charge output line 8b are respectively accumulated in the capacitors 14a and 14b. It should be noted that the capacitors 14a and 14b are set to have the same capacitance.

For example, at a timing at which the input period T of electrical signals ends, the charges accumulated in the capacitor 14a are a sum total σ⁺ of positive weight charges each corresponding to the product value of the positive weight value wᵢ⁺.

Also, the charges accumulated in the capacitor 14b are a sum total σ⁻ of negative weight charges corresponding to the product value of the negative weight value wᵢ⁻.

For example, in a case where the positive weight charges are accumulated in the capacitor 14a, the potential of the positive charge output line 8a with reference to the GND increases. Therefore, the potential of the positive charge output line 8a is a value depending on the sum total σ⁺ of the charges each corresponding to the product value of the positive weight value wᵢ⁺. It should be noted that the potential of the positive charge output line 8a corresponds to the voltage retained by the capacitor 14a.

Similarly, in a case where the negative weight charges are accumulated in the capacitor 14b, the potential of the negative charge output line 8b with reference to the GND increases. Therefore, the potential of the negative charge output line 8b is a value depending on the sum total σ⁻ of the charges each corresponding to the product value of the negative weight value wᵢ⁻. It should be noted that the potential of the negative charge output line 8b corresponds to the voltage retained by the capacitor 14b.

The signal output unit 12 outputs a multiply-accumulate result signal representing a sum of the product values (wᵢ⁺*xᵢ) on the basis of the charges accumulated in the accumulation unit 11. The multiply-accumulate result signal is, for example, a signal representing a total multiply-accumulate result, which is a sum of product values of all positive and negative weight values wᵢ and input values xᵢ. For example, the multiply-accumulate result represented by the expression (Formula 1) can be written as follows.

$${\sum }_{i = 1}^{N} {w}_{i} {x}_{i} = {\sum }_{i = 1}^{{N}^{+}} {w}_{i}^{+} {x}_{i} - {\sum }_{i = 1}^{{N}^{-}} \vert {w}_{i}^{-} \vert {x}_{i} \qquad [ Formula 2 ]$$

Here, N⁺ and N⁻ are the total number of positive weight values wᵢ⁺ and the total number of negative weight values wᵢ respectively. As shown in the expression (Formula 2), the total multiply-accumulate result can be calculated as a difference between a multiply-accumulate result of positive weight charges, which is a sum total of product values (wᵢ⁺*xᵢ) of the positive weight values wᵢ⁺, and a multiply-accumulate result of negative weight charges, which is a sum total of product values (|wᵢ⁻|*xᵢ) of the negative weight values wᵢ⁻.

In the example shown in FIG. 6, the signal output unit 12 generates one signal representing the total multiply-accumulate result, for example, as the multiply-accumulate result signal. Specifically, by referring to the charges accumulated in the accumulation unit 11 (capacitors 14a and 14b) as appropriate, a positive multiply-accumulate result and a negative multiply-accumulate result are calculated, and the total multiply-accumulate result is calculated on the basis of the difference therebetween.

The method of referring to the charges accumulated in the accumulation unit 11 is not limited. As an example, a method of detecting charges accumulated in one capacitor 14 will be described.

In a case where the electrical signal according to the PWM method illustrated in FIG. 3A is used, the charges each corresponding to the product value are accumulated in the capacitor 14 within the input period T. That is, the accumulation of charges each corresponding to the product value does not occur before and after the input period T.

For example, after the input period T ends, the capacitor 14 is charged at a predetermined charging speed. At this time, a comparator or the like is used to detect a timing at which the potential of the output line to which the capacitor 14 is connected reaches a predetermined threshold potential.

For example, as more charges are accumulated at the time of starting charging, the timing at which the potential reaches the threshold potential becomes earlier. Therefore, the charges (multiply-accumulate result) accumulated within the input period T can be represented on the basis of the timing. It should be noted that the charging speed can be expressed by, for example, a charge amount per unit time, and can also be referred to as a charging rate.

It should be noted that this threshold determination corresponds to increasing the voltage retained by the capacitor 14 by charging and detecting a timing at which the threshold voltage is reached.

In a case where the electrical signal according to the TACT method illustrated in FIG. 3B is used, charges are accumulated in the capacitor 14 because the ON level is maintained also after the input period T ends. For this charge accumulation, a timing at which the potential of the output line to which the capacitor 14 is connected reaches the predetermined threshold potential is detected by using the comparator or the like.

For example, as more charges are accumulated at the end of input period T, the timing at which the potential reaches the threshold potential becomes earlier. Therefore, the charges (multiply-accumulate result) accumulated within the input period T can be represented on the basis of the timing.

It should be noted that this threshold determination corresponds to detecting a timing at which the voltage retained by the capacitor 14 reaches the threshold voltage.

For example, a timing to represent the multiply-accumulate result is detected by performing such threshold determination. The multiply-accumulate result signal related to positive weight charges, the multiply-accumulate result signal related to negative weight charges, or the total multiply-accumulate result signal is generated as appropriate on the basis of the detection result.

In addition, each multiply-accumulate result may be calculated by directly reading the potential of the capacitor 14 when the input period T ends, for example.

In this embodiment, the multiply-accumulate result signal is a signal including information regarding the timing, which corresponds to the sum of the product values obtained by multiplying the input values by the weight values.

It should be noted that the voltage depending on the accumulated positive weight charges and the voltage depending on the accumulated negative weight charges may be each amplified in order to generate the multiply-accumulate result signal. Moreover, the multiply-accumulate result signal may be generated by amplifying the differential voltage between the voltage depending on the accumulated positive weight charges and the voltage depending on the accumulated negative weight charges. For example, a differential amplifier or the like having an arbitrary configuration may be provided in the neuron circuit 10.

In this embodiment, the neuron circuit 10 accumulates charges corresponding to the product values generated by the plurality of multiplication units and outputs a multiply-accumulate result signal representing a sum of the product values on the basis of the accumulated charges.

The accumulation unit 11 included in the neuron circuit 10 functions as an accumulation unit that accumulates a charge corresponding to a product value output to the output line by each of the plurality of multiplication units.

Moreover, the capacitor 14a and the capacitor 14b function as a positive charge accumulation unit and a negative charge accumulation unit.

Moreover, in this embodiment, a charging unit is configured and charges, after the input period T, the accumulation unit 11 (capacitors 14) in which charges corresponding to product values are accumulated.

It should be noted that in a case where the electrical signal according to the TACT method is used, accumulating charges in the capacitors 14 with pulse signals whose ON level is maintained is also included in charging according to the present technology.

The signal output unit 12 functions as an output unit that performs, after the charging unit starts charging, threshold determination on the voltage retained by the accumulation unit 11 with a predetermined threshold value, to thereby output a multiply-accumulate result signal including the information regarding the timing, which corresponds to the sum of the product values obtained by multiplying the input values by the weight values.

The signal output unit 12 performs threshold determination with respect to each of the positive charge accumulation unit and the negative charge accumulation unit, to thereby output the multiply-accumulate result signal.

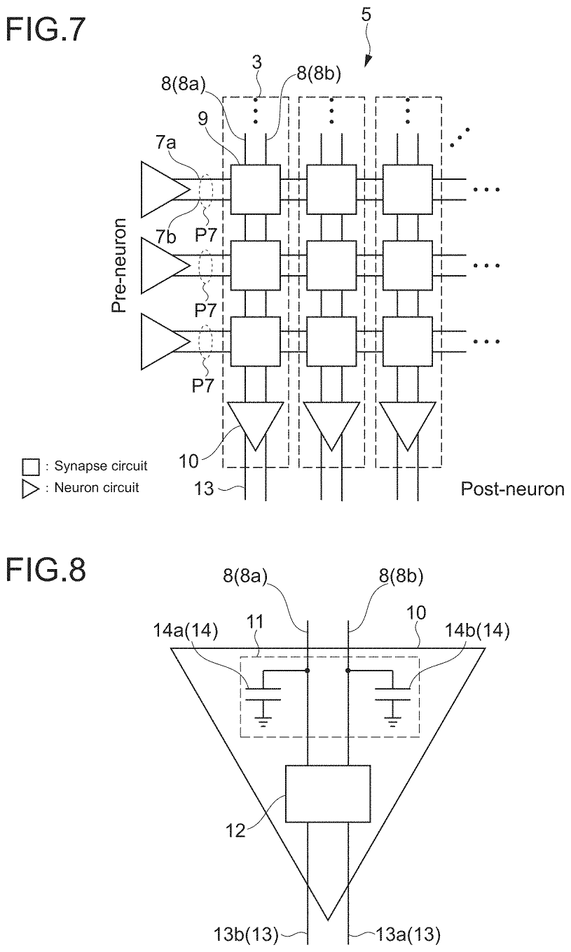

FIG. 7 is a schematic diagram showing a configuration example of the arithmetic circuit unit 5 provided as one layer in the arithmetic apparatus 200 having the two-input two-output configuration.

The arithmetic circuit unit 5 includes a plurality of input signal line pairs P7 and a plurality of analog circuits 3.

A signal pair corresponding to the input value xᵢ is input into each of the plurality of input signal line pairs P7 within the predetermined input period T. For example, the signal pair according to the PWM method or the TACT method described with reference to FIG. 4 is input into each input signal line pair P7 during the input period T.

Each input signal line pair P7 includes a positive input signal line 7a and a negative input signal line 7b. The positive input signal line 7a is a signal line into which a positive signal is input. The negative input signal line 7b is a signal line into which a negative signal is input. In this embodiment, the positive input signal line 7a corresponds to a positive input line and the negative input signal line 7b corresponds to a negative input line.

The synapse circuit 9 calculates a product value (wᵢ*xᵢ) of the input value xᵢ represented by the signal pair and the weight value wᵢ. More specifically, the product value (wᵢ*xᵢ) is calculated by multiplying each of the respective signal values (the positive value xᵢ⁺ and the absolute value |xᵢ⁻ | of the negative value xᵢ⁻) of the positive and negative signals included in the signal pair by the corresponding weight value.

A positive weight value vᵢ⁺ and a negative weight value vᵢ⁻ are respectively set to the plurality of synapse circuits 9. Here, the positive weight value vᵢ⁺ is a positive real number (vᵢ⁺>0). Moreover, the negative weight value vᵢ⁻ is a negative real number (vᵢ⁻<0).

Thus, it can be said that the synapse circuit 9 is a weight pair to which the positive and negative weight values vᵢ⁺ and vᵢ⁻ are set.

The synapse circuit 9 calculates a product value of a signal value of one electrical signal included in the signal pair and the positive weight value vᵢ⁺.

Moreover, the synapse circuit 9 calculates a product value of a signal value of the other electrical signal and the negative weight value v⁻. Specifically, the synapse circuit 9 generates each of charges (currents) corresponding to the respective product values.

An electrical signal to be multiplied by the positive weight value vᵢ⁺ is set as appropriate for each synapse circuit 9. Moreover, an electrical signal that is not the electrical signal set to be multiplied by the positive weight value vᵢ⁺ is to be multiplied by the negative weight value vᵢ⁻. Hereinafter, the product value of the positive weight value vᵢ⁺ will be referred to as a positive weight product value and the charge corresponding to the positive weight product value will be referred to as a positive weight charge. Moreover, the product value of the negative weight value vᵢ⁺ will be referred to as a negative weight product value, and the charge corresponding to the negative weight product value will be referred to as a negative weight charge.

As described above, the synapse circuit 9 is capable of generating each of a positive weight charge corresponding to a positive weight product value obtained by multiplying a signal value of one signal of a signal pair input into the input signal line pair P7 connected thereto by the positive weight value vᵢ⁺, and a negative weight charge corresponding to a negative weight product value obtained by multiplying a signal value of the other signal by the negative weight value vᵢ⁻.

It should be noted that in the synapse circuit 9, a charge with the same sign (e.g., a positive charge) is output as the charge corresponding to each product value irrespective of whether the weight value is positive or negative. That is, the positive weight charge and the negative weight charge are charges with the same sign.

Thus, it can be considered that in an actual circuit, the absolute value |vᵢ⁻| of the negative weight value vᵢ⁻ is multiplied as the negative weight value vᵢ⁻, for example. Since the positive and negative weight values can be thus handled as the values with the same sign, the circuit configuration can be simplified.

In this embodiment, the positive weight value vᵢ⁺ and the absolute value |vᵢ⁻| of the negative weight value vᵢ⁻ are set to be equal to each other for each of the plurality of synapse circuits 9.

Specifically, the positive weight value vᵢ⁺ and the absolute value |vᵢ⁻| of the negative weight value vᵢ⁻ are both set to be equal to each other as an absolute value |wᵢ| of the weight value wᵢ. That is, each weight value satisfies the relationship of |wᵢ|=vᵢ⁺=|vᵢ⁻|. Hereinafter, the weight value wᵢ will be referred to as a paired weight value wᵢ in some cases.

In the synapse circuit 9, either a paired weight value wᵢ⁺ that is a positive value or a paired weight value wᵢ⁻ that is a negative value is set as the paired weight value wᵢ.

The positive and negative paired weight values wᵢ⁺ and wᵢ⁻ can be set by relating the signal pair (positive and negative signals) to the weight pair (positive weight values) as appropriate.

Hereinafter, the synapse circuit 9 to which the positive paired weight value wᵢ⁺ is set will be referred to as a positive synapse circuit 9a and a synapse circuit 9 to which the negative paired weight value wᵢ⁻ is set will be referred to as a negative synapse circuit 9b.

The positive synapse circuit 9a generates a positive weight charge by multiplying the signal value (xᵢ⁺) of the positive signal by the positive weight value vᵢ⁺ and generates a negative weight charge by multiplying the signal value (|xᵢ⁻|) of the negative signal by the negative weight value Thus, the positive weight charge and the negative weight charge are charges respectively corresponding to the positive weight product value (vᵢ⁺*xᵢ⁺) and the negative weight product value (|vᵢ⁻|*xᵢ⁻).

In this case, a difference Δ⁺ between the positive weight product value and the negative weight product value is expressed as follows.

Δ⁺=vᵢ⁺*xᵢ⁺−|vᵢ⁻|*|xᵢ⁻|=|wᵢ|(xᵢ⁺+xᵢ⁻)=wᵢ⁺*xᵢ

Thus, the difference Δ⁺ is the product value wᵢ⁺*xᵢ of the positive paired weight value wᵢ⁺ and the input value xᵢ. That is, in the positive synapse circuit 9a, the product value wᵢ⁺*xᵢ is calculated as a difference between the positive weight charge and the negative weight charge. In this embodiment, the positive synapse circuit 9a corresponds to a first multiplication unit.

The negative synapse circuit 9b generates a positive weight charge by multiplying the signal value (|xᵢ⁻|) of the negative signal by the positive weight value vᵢ⁺ and generates a negative weight charge by multiplying the signal value (xᵢ⁺) of the positive signal by the negative weight value Thus, the positive weight charge and the negative weight charge are charges respectively corresponding to the positive weight product value (|vᵢ⁻|*xᵢ⁺) and the negative weight product value (vᵢ⁺*|xᵢ⁻|).

In this case, a difference Δ⁻ between the positive weight product value and the negative weight product value is expressed as follows.

Δ⁻=|vᵢ⁻|*xᵢ⁺−vᵢ⁺*|xᵢ⁻|=−|wᵢ|(xᵢ⁺+xᵢ⁻)=wᵢ⁻*xᵢ

Thus, the difference Δ⁻ is the product value wᵢ⁻*xᵢ of the negative paired weight value wᵢ⁻ and the input value xᵢ. That is, in the negative synapse circuit 9b, the product value wᵢ⁻*xᵢ is calculated as a difference between the positive weight charge and the negative weight charge. In this embodiment, the negative synapse circuit 9b corresponds to a second multiplication unit.

It should be noted that the positive weight charge corresponding to the positive weight product value is output to the positive charge output line 8a and the negative weight charge corresponding to the negative weight product value is output to the negative charge output line 8b.

In this embodiment, a pair of input signal line 7 (input signal line pair P7) and a pair of output lines 8 are connected to a single synapse circuit 9.

That is, a signal pair is input into the single synapse circuit 9 and a charge corresponding to a product value calculated on the basis of each electrical signal is output to each output line 8a or 8b in accordance with the sign of the paired weight value wᵢ. Thus, the synapse circuit 9 is a two-input two-output circuit.

As shown in FIG. 7, the plurality of input signal line pairs P7 is arranged so as to intersect with the pair of output lines 8 of each of the plurality of analog circuits 3. Typically, each input signal line 7 is provided to be orthogonal to each output line 8. That is, a crossbar configuration in which the input signal line pairs P7 intersect with the output lines 8 can be realized also in the arithmetic apparatus 200.

In this manner, in the arithmetic apparatus 200, the plurality of analog circuits 3 is connected in parallel to each of the plurality of input signal line pairs P7. Accordingly, for example, a signal pair can be input in parallel to each analog circuit 3 (each synapse circuit 9) and the arithmetic processing speed can be increased. As a result, excellent arithmetic operation performance can be exerted.

FIG. 8 is a schematic diagram showing a configuration example of the neuron circuit 10. In the arithmetic apparatus 200, a two-input two-output neuron circuit 10 connected to a pair of output lines 8 and a pair of output signal lines 13 (positive output signal line 13a and negative output signal line 13b) is configured.

A positive weight charge output as a positive multiply-accumulate signal from the positive charge output line 8a is accumulated in the capacitor 14a. Moreover, a negative weight charge output as a negative multiply-accumulate signal from the negative charge output line 8b is accumulated in the capacitor 14b. In this manner, the accumulation unit 11 is capable of accumulating the positive weight charge and the negative weight charge generated by each of the plurality of synapse circuits 9.

For example, at a timing at which the input period T of electrical signals ends, the charges accumulated in the capacitor 14a are a sum total of the positive weight charges each corresponding to the positive weight product value of the positive weight value vᵢ⁺ set to each synapse circuit 9.

Also, the charges accumulated in the capacitor 14b are a sum total of the negative weight charges each corresponding to the negative weight product value of the negative weight value vᵢ⁻ set to each synapse circuit 9.

The signal output unit 12 outputs, on the basis of the charges accumulated in the accumulation unit 11, a multiply-accumulate result signal representing a sum of the product values (wᵢ*xᵢ).

In this embodiment, a positive multiply-accumulate result signal representing a sum of positive weight product values and a negative multiply-accumulate result signal representing a sum of negative weight product values are each output as the multiply-accumulate result signal representing the sum of the product values (wᵢ*xᵢ).

Here, it is assumed that the total number of synapse circuits 9 provided in the analog circuit 3 is denoted by N. Moreover, it is assumed that out of an N-number of synapse circuits 9, the total number of synapse circuits 9 (positive weight pairs) to each of which the positive paired weight value wᵢ⁺ is set is denoted by N⁺ and the total number of synapse circuits 9 (negative weight pairs) to each of which the negative paired weight value wᵢ⁻ is set is denoted by N⁻. Thus, N=N⁺+N⁻ is established.

In this case, the multiply-accumulate result expressed by the expression (Formula 1) can be written in accordance with the above-mentioned expression (Formula 2) as in the arithmetic apparatus 100 having the one-input one-output configuration.

Since the signal pair is used in the two-input two-output arithmetic apparatus 200, the input value xᵢ is expressed as the difference between the positive value xᵢ⁺ and the absolute value |xᵢ⁻| of the negative value xᵢ⁻ (xᵢ=xᵢ⁺−|xᵢ⁻|). Thus, the expression (Formula 2) can be translated as follows.

$${\sum }_{i = 1}^{N} {w}_{i} \cdot {x}_{i} = \{ {\sum }_{i = 1}^{{N}^{+}} ( {w}_{i}^{+} \cdot {x}_{i}^{+} ) + {\sum }_{i = 1}^{{N}^{-}} ( \vert {w}_{i}^{-} \vert \cdot \vert {x}_{i}^{-} \vert ) \} - ( {\sum }_{i = 1}^{{N}^{+}} ( {w}_{i}^{+} \cdot \vert {x}_{i}^{-} \vert ) + {\sum }_{i = 1}^{{N}^{-}} ( \vert {w}_{i}^{-} \vert \cdot {x}_{i}^{+} ) \} \qquad [ Formula 3 ]$$

As shown in the expression (Formula 3), the multiply-accumulate result is a value obtained by subtracting the second term from the first term. Here, the first term and the second term are terms each enclosed by the curly brackets { }.

The first term is a value obtained by adding up all positive weight product values (wᵢ⁺*xᵢ⁺) calculated in the synapse circuits 9 to each of which the positive paired weight value wᵢ⁺ is set and positive weight product values (|wᵢ⁻|*|xᵢ⁻|) calculated in the synapse circuits 9 to each of which the negative paired weight value wᵢ⁻ is set.

That is, the first term is a sum σ⁺ of the positive weight product values calculated in all the synapse circuits 9. This sum of the positive weight product values is represented by a sum of positive weight charges accumulated in the capacitor 14a.

The second term is a value obtained by adding up all negative weight product values (wᵢ⁺*|xᵢ⁻|) calculated in the synapse circuits 9 to each of which the positive paired weight value wᵢ⁺ is set and negative weight product values (|wᵢ⁻|*xᵢ⁺) calculated in the synapse circuits 9 to each of which the negative paired weight value wᵢ⁻ is set.

That is, the second term is a sum σ⁻ of negative weight product values calculated in all the synapse circuits 9. This sum of the negative weight product values is represented by a sum of negative weight charges accumulated in the capacitor 14b.

In this manner, the total multiply-accumulate result can be calculated as a difference between the sum σ⁺ of the positive weight product values and the sum σ⁻ of the negative weight product values.

It should be noted that the first term (the sum σ⁺ of the positive weight product values) in the expression (Formula 3) does not correspond to a multiply-accumulate result of an N⁺−number of positive paired weight values wᵢ⁺. Also, the second term (the sum σ⁻ of the negative weight product values) in the expression (Formula 3) does not correspond to a multiply-accumulate result of an N⁻−number of negative paired weight values wᵢ⁻.

In the example shown in FIG. 8, the signal output unit 12 refers to the charges accumulated in the capacitor 14a to thereby calculate a positive multiply-accumulate result signal representing the sum of the positive weight product values and refers to the charges accumulated in the capacitor 14b to thereby calculate a negative multiply-accumulate result signal representing the sum of the negative weight product values.

At a timing at which the input period T ends, charges corresponding to the sum of the positive weight product values (the sum of the negative weight product values) are accumulated in the capacitor 14a (14b). The same applies irrespective of whether the TACT method or the PWM method is used.

The capacitor 14a and the capacitor 14b are each charged after the input period T ends. The signal output unit 12 performs threshold determination with respect to each of the capacitors 14a and 14b, generates each of the positive multiply-accumulate result signal and the negative multiply-accumulate result signal, and outputs the positive multiply-accumulate result signal and the negative multiply-accumulate result signal to the pair of output signal lines 13.

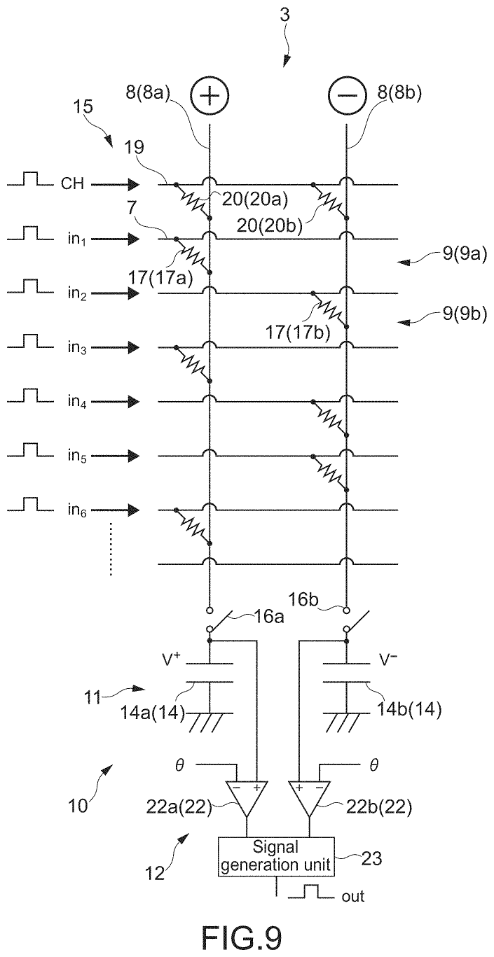

FIG. 9 is a schematic circuit diagram showing an example of the analog circuit 3 according to the PWM method in the arithmetic apparatus 100 having the one-input one-output configuration. The analog circuit 3 is provided extending in a direction orthogonal to the plurality of input signal lines 7. That is, in the example shown in FIG. 9, the crossbar configuration is employed.

The analog circuit 3 includes a pair of output lines (positive charge output line 8a and negative charge output line 8b), a plurality of synapse circuits (a plurality of multiplication units) 9, a neuron circuit 10, and a charging unit 15. In the example shown in FIG. 9, the neuron circuit 10 includes an accumulation unit 11, a signal output unit 12, and switches 16a and 16b.

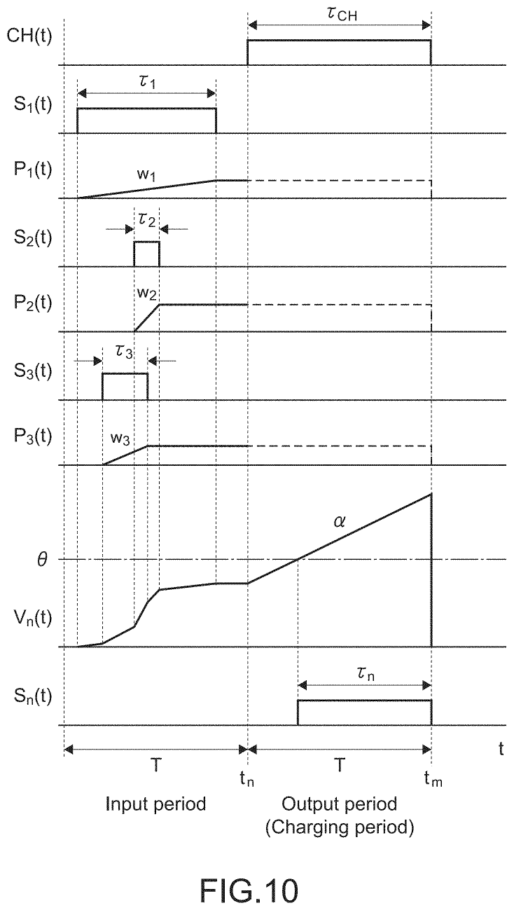

Pulse signals (PWM signals) each having a pulse width corresponding to the input value xᵢ are input into the plurality of input signal lines 7 as input signals in₁ to in₆. In the example shown in FIG. 9, six input signal lines 7 are shown, though the number of input signal lines 7 is not limited. The input signals in₁ to in₆ are input within the input period T having a predetermined duration (see FIG. 10).

The positive charge output line 8a outputs the positive weight charges corresponding to the product values (wᵢ⁺*xᵢ) obtained by multiplying the input values xᵢ by the positive weight values wᵢ⁺. The negative charge output line 8b outputs the negative weight charges corresponding to the product values (|wᵢ⁻|*xᵢ) obtained by multiplying the input values xᵢ by the negative weight values wᵢ⁻. In this embodiment, the pair of output lines 8 corresponds to one or more output lines.

The plurality of synapse circuits 9 is provided to be associated with the plurality of input signal lines 7, respectively. In this embodiment, one synapse circuit 9 is provided in one input signal line 7.

Each of the plurality of synapse circuits 9 includes a resistor 17 that is connected between the corresponding input signal line 7 of the plurality of input signal lines 7 and any one of the positive charge output line 8a or the negative charge output line 8b. This resistor 17 may have a non-linear characteristic and may have a function of preventing backflow of current.

A charge corresponding to the product value (wᵢ⁺*xᵢ) (or (|wᵢ⁻|*xᵢ)) is output to the output line 8a (or 7b) to which the resistor 17 is connected.

For example, in order to multiply the input value xᵢ by the positive weight value wᵢ⁺ in each synapse circuit 9, the resistor 17 is connected between the input signal line 7 and the positive charge output line 8a and the positive charge output line 8a is made to output a positive weight charge.

In the example shown in FIG. 9, the synapse circuit 9 into which the input signal in₁, in₃, in₆ is input is a synapse circuit 9a configured as the positive weight multiplication unit that generates a positive weight charge. It can also be said that the synapse circuit 9a is a multiplication unit in which a positive weight is set.

In order to multiply the input value xᵢ by the negative weight value wᵢ⁻ in each synapse circuit 9, the resistor 17 is connected between the input signal line 7 and the negative charge output line 8b and the negative charge output line 8b is made to output a negative weight charge.

In the example shown in FIG. 9, the synapse circuit 9 into which the input signal in₂, in₄, ins is input is a synapse circuit 9b configured as the negative weight multiplication unit that generates a negative weight charge. It can also be said that the synapse circuit 9b is a multiplication unit in which a negative weight is set.

Hereinafter, the synapse circuits 9a and 9b will be referred to as a positive weight multiplication unit 9a and a negative weight multiplication unit 9b in some cases.

Moreover, the resistor 17 that is connected between the input signal line 7 and the positive charge output line 8a will be referred to as a positive-side resistor 17a in some cases.

Moreover, the resistor 17 connected between the input signal line 7 and the negative charge output line 8b will be referred to as a negative-side resistor 17b in some cases.

It should be noted that a resistor having a resistance value corresponding to the weight value wᵢ to be set is used as the resistor 17. That is, the resistor 17 functions as an element that defines the weight value wᵢ in the arithmetic apparatus 100 that performs multiply-accumulate operations at the analog circuits 3.

For example, a fixed resistor element, a variable resistor element, a MOS transistor that operates in a sub-threshold region, or the like is used as the resistor 17. By using a MOS transistor that operates in the sub-threshold region as the resistor 17, for example, it is possible to reduce the power consumption. As a matter of course, another arbitrary resistor may be used.

The accumulation unit 11 accumulates charges corresponding to the product values (wᵢ*xᵢ) generated by the plurality of synapse circuits 9. In this embodiment, two capacitors 14a and 14b are provided as the accumulation unit 11.

The capacitor 14a is connected to the positive charge output line 8a via the switch 16a to accumulate the positive weight charges generated by the synapse circuits 9a.

The capacitor 14b is connected to the negative charge output line 8b via the switch 16b to accumulate the negative weight charges generated by the synapse circuits 9b.

The charging unit 15 charges the accumulation unit 11 in which a sum of charges corresponding to the product values (wᵢ*xᵢ) is accumulated. In this embodiment, the charging unit 15 includes a signal source (not shown), a charging line 19, and two resistors 20.

The charging line 19 is arranged in parallel to the input signal line 7.

One resistor 20a of the two resistors 20 is connected between the charging line 19 and the positive charge output line 8a. The other resistor 20b is connected between the charging line 19 and the negative charge output line 8b.

Thus, the charging line 19 is connected to the capacitor 14a via the resistor 20a. Also, the charging line 19 is connected to the capacitor 14a via the resistor 20b.

Resistors having the same resistance value are used as the resistors 20a and 20b. Although the same resistors are typically used, different types of resistors having the same resistance value may be used. The specific configurations of the resistors 20a and 20b are not limited, and various types of resistors may be used as in the resistors 17. Moreover, resistors the same in type as the resistors 17 may be used as the resistors 20a and 20b or resistors different in type from the resistors 17 may be used as the resistors 20a and 20b.

The charging is performed after the input period T ends. In this embodiment, a charging signal CH is input via the charging line 19 after the input period T ends. That is, the same charging signal CH is supplied into the capacitors 14a and 14b from the charging line 19.

Accordingly, charges based on a high-level value of the charging signal CH and resistance values of the resistors 20a and 20b are accumulated in the capacitors 14a and 14b.

Since the resistance values of the resistors 20a and 20b are equal to each other, the capacitors 14a and 14b are charged at the same charging speed.

The charging by the charging unit 15 increases each of the potential (voltage retained by the capacitor 14a) V⁺ of the positive charge output line 8a and the potential (voltage retained by the capacitor 14b) V⁻ of the negative charge output line 8b.

After the charging unit 15 starts charging, the signal output unit 12 performs threshold determination on the voltage retained by the accumulation unit 11 with a predetermined threshold value, to thereby output a multiply-accumulate result signal representing a sum of the product values (wᵢ*xᵢ).

In this embodiment, two comparators 22a and 22b and a signal generation unit 23 are provided as the signal output unit 12.

The comparator 22a detects a timing at which the voltage retained by the capacitor 14a exceeds a predetermined threshold value.

It should be noted that the magnitude of the voltage retained by the capacitor 14a is determined by the total amount of positive weight charge accumulated in the capacitor 14a and the charge amount (charging speed×time).

The comparator 22b detects a timing at which the voltage retained by the capacitor 14b exceeds a predetermined threshold value.

It should be noted that the magnitude of the voltage retained by the capacitor 14b is determined by the total amount of negative weight charge accumulated in the capacitor 14b and the charge amount (charging speed×time).

It should be noted that in this embodiment, a multiply-accumulate result signal is output by performing threshold determination with respect to each of the capacitors 14a and 14b with a common threshold value θ. Accordingly, the efficiency and speed of the arithmetic operation can be increased. As a matter of course, the multiply-accumulate operation can be performed also in a case where threshold values different from each other are used.

The signal generation unit 23 outputs a multiply-accumulate result signal representing a sum of the product values (wᵢ*xᵢ) on the basis of the timing detected by the comparator 22a and the timing detected by the comparator 22b.

In other words, the signal generation unit 23 outputs a multiply-accumulate result signal on the basis of a timing at which the voltage retained by the capacitor 14a reaches the threshold value θ and a timing at which the voltage retained by the capacitor 14b reaches the threshold value θ.

In this embodiment, a PMW signal, which is a pulse signal the pulse width of which has been modulated, is output as the multiply-accumulate result signal. The specific circuit configuration and the like of the signal generation unit 23 are not limited and may be arbitrarily designed.

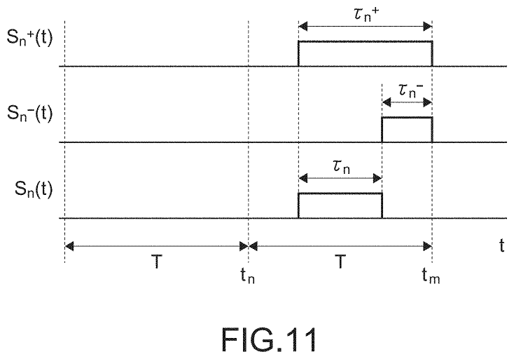

FIGS. 10 and 11 are diagrams for describing a calculation example of the multiply-accumulate result signal by the analog circuit 3 shown in FIG. 9.

In this embodiment, a multiply-accumulate result signal representing the total multiply-accumulate result including the positive and negative values is calculated on the basis of the multiply-accumulate result of positive weight charges based on the positive weight charges accumulated in the capacitor 14a and the multiply-accumulate result of negative weight charges based on the negative weight charges accumulated in the capacitor 14b.

The calculation of the multiply-accumulate result of the positive weight charges and the calculation of the multiply-accumulate result of the negative weight charges are the same processing. First, a method (multiply-accumulate method) of calculating the multiply-accumulate result on the basis of the charges accumulated in the capacitor 14 without distinguishing positive and negative values will be described with reference to FIG. 10.

The parameters described in FIG. 10 will be described.

“t” represents time.

“T” represents each of the input period and the output period.

“tₙ” represents an end timing of the input period T.

“tₘ” represents an end timing of the output period T.

In this embodiment, the duration of the input period T and the duration of the output period T are set to be equal to each other. Moreover, the output period T is started from an end timing tₙ of the input period T. Therefore, the end timing tₙ of the input period T corresponds to the start timing of the output period T.

Moreover, in this embodiment, the charging unit 15 performs charging in the output period T following the input period T. Thus, the output period T corresponds to a charging period.

“θ” represents a common threshold value used for threshold determination performed by the signal output unit 12 (comparator 22).

“Sᵢ(t)” represents an input signal (PWM signal) input into an i-th input signal line 7.

“τᵢ” represents the pulse width of the input signal Sᵢ(t).

“Pᵢ(t)” represents an amount of change of an internal state (potential) in each synapse circuit 9 shown in FIG. 9.

“wᵢ” represents a weight value and is defined by the resistance value of the resistor 17 shown in FIG. 9.

“Vₙ(t)” represents a sum total of “Pᵢ(t)” and corresponds to the total amount of charge accumulated in the capacitor 14.

“Sₙ(t)” represents a multiply-accumulate result signal (PWM signal) representing the multiply-accumulate result.

“τₙ” represents the pulse width of the multiply-accumulate result signal to be output. Specifically, “τₙ” takes a value corresponding to the duration from the timing at which the voltage retained by the capacitor 14 exceeds the threshold value θ in the output period T to the end timing tₘ of the output period T.

“CH(t)” represents a charging signal input into the charging line 19 in the output period T that is the charging period. As shown in FIG. 10, in this embodiment, a pulse signal that becomes the ON level during the output period T is input as the charging signal. Thus, a pulse width T_{CH} of the charging signal has the same length as the output period T.

In this example, the switches 16a and 16b are provided, and, in particular, the power consumption reduction can be improved by disconnecting the output lines through these switches.

Here, as shown in the following expression, the input value (signal value) xᵢ is given by the duty ratio Rᵢ (=τ/T) of the pulse width Ti of the input signal Sᵢ(t) to the input period T.

$${x}_{i} = {R}_{i} ( = \frac{{τ}_{i}}{T} ) \qquad [ Formula 4 ]$$

The synapse circuit 9 shown in FIG. 9 generates the charge corresponding to the product value obtained by multiplying the input value xᵢ by the weight value wᵢ. Specifically, the resistance of the resistor 17 increases the internal state (potential) along a constant slope wᵢ.

The amount of change Pᵢ(tₙ) of the internal potential of each synapse circuit 9 at the end timing tₙ of the input period T is given by the following expression. It should be noted that the high-level value of the input signal Sᵢ(t) is set to 1.

Pᵢ(tₙ)=wᵢRᵢT=wᵢxᵢT [Formula 5]

The total amount Vₙ(tₙ) of charge accumulated in the capacitor 14 is a sum total of Pᵢ(tₙ), and therefore it is given by the following expression.

$${V}_{n} ( {t}_{n} ) = {\sum }_{i = 1}^{N} {P}_{i} ( {t}_{n} ) = T {\sum }_{i = 1}^{N} {w}_{i} {x}_{i} \qquad [ Formula 6 ]$$

The charging unit 15 starts charging at the end timing tₙ of the input period T. As described above, in this embodiment, the output period T corresponds to the charging period.

The charging by the charging unit 15 increases the internal potential of each synapse circuit 9 along a slope (at a charging speed) a from the end timing tₙ of the input period T.

The charging speed a is defined by the high-level value of the charging signal and the resistance values of the resistors 20. It should be noted that in FIG. 10, the illustrations of changes in the internal potential of each synapse circuit 9 in the output period T are omitted (internal potential values at the end of the input period T are schematically shown by the broken lines).

A pulse signal whose high-level value is the same as the input signal may be used as the charging signal. As a matter of course, a pulse signal whose high-level value is different from that of the input signal may be used. Another arbitrary electrical signal different from the input signal can be employed as the charging signal.

A multiply-accumulate result signal (PWM signal) having a pulse width τₙ corresponding to the duration from the timing at which the voltage retained by the capacitor 14 exceeds the threshold value θ in the output period T to the end timing tₘ of the output period T is generated.

Assuming that the duty ratio of the pulse width in of the multiply-accumulate result signal to the output period T is Rₙ (=τₙ/T), Rₙ is given by the following expression. It should be noted that the threshold value θ is equal to or larger than the total amount Vₙ(tₙ) of charge.

$${R}_{n} = \frac{T - \frac{( θ - {V}_{n} ( {t}_{n} ) )}{α}}{T} = \frac{1}{α} {\sum }_{i = 1}^{N} {w}_{i} {x}_{i} + \frac{( α T - θ )}{α T} \qquad [ Formula 7 ]$$

Therefore, the multiply-accumulate result obtained by adding up product values (wᵢ*xᵢ) obtained by multiplying the input values xᵢ by the weight values wᵢ is given by the following expression.

$${{\sum }_{i = 1}}^{N} {w}_{i} {x}_{i} = α {R}_{n} - \frac{( α T - θ )}{T} \qquad [ Formula 8 ]$$

That is, the multiply-accumulate result is a value obtained by subtracting the constant defined by the charging speed a, the threshold value θ, and the output period T from αRₙ=α·(τₙ/T). In this way, the multiply-accumulate result signal representing the multiply-accumulate result can be output on the basis of the timing at which the voltage retained by the accumulation unit 11 exceeds the threshold value θ in the output period T having the predetermined duration.

FIG. 11 is a schematic diagram showing a calculation example of a multiply-accumulate result signal representing a total multiply-accumulate result based on the multiply-accumulate results of both the positive weight charges and the negative weight charges.

In FIG. 11, the multiply-accumulate result signal representing the multiply-accumulate result of the positive weight charges is denoted by “Sₙ⁺(t)” and its pulse width is denoted by “τn⁺”. Moreover, the multiply-accumulate result signal representing the multiply-accumulate result of the negative weight charges is denoted by “Sₙ⁻(t)” and its pulse width is denoted by “τₙ⁻”.

Moreover, the multiply-accumulate result signal representing the total multiply-accumulate result is denoted by “Sₙ(t)” and its pulse width is denoted by “τₙ”.

The total amount Vₙ⁺(tₙ) of positive weight charge accumulated in the capacitor 14a at the end timing tₙ of the input period T is given by the following expression. It should be noted that wᵢ⁺ represents a positive weight value.

$${V}_{n}^{+} ( {t}_{n} ) = T {\sum }_{i = 1}^{{N}^{+}} {w}_{i}^{+} {x}_{i} \qquad [ Formula 9 ]$$

The total amount Vₙ⁻(tₙ) of negative weight charge accumulated in the capacitor 14b at the end timing tₙ of the input period T is given by the following expression. It should be noted that wᵢ⁻ represents a negative weight value.

$${V}_{ι}^{-} ( {t}_{n} ) = T {\sum }_{i = 1}^{{N}^{-}} \vert {w}_{i}^{-} \vert {x}_{i} \qquad [ Formula 10 ]$$

Assuming that the duty ratio of the positive multiply-accumulate result signal Sₙ⁺(t) is Rₙ⁺ (=τₙ⁺/T), the positive multiply-accumulate result obtained by adding up product values (wᵢ⁺*xᵢ) obtained by multiplying the input value xᵢ by the positive weight value wᵢ⁺ is given by the following expression. It should be noted that it is assumed that the threshold value θ is equal to or larger than the total amount Vₙ⁺(tₙ) of positive weight charge.

$${\sum }_{i = 1}^{{N}^{+}} {w}_{i}^{+} {x}_{i} = α {R}_{n}^{+} - \frac{( α T - θ )}{T} \qquad [ Formula 11 ]$$

In a case where the duty ratio of the negative multiply-accumulate result signal Sₙ⁻(t) is Rₙ⁻ (=τₙ⁻/T), a negative multiply-accumulate result obtained by adding up product values (|wᵢ⁻|*xᵢ) obtained by multiplying the input value xᵢ by the negative weight value wᵢ⁻ is given by the following expression. It should be noted that the charge speed a and the threshold value θ are equal to the values used in the expression (Formula 11). Moreover, it is assumed that the threshold value θ is equal to or larger than the total amount Vₙ⁻(tₙ) of negative weight charge.

$${\sum }_{i = 1}^{{N}^{-}} \vert {w}_{i}^{-} \vert {x}_{i} = α {R}_{n}^{-} - \frac{( α T - θ )}{T} \qquad [ Formula 12 ]$$

Therefore, with the expression (Formula 2) described above, the total multiply-accumulate result is given by the following expression.

$${\sum }_{i = 1}^{N} {w}_{i} {x}_{i} = α ( {R}_{n}^{+} - {R}_{n}^{-} ) ( = α \frac{{τ}_{n}^{+} - {τ}_{n}^{-}}{T} ) \qquad [ Formula 13 ]$$

That is, the total multiply-accumulate result is obtained by the charge speed α, the pulse width τᵢ⁻ of the multiply-accumulate result signal Sₙ⁺(t), the pulse width τᵢ⁻ of the multiply-accumulate result signal Sₙ⁻(t), and the output period T. That is, it is possible to easily calculate the multiply-accumulate result on the basis of the timing detected by the comparator 22a and the timing detected by the comparator 22b.

As shown in FIG. 11, it is possible to easily output the multiply-accumulate result signal “Sₙ(t)” having the pulse width “τₙ” as the multiply-accumulate result signal representing the total multiply-accumulate result.

It should be noted that it may be possible to determine which one of the pulse width τₙ⁺ of the multiply-accumulate result signal Sₙ⁺(t) and the pulse width τₙ⁻ of the multiply-accumulate result signal Sₙ⁻(t) is larger. The multiply-accumulate result signal “Sₙ(t)” in a case where the pulse width τₙ⁺ is larger can be output as the positive multiply-accumulate result signal and the multiply-accumulate result signal “Sₙ(t)” in a case where the pulse width τₙ⁻ is larger can also be output as the negative multiply-accumulate result signal.

A circuit for comparing the pulse width τₙ⁺ with the pulse width τₙ⁻ can be realized by using a logical conjunction circuit, a NOT circuit, and the like as appropriate.

A setting can also be made such that in a case where the ReLU function (ramp function) or the like is used, for example, when the positive multiply-accumulate result signal “Sₙ(t)” is obtained, the signal is output as it is, and when the negative multiply-accumulate result signal “Sₙ(t)” is obtained, 0 is output.

As the setting of the charging speed a and the threshold value θ, α=θ/T is set for the output period T. Accordingly, the constant determined by the charge speed a, the threshold value θ, and the output period T included in the expressions (Formula 7), (Formula 8), (Formula 11), and (Formula 12) can be set to be zero, and the processing can be simplified.

For example, the high-level value of the charging signal and the resistance values of the resistors 20 are set as appropriate to adjust the charging speed a. Then, a threshold value θ is set on the basis of the duration of the input period T. Accordingly, an advantageous effect can be exerted.

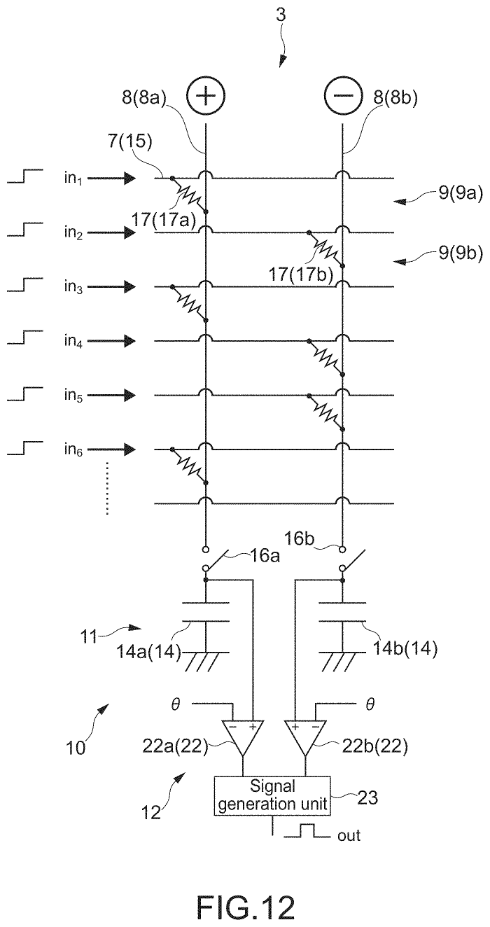

FIG. 12 is a schematic circuit diagram showing an example of the analog circuit according to the TACT method in the arithmetic apparatus 100 having the one-input one-output configuration. Pulse signals (TACT signals) are input into the plurality of input signal lines 7 as input signals in₁ to in₆ at a timing corresponding to the input value xᵢ.

Here, a continuous pulse signal that rises to a timing corresponding to the input value and keeps the ON level as illustrated in FIG. 3B is input.

Regarding the pulse signal, the duration of the ON time with respect to the input period T corresponds to the input value in the input period T. Hereinafter, the duration of the ON time in the input period T will be referred to as a pulse width in the input period T in some cases.

At a timing at which the input period T elapses, the charges accumulated in the capacitor 14a are the sum total σ⁺ of the positive weight charges each corresponding to the product value of the positive weight value wᵢ⁺.

Also, the charges accumulated in the capacitor 14b are the sum total σ⁻ of the negative weight charges each corresponding to the product value of the negative weight value wᵢ⁺.

Since the ON level of the electrical signal is maintained also after the input period T ends, charges are accumulated in the capacitor 14a and the capacitor 14b. A multiply-accumulate result signal (PWM signal) representing the multiply-accumulate result of the positive weight charges is generated on the basis of the timing at which the voltage retained by the capacitor 14a exceeds the threshold value θ.

Moreover, a multiply-accumulate result signal (PWM signal) representing the multiply-accumulate result of the negative weight charges is generated on the basis of the timing at which the voltage retained by the capacitor 14b exceeds the threshold value θ.

A multiply-accumulate result signal representing the total multiply-accumulate result can be generated on the basis of these positive and negative multiply-accumulate result signals.

In the analog circuit 3 according to the TACT method illustrated in FIG. 12, the output period T corresponds to the charging period. Moreover, the input signals in₁ to in₆ input into the plurality of input signal lines 7 in the output period T corresponds to the charging signal.

Thus, in the analog circuit 3 according to the TACT method illustrated in FIG. 12, the same charging signal is supplied into the capacitors 14a and 14b via the plurality of input signal lines 7.

Although not shown in the figure, the configuration to input the input signals in₁ to in₆ into the plurality of input signal lines 7 during the output period T corresponds to the charging unit 15. Thus, the configuration for inputting the input signals in₁ to in₆ also functions the charging unit 15. As shown in FIG. 8, the plurality of input signal lines 7 themselves can also be considered as parts of the charging unit 15.

Here, the focus is placed on a time constant as a parameter related to accumulation of charges of the capacitors 14 in the input period T and the output period (charging period) T.

In the above description, as shown in FIG. 10, accumulation of charges in the input period T and the output period T is approximated as a straight-line change (linear change) like a linear function and is described with the “slope wᵢ” and the “slope α”.

As a matter of course, the arithmetic apparatus 100 according to the analog method that is capable of accurately performing predetermined arithmetic processing including a multiply-accumulate operation on the basis of such approximation can be realized.

On the other hand, it can be considered that the charges (potential) of the capacitors 14 are accumulated in accordance with the time constant, which is determined by the circuit configuration of the analog circuit 3 illustrated in FIGS. 9 and 12, in the input period T and the output period (charging period) T.

Thus, it can be considered that designing the circuit configuration as appropriate could realize a more accurate multiply-accumulate operation on the basis of accumulation of charges according to the time constant.

Hereinafter, the charges (potential) of the capacitors 14 will be described as potential (charges) of the output lines 8 that output charges to the capacitors 14 in some cases.

First of all, the focus is placed on the analog circuit 3 according to the TACT method illustrated in FIG. 12. Then, the inventor found a configuration that makes the time constant for the output lines 8 irrespective of the number of resistors 17 disposed between the output lines 8 and the plurality of input signal lines 7.

First, it is assumed that the capacitors 14a and 14b functionally include a parasitic capacitance (not shown) generated in the output lines 8a and 8b. In this case, a minimum value of the capacitance that can be taken by the capacitors 14a and 14b is a parasitic capacitance generated in the output lines 8.

For example, even in a case where the capacitors 14 are not provided, charges are accumulated on the basis of the parasitic capacitance generated in the output lines 8a and 8b and a multiply-accumulate signal can be generated on the basis of the threshold determination. The same applies to the analog circuit 3 according to the PWM method illustrated in FIG. 9.

The time constant of the output lines 8 sequentially changes in accordance with the number of input signals sequentially input over time and the number of resistors 17 (on-resistances) in a state capable of transmitting a signal to the output lines 8.

Here, the focus is placed on the time constant at the end of the input period T.

In the analog circuit 3 according to the TACT method according to this embodiment, signals are input into all of the input signal lines 7 at the end of the input period T.

Therefore, the number of input signals at the end of the input period T takes a maximum value and a constant value. As a result, the time constant at the end of the input period T sequentially changes in accordance with the number of on-resistances.

Here, the resistance values of the resistors 17 are set to be the same resistance value R. In other words, a binary connect configuration is employed. Moreover, the parasitic capacitance of each synapse circuit 9 is designed to be a constant capacitance C.

Since the resistors 17 are connected in parallel to one output line 8, the combined resistance is R/N in a case where N resistors 17 are connected (the number of on-resistances is N).

On the other hand, since the number of synapse circuits 9 is N which is equal to the number of resistors 17, the combined capacitance is NC.

For example, a multiply-accumulate result signal is generated on the basis of the parasitic capacitance of each synapse circuit 9 without providing the capacitors 14. In this case, the value of the combined resistance×combined capacitance is RC irrespective of the number of resistors 17 (number of on-resistances). Therefore, the time constant of the output lines 8 at the end of the input period T is also RC irrespective of the number of resistors 17.

In a case where the capacitors 14 are installed, the capacitance of the capacitors 14 is set to a value (number of resistors 17×C₀) obtained by multiplying a predetermined constant C₀ by the number of resistors 17 (number of on-resistances). Accordingly, the time constant is R/N×(NC+NC₀)=R×(C+C₀) and is constant irrespective of the number of resistors 17.

Thus, the time constant can be made constant irrespective of the number of resistors 17.

Therefore, the potential V of each output line 8 at the end of the input period T can be approximated by the following expression.

$$V = {V}_{c} ( 1 - {e}^{- \frac{{t}_{ave}}{R \cdot C}} ) \qquad [ Formula 14 ]$$

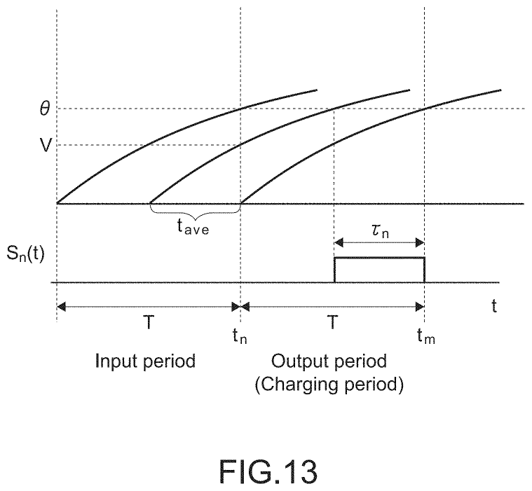

FIG. 13 is a schematic graph for describing the potential V of each output line 8 at the end of the input period T. The potential V of each output line 8 at the end of the input period T will be described with reference to the expression (Formula 14) and FIG. 13. It should be noted that the time constant curve in the graph of FIG. 13 is a curve corresponding to the expression (Formula 14).

“V_{c}” represents a constant and is a value corresponding to the convergence value of the potential after a time equal to or longer than the time constant has elapsed.

“tₐᵥₑ” represents the average of pulse widths of the pulse signals input into the input signal lines 7 within the input period T.

It should be noted that the charge of each output line 8 until the end of the input period T does not always change along the time constant curve shown in FIG. 13. It was found that at least the potential V of each output line 8 at the end of the input period T can be approximated by the expression (Formula 14).

On the other hand, in the output period (charging period) T, the input signals in₁ to in₆ (charging signals) at the ON level are input into all the input signal lines 7. Thus, it can be considered that the charge in the output period (charging period) T changes along the time constant curve shown in FIG. 13.

Here, the potential V of each output line 8 at the end timing tₙ of the input period T, which is approximated by the expression (Formula 14), is denoted by “Vtₙ”.

Moreover, a time (time within the output period T) after the end timing tₙ of the input period T is denoted by t.

Then, the potential “Vₒᵤₜ” of each output line 8 in the output period T can be approximated by the following expression.

$${V}_{out} = {V}_{{t}_{n}} + ( {V}_{i n} - {V}_{{t}_{n}} ) ( 1 - {e}^{- \frac{t}{R \cdot C}} ) \qquad [ Formula 15 ]$$

Here, as shown in FIG. 13, the input period T and the threshold value θ are determined in accordance with the time constant curve corresponding to the expression (Formula 14). That is, the potential V when the input period T is substituted for “tₐᵥₑ” of (Formula 14) is set as the threshold value θ.

Accordingly, in a case where the maximum pulses whose pulse width in the input period T is maximum are input into all the input signal lines 7, the potential of the output line 8 exceeds the threshold value at the end timing of the input period T (start timing of the output period T).

On the other hand, in a case where the pulses whose pulse width in the input period T is 0 are input into all the input signal lines 7, the potential of the output line 8 exceeds the threshold value at the end timing of the output period T.

As a result, it is possible to accurately calculate the multiply-accumulate result signal with high resolution within the output period T. That is, by setting the threshold value θ on the basis of the duration of the input period T, an advantageous effect can be exhibited.

As shown in FIG. 13, the threshold determination is performed on each of the capacitors 14a and 14b on the basis of the threshold value θ.

Accordingly, the multiply-accumulate result signal “Sₙ(t)” using “tₐᵥₑ” that is the average of the pulse widths of the respective pulse signals in the input period T as the pulse width “In” can be generated and output accurately.

It was found that the pulse width “in” of the multiply-accumulate result signal “Sₙ(t)” can also be approximated by the expression (Formula 14).

Irrespective of how the number of resistors 17 for connecting the input signal lines 7 and the positive charge output line 8a (i.e., the number of positive weight multiplication units), and the number of resistors 17 for connecting the input signal lines 7 and the negative charge output line 8b (i.e., the number of negative multiplication units) are combined in each analog circuit 3, the multiply-accumulate operation illustrated in FIG. 13 is realized for the potential V⁺ of the positive charge output line 8a and the potential V⁻ of the negative charge output line 8b.

Therefore, as illustrated in FIG. 11, the multiply-accumulate result signal “Sₙ(t)” representing the total multiply-accumulate result can be calculated on the basis of the pulse width τₙ⁺ of the multiply-accumulate result signal Sₙ⁺(t) and the pulse width τₙ⁻ of the multiply-accumulate result signal Sₙ⁻(t).

It should be noted that also in a case where another configuration is employed, the analog circuit 3 is designed such that the time constant of the positive charge output line 8a is equal to the time constant of the negative charge output line 8b. Accordingly, the multiply-accumulate operation illustrated in FIG. 13 is realized with respect to the potential V⁺ of the positive charge output line 8a and the potential V⁻ of the negative charge output line 8b.

As a matter of course, the present technology is not limited to the case where the binary connect configuration in which the positive weight value wᵢ⁺ and the absolute value of the negative weight value are fixed at the same value is employed.

For example, the positive weight value wᵢ⁺ and the absolute value of the negative weight value are multi-valued. That is, the positive weight value wᵢ⁺ and the absolute value of the negative weight value wᵢ⁻ are set to be any one of a plurality of values different from each other. Alternatively, the positive weight value wᵢ⁺ and the absolute value of the negative weight value are randomly set.

Also in this case, the analog circuit 3 is designed such that the time constant of the positive charge output line 8a is equal to the time constant of the negative charge output line 8b. Accordingly, the multiply-accumulate operation illustrated and described in FIG. 13 is realized with respect to the potential V⁺ of the positive charge output line 8a and the potential V⁻ of the negative charge output line 8b.

In the present disclosure, the time constant of the output lines 8 is included in the time constant related to the output of the charges corresponding to the product values to the output lines 8 by the plurality of synapse circuits 9.

The time constant of the positive charge output line 8a is included in the time constant related to the output of the positive weight charge to the positive charge output line 8a by the plurality of positive weight multiplication units 9a.

The time constant of the negative charge output line 8b is included in the time constant related to the output of the negative weight charge to the negative charge output line 8b by the plurality of negative weight multiplication units 9b.

Next, the analog circuit 3 according to the PWM method illustrated in FIG. 9 will be discussed.

In the analog circuit 3 according to the PWM method illustrated in FIG. 9, the input signals in₁ to in₆ are input into the plurality of input signal lines 7 during the input period T. Then, the charging signal CH is input via the charging line 19 during the output period T.

Here, the potential V of each output line 8 at the end of the input period T can be approximated by the expression (Formula 14) as in the TACT method. That is, the time constant curve according to the time constant of the output line 8 can be approximated as illustrated in FIG. 13.

After that, the charging line 19 and the resistance values of the resistors 20 are designed such that the charging by the charging unit 15 is performed in accordance with the same time constant curve. Accordingly, the multiply-accumulate operation illustrated in FIG. 13 is realized.

For example, in the configuration shown in FIG. 9, the combined resistance of the positive-side resistors 17a is set to be equal to the resistance value of the resistors 20a connected to the charging line 19. Accordingly, the multiply-accumulate operation illustrated in FIG. 13 is realized with respect to the positive charge output line 8a.

Moreover, the combined resistance of the negative-side resistors 17b is set to be equal to the resistance value of the resistors 20b connected to the charging line 19. Accordingly, the multiply-accumulate operation illustrated in FIG. 13 is realized with respect to the negative charge output line 8b.

For example, the analog circuit 3 is designed such that the time constant of the positive charge output line 8a is equal to the time constant of the negative charge output line 8b during the input period T. Then, the combined resistance of the positive-side resistors 17a is set to be equal to the resistance value of the resistors 20a and the combined resistance of the negative-side resistors 17b is set to be equal to the resistance value of the resistors 20b.

Accordingly, with respect to the potential V⁺ of the positive charge output line 8a and the potential V⁻ of the negative charge output line 8b, the multiply-accumulate operation illustrated in FIG. 13 is realized in accordance with the same time constant. As a result, the multiply-accumulate result signal “Sₙ(t)” for which “tₐᵥₑ” that is an average of pulse widths of the respective pulse signals in the input period T is set to be the pulse width “In” can be accurately generated and output.

As a matter of course, the application of the present technology is not limited to the case where the multiply-accumulate operation illustrated in FIG. 13 is realized.

Other configurations and other multiply-accumulate operations may be performed for the analog circuit 3 according to the PWM method and the analog circuit 3 according to the TACT method.

In any case, the result of the multiply-accumulate operation can be obtained on the basis of the potential (voltage retained by the capacitor 14a) V⁺ of the positive charge output line 8a and the potential (voltage retained by the capacitor 14b) V⁻ of the negative charge output line 8b.

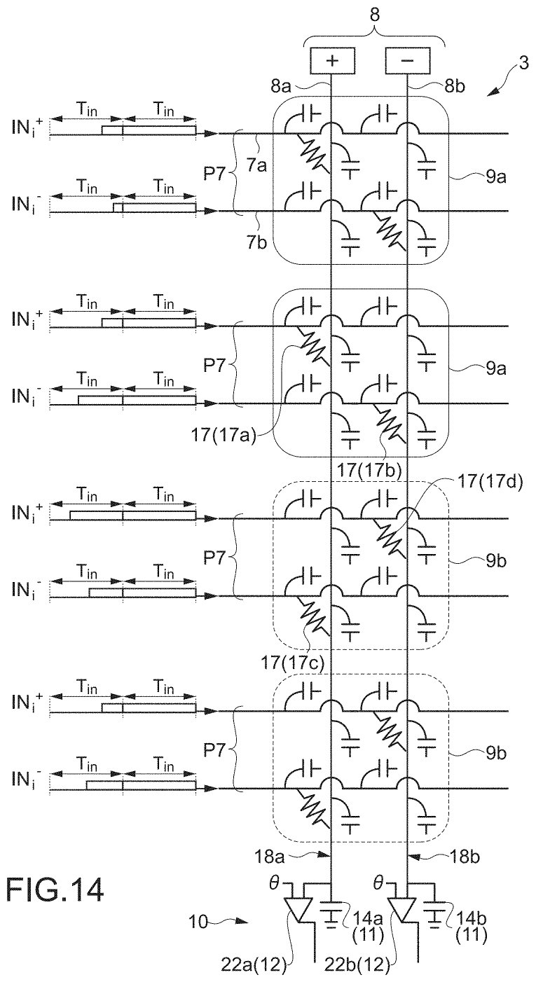

FIG. 14 is a schematic circuit diagram showing an example of the analog circuit 3 in the arithmetic apparatus 200 having the two-input two-output configuration.

The analog circuit 3 includes a pair of output lines (positive charge output line 8a and negative charge output line 8b), a plurality of synapse circuits 9, and a neuron circuit 10. The neuron circuit 10 includes an accumulation unit 11 and a signal output unit 12.

In the example shown in FIG. 14, four input signal line pairs P7 are connected to the analog circuit 3.

The number of input signal line pairs P7 and the like are not limited. Each signal pair is input into each input signal line pair P7. Those signal pairs include a signal pair whose input value xᵢ is negative and a signal pair whose input value xᵢ is positive.

That is, the positive and negative input values xᵢ are transmitted by each signal pair. Hereinafter, primarily a case where the signal pair according to the TACT method is used will be described.

FIG. 15 is a schematic diagram showing an example of the signal pair.

FIG. 15A and FIG. 15B each schematically show a graph representing an example of waveforms of the signal pair according to the TACT method.

“to” represents the start timing of the input period T and “tₙ” represents the end timing of the input period T.

“tₘ” represents the end timing of the output period T.

FIG. 15A is an example of the signal pair (positive signal pair) whose input value xᵢ is positive.

In a case where the input value xᵢ is positive, the positive value xᵢ⁺ that is the signal value of the positive signal INᵢ⁺ is larger than the absolute value |xᵢ⁻| of the negative value xᵢ⁻ that is the signal value of the negative signal INᵢ⁻.

Hereinafter, it is assumed that the positive signal pair includes a positive signal pair whose input value xᵢ is 0. That is, as to the positive signal pair, xᵢ⁺≥|xᵢ⁻| is established.

Regarding the positive signal pair according to the TACT method, the input timing of the pulse (xᵢ⁺) of the positive signal INᵢ⁺ is earlier than the input timing of the pulse (|xᵢ⁻|) of the negative signal INᵢ⁻ in the input period T. Thus, the positive signal pair according to the TACT method is defined as a signal pair for which the input timing of the positive signal INᵢ⁺ the input timing of the negative signal INᵢ⁻ is established.

FIG. 15B is an example of the signal pair (negative signal pair) whose input value xᵢ is negative.

In a case where the input value xᵢ is negative, the positive value xᵢ⁺ that is the signal value of the positive signal INᵢ⁺ is smaller than the absolute value of the negative value xᵢ⁻ that is the signal value of the negative signal INᵢ⁻. That is, as to the negative signal pair, xᵢ⁺<|xᵢ⁻| is established.

In the negative signal pair according to the TACT method, the input timing of the pulse (xᵢ⁺) of the positive signal INᵢ⁺ is later than the input timing of the pulse (|xᵢ⁻|) of the negative signal INᵢ⁻ in the input period T. Thus, the negative signal pair according to the TACT method is defined as a signal pair for which the input timing of the positive signal INᵢ⁺<the input timing of the negative signal INᵢ⁻ is established.

In the example shown in FIG. 14, the positive signal pairs are input into the first and third input signal line pairs P7 from the top of the figure. Moreover, the negative signal pairs are input into the second and fourth input signal line pairs P7.

It should be noted that the input signal line pairs P7 into which the positive signal pair and the negative signal pair are input change depending on input data, for example, in every arithmetic operation.

Moreover, as shown in FIG. 15A and FIG. 15B, the positive and negative signal pairs maintain the ON-state also after the input period T ends. That is, each electrical signal included in the signal pairs maintains a predetermined signal voltage also after the end timing tₙ of the input period T.

This ON-state is maintained until the end timing tₘ of the output period T, for example. The output period T has the same duration as the input period T.

When each electrical signal is put in the ON-state in the output period T, charges (currents) are supplied into the pair of output lines 8 via the synapse circuit 9 (resistor 17). Accordingly, the accumulation unit 11 (capacitor 14a and capacitor 14b) is charged during the output period T.

It should be noted that the present technology is not limited to the signal according to the TACT method, and the signal according to the PWM method (see FIG. 4A) may be used. In this case, electrical signal having respective pulse widths are input in the input period T, and electrical signals are input such that all the input signal lines 7 are turned on in the output period T. Also in this case, charges corresponding to multiply-accumulate results can be accumulated in the input period T and the capacitors 14 can be thereafter charged.

Referring back to FIG. 14, the positive charge output line 8a is connected to each synapse circuit 9 and outputs the positive weight charge corresponding to the positive weight product value obtained by multiplying the signal value of either the positive signal or the negative signal by the positive weight value vᵢ⁺.

Similarly, the negative charge output line 8b is connected to each synapse circuit 9 and outputs the negative weight charge corresponding to the negative weight product value obtained by multiplying the signal value of either the positive signal or the negative signal by the absolute value of the negative weight value vᵢ⁻.

The plurality of synapse circuits 9 is provided respectively corresponding to the plurality of input signal line pairs P7. In the example shown in FIG. 14, four synapse circuits 9 are provided for four input signal line pairs P7.

Each synapse circuit 9 is provided with two resistors 17. Those two resistors 17 each function as a weight for multiplying the weight value. Thus, the synapse circuit 9 serves as a weight pair that multiplies the signal pair by the weight value.

It should be noted that FIG. 14 schematically shows a parasitic capacitance deriving from each input signal line 7 and a parasitic capacitance deriving from each output line 8. Here, each parasitic capacitance is a capacitance produced between each wire and the GND or the like, for example.

The plurality of synapse circuits 9 includes at least one of the positive synapse circuit 9a or the negative synapse circuit 9b. Thus, the synapse circuits 9 provided in the single analog circuit 3 may be all the positive synapse circuits 9a or may be all the negative synapse circuits 9b. As a matter of course, the analog circuit 3 including the positive and negative synapse circuits 9a and 8b may be configured.

In the example shown in FIG. 14, the positive synapse circuits 9a are provided at the first and second rows from the top and the negative synapse circuits 9b are provided at the third and fourth rows.

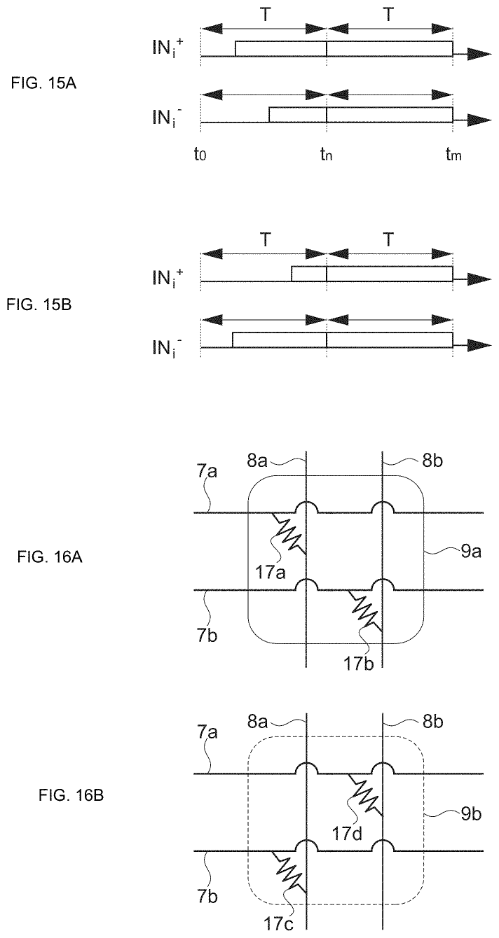

FIG. 16 is a schematic circuit diagram showing a configuration example of the synapse circuit 9.

FIG. 16A and FIG. 16B schematically show circuit diagrams of the positive synapse circuit 9a and the negative synapse circuit 9b. It should be noted that in FIG. 16, the illustrations of parasitic capacitances are omitted.

The positive synapse circuit 9a is the synapse circuit 9 to which the positive paired weight value wᵢ⁺ is set and serves as a positive weight pair. As shown in FIG. 16A, the positive synapse circuit 9a includes a first resistor 17a and a second resistor 17b.

The first resistor 17a is connected between the positive input signal line 7a and the positive charge output line 8a, defines the positive weight value vᵢ⁺, and outputs the positive weight charge to the positive charge output line 8a.

For example, the first resistor 17a outputs a positive signal input into the positive input signal line 7a, as the positive weight charge to the positive charge output line 8a. The first resistor 17a functions as a positive weight that generates the positive weight charge.

The second resistor 17b is connected between the negative input signal line 7b and the negative charge output line 8b, defines the negative weight value vᵢ⁻, and outputs the negative weight charge to the negative charge output line 8b.

For example, the first resistor 17b outputs a negative signal input into the negative input signal line 7b, as the negative weight charge to the negative charge output line 8b. The second resistor 17b functions as a negative weight that generates the positive weight charge.

As described above, in order to multiply the signal value xᵢ of the signal pair by the positive paired weight value wᵢ⁺, the positive input signal line 7a and the positive charge output line 8a are connected to each other via the resistor and the negative input signal line 7b and the negative charge output line 8b are connected to each other via the resistor.

Thus, it can also be said that regarding the positive synapse circuit 9a (positive weight pair), the positive signal (positive input) corresponds to the positive weight and the negative signal (negative input) corresponds to the negative weight.

The negative synapse circuit 9b is the synapse circuit 9 to which the negative paired weight value wᵢ⁻ is set and serves as a negative weight pair. As shown in FIG. 7B, the negative synapse circuit 9b includes a third resistor 17c and a fourth resistor 17d.

The third resistor 17c is connected between the negative input signal line 7b and the positive charge output line 8a, defines the positive weight value vᵢ⁺, and outputs the positive weight charge to the positive charge output line 8a.

For example, the third resistor 17c outputs a negative signal input into the negative input signal line 7b, as the positive weight charge to the positive charge output line 8a. The third resistor 17c functions as a positive weight that generates the positive weight charge.

The fourth resistor 17d is connected between the positive input signal line 7a and the negative charge output line 8b, defines the negative weight value vᵢ⁻, and outputs the negative weight charge to the negative charge output line 8b.

For example, the fourth resistor 17d outputs a positive signal input into the positive input signal line 7a, as the negative weight charge to the negative charge output line 8b. The fourth resistor 17d functions as a negative weight that generates the positive weight charge.

As described above, in order to multiply the signal value xᵢ of the signal pair by the negative paired weight value wᵢ, the negative input signal line 7b and the positive charge output line 8a are connected to each other via the resistor and the positive input signal line 7a and the negative charge output line 8b are connected to each other via the resistor.

Thus, it can also be said that regarding the negative synapse circuit 9b (negative weight pair), the positive signal (positive input) correspond to the negative weight and the negative signal (negative input) correspond to the positive weight.

In this embodiment, the respective resistors 17 that are the positive and negative weights are set to have the same conductance (or resistance value) in the single synapse circuit 9. This common conductance is set as appropriate in accordance with the paired weight value wᵢ set to the synapse circuit 9, for example.

For example, in a case where a constant voltage is applied to the resistor 17, a current (charge) generated by the resistor 17 is proportional to the conductance (inversely proportional to the resistance value). Thus, for example, the conductance of the resistor 17 is set to be proportional to the weight value set to the resistor 17.

Accordingly, the positive weight value and the negative weight value can be set to be equal to each other, and the multiply-accumulate operation can be properly performed.

It should be noted that the resistance value may differ or may be the same for each synapse circuit 9. It should be noted that various types of resistors may be used the resistors 17 (e.g., 17a to 17d).

As shown in FIG. 14, the positive weight (first resistor 17a) of the positive synapse circuit 9a and the positive weight (third resistor 17c) of the negative synapse circuit 9b are connected in parallel to the capacitor 14a. Those positive weights of the respective synapse circuits 9 constitute a positive weight column 18a.

Moreover, the negative weight (second resistor 17b) of the positive synapse circuit 9a and the negative weight (fourth resistor 17d) of the negative synapse circuit 9b are connected in parallel to the capacitor 14b. Those negative weights of the respective synapse circuits 9 constitute a negative weight column 18b.

Moreover, a circuit constituted by a single weight column 18 and a capacitor 14 and a comparator 22 that are connected to the weight column 18 functions as a multiply-accumulate deriving means for deriving a multiply-accumulate result.

For example, it is assumed that the analog circuit 3 includes an N-number of synapse circuits 9. In this case, an N-number of positive weights (negative weights) are connected to the capacitor 14a (capacitor 14b) as the positive weight column 18a (negative weight column 18b).

In this manner, in this configuration, weights (resistors 17) equal in number to the synapse circuits 9 are connected in parallel to each capacitor.

Moreover, in each synapse circuit 9, the positive and negative weight values (vᵢ⁺ and |vᵢ⁻|) are set to be equal to each other. Therefore, the sum total value of the positive weight values included in the positive weight column 18a is equal to the sum total value of the negative weight values included in the negative weight column 18b.

Thus, the circuit for outputting the positive multiply-accumulate result signal and the circuit for outputting the negative multiply-accumulate result signal can be considered as circuits having similar configurations.

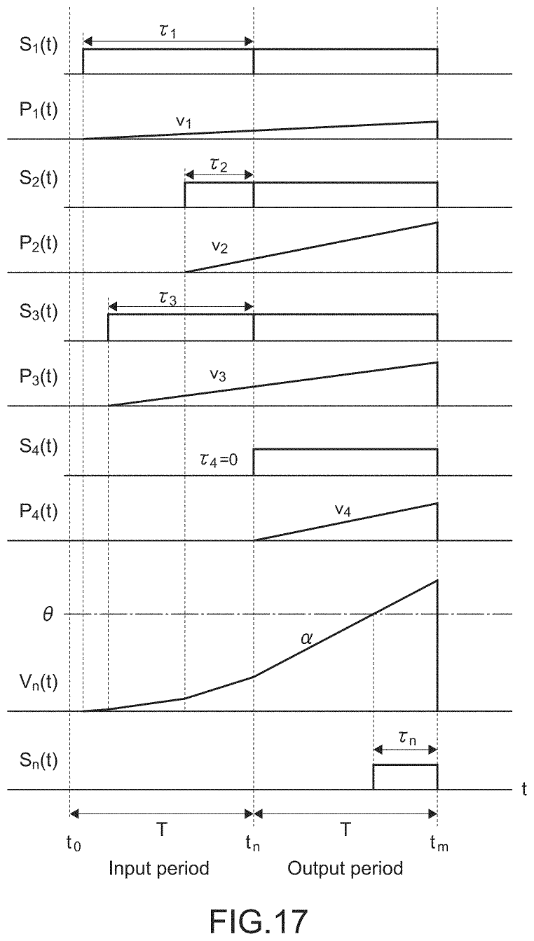

FIG. 17 is a diagram for describing a calculation example of the multiply-accumulate result signal by the analog circuit 3 shown in FIG. 14. FIG. 17 shows a graph showing the calculation example of the multiply-accumulate result signal in the single weight column 18 (positive weight column 18a or negative weight column 18b).

Hereinafter, referring to FIG. 17, a calculation method (multiply-accumulate method) for a multiply-accumulate result based on the charge accumulated in the capacitor 14 will be described without distinguishing positive and negative values.

It should be noted that the positive and negative signals will be both referred to as input signals, the signal values (xᵢ⁺ and |xᵢ⁻|) of the positive signal and the negative signal will be both referred to as signal values yᵢ, and the respective weight values (vᵢ⁺ and |vᵢ⁻|) of the positive weight and the negative weight will be both referred to as weight values vᵢ in some cases.

“Sᵢ(t)” represents an input signal (TACT signal) input into an i-th input signal line pair P7.

“τᵢ” represents a duration from the input timing of the input signal Sᵢ(t) to the end timing to of the input period T.

Hereinafter, “τᵢ” will be referred to as a pulse width of the input signal Sᵢ(t) in the input period T in some cases. As “τᵢ” becomes larger, the input signal ᵢ(t) becomes a signal representing a larger signal value yᵢ.

“Pᵢ(t)” represents the amount of change of the internal state (potential) in each synapse circuit 9 shown in FIG. 14.

“vᵢ” represents the weight value of the weight connected to the single weight column (positive weight column or negative weight column) and is defined by the resistance value of the resistor 17 shown in FIG. 14.

Here, the description is given assuming that the potential corresponding to each synapse circuit 9 linearly increases over time. At this time, the resistance value of the resistor 17 is set such that the slope of the potential is “vᵢ”, for example.

“α” represents an increasing slope of the potential of the capacitor 14 in the output period T following the input period T and is a charging speed of the capacitor 14.

In the example shown in FIG. 17, each synapse circuit 9 is maintained at the ON level after the input period T elapses, and the potential of the capacitor 14 thus increases along the slope “a”. It should be noted that for example, in a case of charging the capacitor 14 through another wire in the output period T, a takes a value depending on the charging speed.

“θ” represents the threshold value used for threshold determination performed by the signal output unit 12 (comparator 22).

“Vₙ(t)” represents a sum total of “Pᵢ(t)” and corresponds to the total amount of charge accumulated in the capacitor 14.

“Sₙ(t)” represents a multiply-accumulate result signal (PWM signal) representing the multiply-accumulate result.

“τₙ” represents the pulse width of the multiply-accumulate result signal to be output. Specifically, “τₙ” takes a value corresponding to the duration from the timing at which the voltage retained by the capacitor 14 exceeds the threshold value θ in the output period T to the end timing tₘ of the output period T.

Here, as shown in the following expression, it can be considered that the signal value yᵢ of the input signal is given by the duty ratio Rᵢ (=τᵢ/T) of the pulse width Ti of the input signal Sᵢ(t) in the input period T to the input period T.

$${y}_{i} = {R}_{i} ( = \frac{{τ}_{i}}{T} ) \qquad [ Formula 16 ]$$

The synapse circuits 9 shown in FIG. 14 each generate a charge corresponding to a product value obtained by multiplying the signal value yᵢ by the weight value vᵢ. Specifically, the internal state (potential) increases along the constant slope vᵢ due to the resistance of the resistor 17.

Then, the amount of change Pᵢ(tₙ) of the internal potential of the respective synapse circuits 9 at the end timing tₙ of the input period T is given by the following expression. It should be noted that it is assumed that the high-level value of the input signal Sᵢ(t) is 1.

Pᵢ(t)=vᵢRᵢT=vᵢyᵢT [Formula 17]

The total amount Vₙ(tₙ) of charge accumulated in the capacitor 14 is the sum total of Pᵢ(tₙ), and is thus given by the following expression.

$${V}_{n} ( {t}_{n} ) = {\sum }_{i = 1}^{N} {P}_{i} ( {t}_{n} ) = T {\sum }_{i = 1}^{N} {v}_{i} {y}_{i} \qquad [ Formula 18 ]$$

In the example shown in FIG. 14, after the end timing tₙ of the input period T, all the input signals enter the ON-state and the internal states (potential) increase along slopes vᵢ in all the synapse circuits 9. That is, charges are output from all the weights connected to the weight column to the capacitor 14.

The slope (charging speed a) of the voltage of the capacitor 14 at this time is equal to a sum of “vᵢ”. That is, the charging speed a is the sum total value of all the weight values provided in the weight column.

The comparator performs threshold determination on the voltage of the capacitor 14 that increases at the charging speed a. Then, a multiply-accumulate result signal having the pulse width τₙ corresponding to the duration from the timing at which the voltage retained by the capacitor 14 exceeds the threshold value θ in the output period T to the end timing tₘ of the output period T is generated.

Assuming that the duty ratio of the pulse width τₙ of the multiply-accumulate result signal to the output period T is denoted by Rₙ (=τₙ/T), Rₙ is given by the following expression. It should be noted that it is assumed that the threshold value θ is equal to or larger than the total amount Vₙ(tₙ) of charge.

$${R}_{n} = \frac{T - \frac{( θ - {V}_{n} ( {t}_{n} ) )}{α}}{T} = \frac{1}{α} {\sum }_{i = 1}^{N} {ν}_{i} {y}_{i} + \frac{( α T - θ )}{α T} \qquad [ Formula 19 ]$$

Thus, the multiply-accumulate result obtained by adding up product values (vᵢ*yᵢ) obtained by multiplying the signal values yᵢ by the weight values vᵢ is given by the following expression.

$${\sum }_{i = 1}^{N} {ν}_{i} {y}_{i} = α {R}_{n} - \frac{( α T - θ )}{T} \qquad [ Formula 20 ]$$

That is, the multiply-accumulate result is a value obtained by subtracting the constant defined by the charging speed α, the threshold value θ, and the output period T from αRₙ=α*(τₙ/T). It is thus possible to output the multiply-accumulate result signal representing the multiply-accumulate result for each weight pair on the basis of the timing (pulse width iₙ) at which the voltage retained by the accumulation unit 11 exceeds the threshold value θ in the output period T having the predetermined duration.

In the example shown in FIG. 14, the multiply-accumulate result signal representing the multiply-accumulate result shown in the expression (Formula 20) is calculated with respect to each of the positive weight column 18a and the negative weight column 18b.

For example, the comparator 22a generates a positive multiply-accumulate result signal Sₙ⁺(t) representing the multiply-accumulate result of the positive weight charges output from the positive weight column 18a.

Moreover, the comparator 22a generates a negative multiply-accumulate result signal Sₙ⁻(t) representing the multiply-accumulate result of the negative weight charges output from the negative weight column 18b.

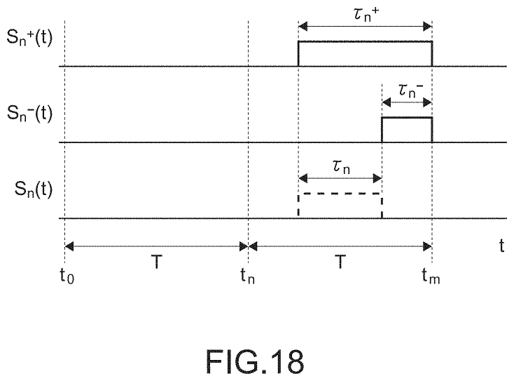

FIG. 18 is a schematic diagram showing an example of the positive and negative multiply-accumulate result signals.

Hereinafter, the pulse width of the positive multiply-accumulate result signal Sₙ⁺(t) will be denoted by “Ink” and the pulse width of the negative multiply-accumulate result signal Sₙ⁻ (t) will be denoted by “τₙ⁻”.

Moreover, “Sₙ(t)” shown in FIG. 18 is an example of multiply-accumulate result signals representing total multiply-accumulate results including the positive and negative multiply-accumulate results in the analog circuit 3. The pulse width of Sₙ(t) is denoted by “τₙ”.

The multiply-accumulate result obtained by adding up the product values (vᵢ*yᵢ) in the positive weight column 18a is a sum of the product values of the positive weights provided in the positive weight pair and the negative weight pair. That is, the multiply-accumulate result of the positive weight column 18a is the sum σ⁺ of the positive weight product values described by using the expression (Formula 3).

Thus, the total amount Vₙ(tₙ) of positive weight charge accumulated in the capacitor 14a at the end timing tₙ of the input period T in accordance with the expression (Formula 20) is given by the following expression.

$${V}_{n}^{+} ( {t}_{n} ) = T \{ {\sum }_{i = 1}^{{N}^{+}} ( {w}_{i}^{+} \cdot {x}_{i}^{+} ) + {\sum }_{i = 1}^{{N}^{-}} ( \vert {w}_{i}^{-} \vert \cdot \vert {x}_{i}^{-} \vert ) \} = T {σ}^{+} \qquad [ Formula 21 ]$$

As shown in the expression (Formula 21), the sum σ⁺ of the positive weight product values is, in the input period T, calculated by relating positive signals (positive inputs xᵢ⁺) constituting an N⁺−number of signal pairs to the positive weights constituting the positive weight pair and relating negative signals (negative inputs xᵢ⁻) constituting an N−N⁺=N⁻−number of signal pairs to the positive weights constituting the negative weight pair.

The multiply-accumulate result obtained by adding up the product values (vᵢ*yᵢ) in the negative weight column 18b is a sum of the product values of the negative weights provided in the positive weight pair and the negative weight pair. That is, the multiply-accumulate result of the negative weight column 18b is the sum σ⁻ of the negative weight product values described by using the expression (Formula 3).

Thus, the total amount Vₙ⁻(tₙ) of negative weight charge accumulated in the capacitor 14b at the end timing tₙ of the input period T in accordance with the expression (Formula 21) is given by the following expression.

$${V}_{n}^{-} ( {t}_{n} ) = T \{ {\sum }_{i = 1}^{{N}^{+}} ( {w}_{i}^{+} \cdot \vert {x}_{i}^{-} \vert ) + {\sum }_{i = 1}^{{N}^{-}} ( \vert {w}_{i}^{-} \vert \cdot {x}_{i}^{+} ) \} = T {σ}^{-} \qquad [ Formula 22 ]$$

As shown in the expression (Formula 22), the sum σ⁻ of the negative weight product values is, in the input period T, calculated by relating negative signals (negative inputs xᵢ⁻) constituting an N⁺−number of signal pairs to the positive weights constituting the positive weight pair and relating positive signals (positive inputs xᵢ⁺) constituting an N⁻−number of signal pairs to the positive weights constituting the negative weight pair.

It is assumed that the duty ratio of the positive multiply-accumulate result signal Sₙ⁺(t) is denoted by Rₙ⁺ (=τₙ+/T) and the sum total value of the weight values (vᵢ⁺) set in the positive weight column 18a is denoted by W⁺.

In this case, the multiply-accumulate result (the sum σ⁺ of the positive weight product values) calculated in the positive weight column 18a is given by the following expression. It should be noted that it is assumed that the threshold value θ is equal to or larger than the total amount Vₙ(tₙ) of positive weight charge.

$${σ}^{+} = {W}^{+} {R}_{n}^{+} - \frac{( {W}^{+} T - θ )}{T} ( {W}^{+} = {\sum }_{i = 1}^{N} {v}_{i}^{+} ) \qquad [ Formula 23 ]$$

It is assumed that the duty ratio of the negative multiply-accumulate result signal Sₙ⁻(t) is denoted by Rₙ⁻ (=τₙ⁻/T) and the sum total value of the weight values (vᵢ⁻) set in the negative weight column 18b is denoted by W.

In this case, the multiply-accumulate result (the sum σ⁻ of the negative weight product values) calculated in the negative weight column 18b is given by the following expression. It should be noted that the threshold value θ is equal to or larger than the total amount Vₙ⁻(tₙ) of negative weight charge and takes the same value as θ shown in the expression (Formula 23).

$${σ}^{-} = {W}^{-} {R}_{n}^{-} - \frac{( {W}^{-} T - θ )}{T} ( {W}^{-} = {\sum }_{i = 1}^{N} \vert {ν}_{i}^{-} \vert ) \qquad [ Formula 24 ]$$

As described above, in the analog circuit 3 configured using the weight pair, the sum total values (W⁺ and W⁻) of the weight values set in the positive and negative weight columns 18a and 18b are equal to each other. Hereinafter, the sum total value of the weight values set in each weight column will be denoted by W.

Thus, in this embodiment, the sum total value W⁺ of the positive weight values vᵢ⁺ and the sum total value W⁻ of the absolute values |vᵢ⁻| of the negative weight values vᵢ⁻ are set to be the same common sum total value W in the analog circuit 3. This sum total value W (common sum total value) of the weight values is, as shown below, equal to a value obtained by adding up a sum total of the positive paired weights wᵢ⁺ and a sum total of the negative paired weights wᵢ⁻.

$${W}^{+} = {W}^{-} = W = {\sum }_{i = 1}^{{N}^{+}} {w}_{i}^{+} + {\sum }_{i = 1}^{{N}^{-}} \vert {w}_{i}^{-} \vert \qquad [ Formula 25 ]$$

Moreover, as shown in the expression (Formula 3), the total multiply-accumulate result is expressed by a difference between the sum σ⁺ of the positive weight product values and the sum σ⁻ of the negative weight product values. Thus, with the expression (Formula 23), the expression (Formula 24), and the expression (Formula 25), the total multiply-accumulate result is given by the following expression.

$${\sum }_{i = 1}^{N} {w}_{i} \cdot {x}_{i} = W ( {R}_{n}^{+} - {R}_{n}^{-} ) = W ( \frac{{τ}_{n}^{+} - {τ}_{n}^{-}}{T} ) \qquad [ Formula 26 ]$$

That is, the total multiply-accumulate result is determined on the basis of the sum total value W of the weight values, the pulse width τₙ⁺ of the positive multiply-accumulate result signal Sₙ⁺(t), the pulse width τₙ⁻ of the negative multiply-accumulate result signal Sₙ⁻(t), and the output period T. Thus, the multiply-accumulate result can be easily calculated on the basis of the timing detected by the comparator 22a and the timing detected by the comparator 22b.

As described above, the analog circuit 3 calculates, on the basis of analog signals, a “sum” of an N-number of product values determined on the basis of positive and negative electrical signal pairs and positive and negative weight pairs. Accordingly, the multiply-accumulate operation can be properly performed irrespective of whether the input value xᵢ and the paired weight value wᵢ are positive or negative, for example.

Moreover, in the analog circuit 3, the positive multiply-accumulate result signal Sₙ⁺(t) and the negative multiply-accumulate result signal Sₙ⁻(t) are each generated. That is, a pair of electrical signals (signal pair) having the pulse width τₙ⁺ and the pulse width τₙ⁻ as the signal values is generated.

Therefore, the input value xᵢ represented by this signal pair is equal to the pulse width in corresponding to the total multiply-accumulate result. Thus, the analog circuit 3 is a circuit that outputs the total multiply-accumulate result as the signal pair.

It should be noted that a single electrical signal representing the total multiply-accumulate result may be output instead of the signal pair. For example, a total multiply-accumulate result signal Sₙ(t) having a difference between the pulse width τₙ⁺ and the pulse width τₙ⁻ as the pulse width in is generated.

Such a multiply-accumulate result signal Sₙ(t) can be easily configured by using a logic circuit such as a logical conjunction circuit and a NOT circuit, for example. In the arithmetic apparatus 100, the total multiply-accumulate result signal Sₙ(t) is used as an output of an uppermost layer (last stage), for example.

It should be noted that as shown in FIG. 17, an increase in the voltage of the capacitor 14 (the potential with respect to the GND) is approximated as a straight-line change (linear change) like a linear function. The arithmetic apparatus 200 according to the analog method that is capable of accurately performing predetermined arithmetic processing including a multiply-accumulate operation on the basis of such approximation can be realized.

On the other hand, the circuit configuration is designed as appropriate such that each capacitor 14 is charged on the basis of a common time constant in each of the plurality of analog circuits 3. Then, threshold determination is performed on the voltage of each capacitor 14 with a common threshold value θ. Accordingly, the efficiency and speed of the arithmetic operation can be increased.

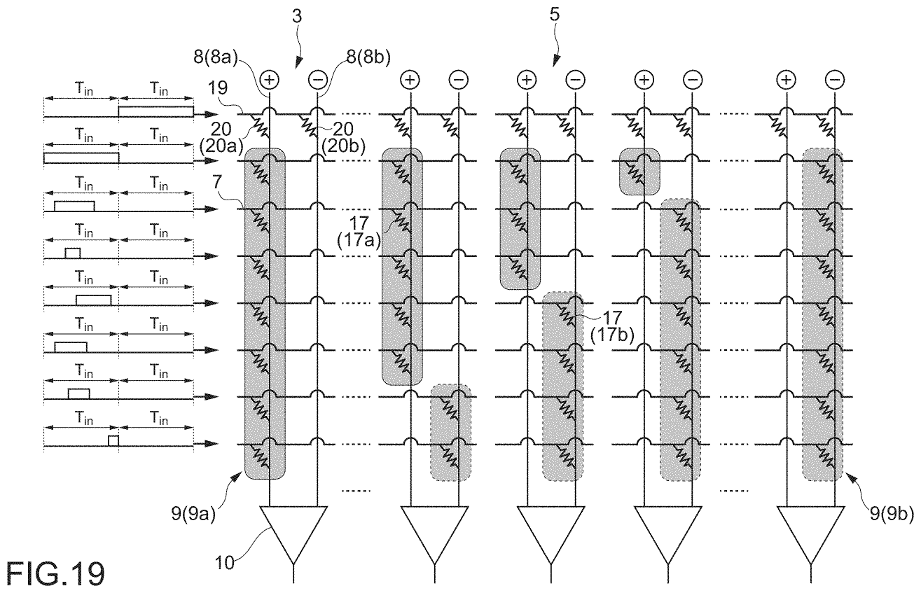

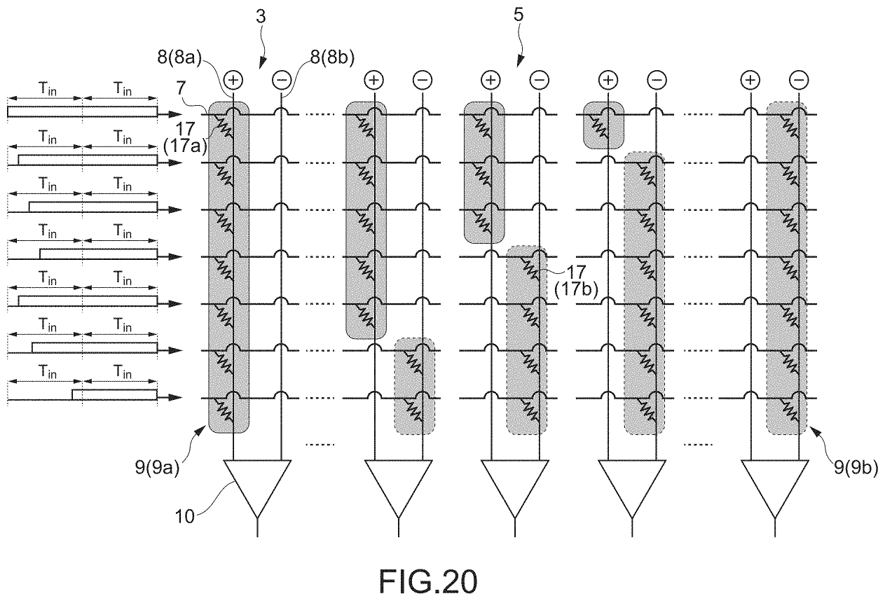

FIGS. 19 and 20 are schematic diagrams showing a configuration example of the arithmetic circuit unit 5 in the arithmetic apparatus 100 having the one-input one-output configuration.

The arithmetic circuit unit 5 illustrated in FIGS. 19 and 20 includes a plurality of input signal lines 7 and a plurality of analog circuits 3 connected in parallel to the plurality of input signal lines 7.

By employing such a configuration, an electrical signal can be input in parallel to each analog circuit 3 and the arithmetic processing speed can be increased. As a result, excellent arithmetic operation performance can be exerted.

As to the arithmetic circuit unit 5 illustrated in FIG. 19, the analog circuits 3 according to the PWM method described with reference to FIGS. 9 to 11 are arranged as the plurality of analog circuits 3. As to the arithmetic circuit unit 5 illustrated in FIG. 20, the analog circuits 3 according to the TACT method are arranged described with reference to FIGS. 12 and 13 as the plurality of analog circuits 3.

For example, the charging by the charging unit 15 is performed with respect to the plurality of analog circuits 3 on a common charging mode. Moreover, a common threshold value is set as the predetermined threshold used for threshold determination performed by the signal output unit 12 in the neuron circuit 10. That is, the charging is performed on the same charging mode in each analog circuit 3 and the threshold determination is performed by using the same threshold value.

In each analog circuit 3, the common charging mode is performed with respect to each of the capacitors 14a and 14b. That is, the charging is performed on the common charging mode with respect to the plurality of capacitors 14a and 14b included in the plurality of analog circuits 3. Then, in the plurality of analog circuits 3, the threshold determination is performed with the common threshold value and a multiply-accumulate result signal is output.

The common charging mode can include charging in which charging signals are supplied in the respective analog circuits 3 during a common charging period. In addition, the common charging mode also includes a mode on which the same charging signals are supplied in the respective analog circuits 3.

The common charging mode also includes charging at a common charging speed (charging rate), charging according to a common time constant, and the like. As a matter of course, the present technology is not limited thereto.

For example, as shown in FIG. 19, the common charging line 19 is arranged with respect to the plurality of analog circuits 3. The charging line 19 is arranged in parallel to the plurality of input signal lines 7. The resistor 20a is connected between the charging line 19 and the positive charge output line 8a of each analog circuit 3. The resistor 20b is connected between the charging line 19 and the negative charge output line 8b of each analog circuit 3.

Charging signals that become the ON level during the output period (charging period) T are input via the charging line 19. Accordingly, the same charging signals can be supplied in the common charging period.

Moreover, resistors having all the same resistance values are arranged as the resistors 20a and 20b. Accordingly, the charging can be performed at the common charging speed during the common charging period.

For example, it is assumed that charging is performed at the common charging speed in the common charging period. In this case, the potential of the positive charge output line 8a of each analog circuit 3 and the potential of the negative charge output line 8b increase in accordance with the charging speed a as illustrated in FIG. 10.

Therefore, as illustrated in FIG. 11, the multiply-accumulate result signal “Sₙ(t)” representing the total multiply-accumulate result can be calculated in each analog circuit 3 on the basis of the pulse width τₙ⁺ of the multiply-accumulate result signal Sₙ⁺(t) and the pulse width τₙ⁻ of the multiply-accumulate result signal Sₙ⁻(t).

Moreover, each analog circuit 3 and the charging unit 15 are designed such that the time constant of each output line (positive charge output line 8a or negative charge output line 8b) in the output period T takes a common value. In this case, the charging according to the common time constant can be realized.

Moreover, each analog circuit 3 is designed such that the time constant of the positive charge output line 8a and the time constant of the negative charge output line 8b in the input period T are equal to each other at each of the plurality of analog circuits 3 and the value of such a time constant is the common value in all the analog circuits 3.

Then, the charging unit 15 is designed such that the time constant of the positive charge output line 8a and the time constant of the negative charge output line 8b in the output period T is the same as the time constant in the input period T.

Accordingly, in each analog circuit 3, the multiply-accumulate operation illustrated in FIG. 13 is realized. It should be noted that the threshold value is defined in accordance with the time constant curve on the basis of the input period T and is set as the common threshold value.

Moreover, input signals are input so as to maintain the ON-state in the output period T as shown in FIG. 20. Accordingly, charging in which the same charging signals are supplied is performed in the common charging period.

Moreover, each analog circuit 3 and the charging unit are designed such that the time constant of each output line 8 (positive charge output line 8a or negative charge output line 8b) takes the common value. In this case, the charging according to the common time constant can be realized.

Accordingly, in each analog circuit 3, the multiply-accumulate operation illustrated in FIG. 13 can be realized. It should be noted that the threshold value is defined in accordance with the time constant curve on the basis of the input period T and is used as the common threshold value.

It should be noted that the charging mode and the threshold setting are not limited.

Any configuration and method for realizing the charging on the common charging mode and the threshold determination with the common threshold value may be employed. Moreover, they may be combined with the configuration, method, and the like for realizing the above-mentioned multiply-accumulate operation illustrated in FIG. 13.

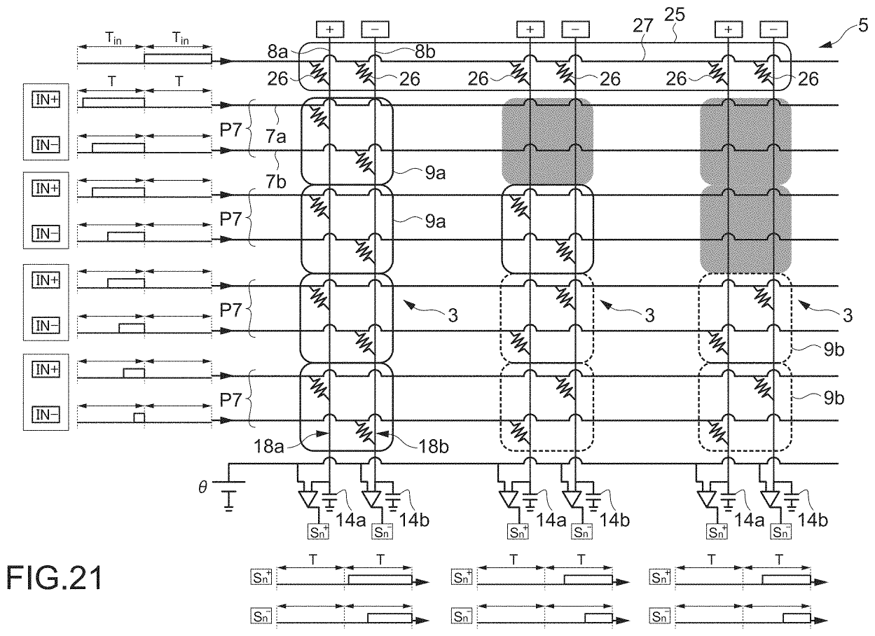

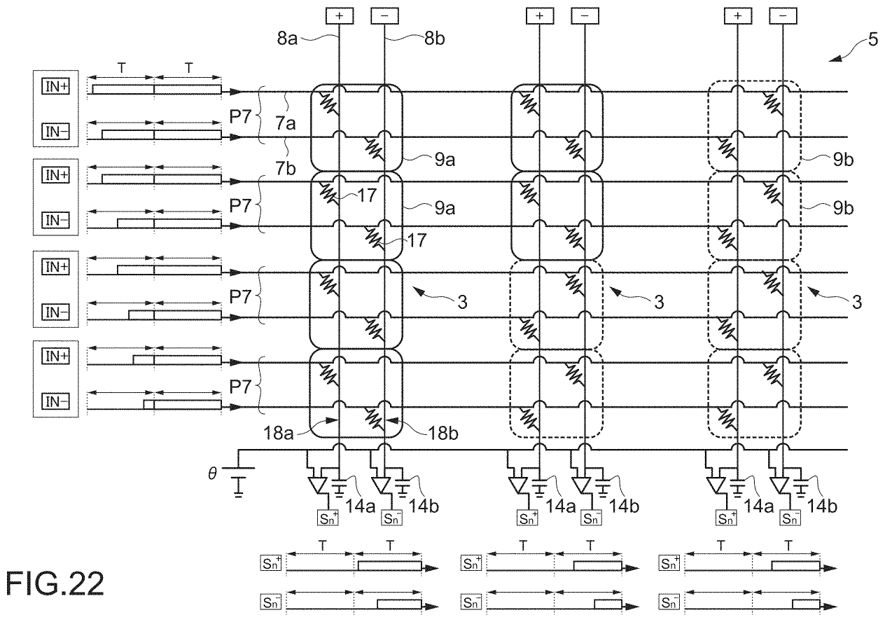

FIGS. 21 and 22 are schematic diagrams showing a configuration example of the arithmetic circuit unit 5 in the arithmetic apparatus 200 having the two-input two-output configuration.

The arithmetic circuit unit 5 illustrated in FIGS. 19 and 20 includes a plurality of input signal line pairs P7 and a plurality of analog circuits 3 connected in parallel to the plurality of input signal line pairs P7.

In the arithmetic circuit unit 5 illustrated in FIG. 21, signals according to the PWM method are used as the signal pair (input signals) corresponding to the input value xᵢ. Then, in the output period (charging period) T, a charging circuit 25 including charging resistors 26 and a charging line 27 charges the capacitors 14a and 14b.

In the arithmetic circuit unit 5 illustrated in FIG. 22, signals according to the TACT method are used as the signal pair (input signals) corresponding to the input value xᵢ. In the output period (charging period) T, the signal pair whose ON-state is maintained charges the capacitors 14a and 14b.

As in the arithmetic apparatus 100 having the one-input one-output configuration, the charging by the charging unit is performed on a common charging mode with respect to the plurality of analog circuits 3.

Moreover, a common threshold value is set as the predetermined threshold used for threshold determination performed by the signal output unit 12 in the neuron circuit 10.

That is, in each analog circuit 3, the charging is performed on the same charging mode and the threshold determination is performed using the same threshold value.

In each analog circuit 3, the common charging mode is performed with respect to each of the capacitors 14a and 14b. That is, the charging is performed on the common charging mode with respect to the plurality of capacitors 14a and 14b included in the plurality of analog circuits 3.

Then, in the plurality of analog circuits 3, the threshold determination is performed with the common threshold value and a multiply-accumulate result signal is output. Accordingly, the efficiency and speed of the arithmetic operation can be increased.

It should be noted that in the arithmetic apparatus 200 having the two-input two-output configuration, the positive and negative multiply-accumulate result signals can be used as they are as inputs (signal pair) to a next layer. Therefore, a difference circuit for generating positive or negative total multiply-accumulate result signals on the basis of the positive and negative multiply-accumulate result signals becomes unnecessary.

For example, such a configuration that it is sufficient to arrange only one difference circuit for generating a final multiply-accumulate result signal can be realized. As a result, the circuit configuration can be simplified, and the power consumption of the arithmetic apparatus 200 can be greatly reduced.

For example, there is a case where an MLP method is used as one of algorithms for deep-layer learning. The MLP method can provide a fully-connected configuration, for example, and does not require performing special processing and the like between a pre-stage and a post-stage of the multiply-accumulate operation.

Thus, in a case where processes of calculating positive or negative total multiply-accumulate result signals (differences between positive and negative multiply-accumulate results) after multiply-accumulate operations can be reduced, circuits and the like for difference calculation can be reduced.

In this case, an MLP network can be implemented only with a crossbar wiring structure and a comparator circuit using resistors (resistance elements) as weights without mounting unnecessary circuits. Therefore, high-speed arithmetic processing can be performed with an extremely simplified circuit configuration.

As a matter of course, the MLP method can also be realized by the use of the arithmetic apparatus having the one-input one-output configuration.

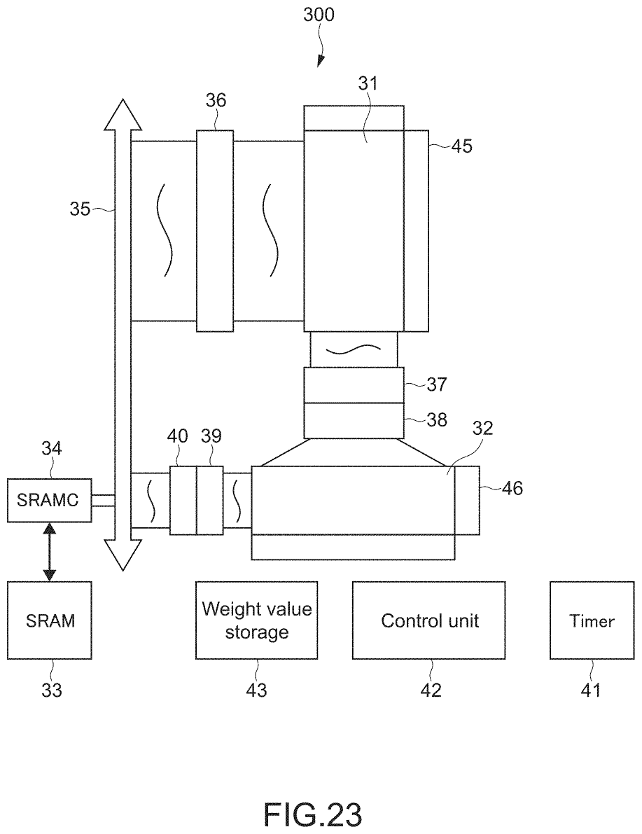

FIG. 23 is a schematic diagram showing a configuration example of an inference apparatus including the arithmetic apparatus according to the present technology. An inference apparatus 300 is an inference apparatus utilizing a neural network and realizes inference according to the MLP method.

In this embodiment, the inference apparatus 300 infers any one of numbers from 0 to 9, which are manually written letters written in a touch panel having total 784 (28×28) pixels. That is, which one of the numbers from 0 to 9 is written is inferred on the basis of data regarding the 784 pixels.

The inference apparatus 300 includes a first arithmetic circuit unit 31, a second arithmetic circuit unit 32, an SRAM 33, a SRAM controller (SRAMC) 34, a bus 35, a D/A converter 36, ReLU circuits 37, an enlargement circuit 38, a difference circuit 39, and an A/D converter 40. The inference apparatus 300 further includes a timer 41, a control unit 42, a weight value storage 43.

The control unit 42 is capable of comprehensively controlling overall operations of the inference apparatus 300. The configuration of the control unit 42 is not limited, and any hardware and software may be used. For example, a programmable logic device (PLD) such as a field programmable gate array (FPGA) and other devices such as an application specific integrated circuit (ASIC) may be used.

The timer 41 supplies time (timing) information to the control unit 42. The timer 41 also supplies a time that is a reference to a clock in the D/A converter (DTC: digital-to-time converter) 36 and a clock in the A/D converter (TDC: time-to-digital converter) 40.

The specific configuration of the timer 41 is not limited.

The weight value storage 43 retains information regarding weight values set to the respective synapse circuits 9 of the first arithmetic circuit unit 31 and the second arithmetic circuit unit 32. For example, the weight values are calculated by learning processing performed by a computer and the like (not shown) and are stored in the storage 43. As necessary, the control unit 42 reads the information regarding the weight values from the storage 43 and performs writing processing with respect to the first arithmetic circuit unit 31 and the second arithmetic circuit unit 32.

As shown in FIG. 23, the first arithmetic circuit unit 31 and the second arithmetic circuit unit 32 are respectively provided with writing circuits 45 and 46. The writing circuits 45 and 46 are typically electrically connected to each synapse circuit 9 via an input signal line 7 and a charge output line 8.

For example, in a case where a configuration using a volatile memory such as an SRAM is employed as the configuration for setting the weight values (the resistance values), it is necessary to perform writing every time after it is powered on.

Also, in a case where a configuration using a nonvolatile memory is employed as the configuration for setting the weight values (the resistance values), writing processing is performed in updating the weight values, for example. Moreover, the weight values can also be updated as appropriate after a predetermined number of times of inference are performed, for example.

The specific configuration of the storage 43 is not limited. Moreover, the specific configurations of the writing circuits 45 and 46 are also not limited.

The first arithmetic circuit unit 31 is the arithmetic circuit unit 5 having the two-input two-output configuration which is illustrated in FIGS. 21 and 22.

An input signal line pair P7 (positive input signal line 7a and negative input signal line 7b) is arranged with respect to data regarding one single pixel. Thus, the total number of plurality of input signal lines 7 is 1568 (784×2).

Moreover, a total of 100 analog circuits 3 including positive charge output lines 8a and negative charge output lines 8b are arranged in parallel. Thus, the total number of charge output lines 8 arranged so as to intersect with the plurality of input signal lines 7 is 200 (100×2).

As illustrated in FIG. 18, in each analog circuit 3, the positive multiply-accumulate result signal Sₙ⁺(t) is output on the basis of the positive weight charge output from the positive charge output line 8a and the negative multiply-accumulate result signal Sₙ⁻(t) is output on the basis of the negative weight charge output from the negative charge output line 8b.

The second arithmetic circuit unit 32 is also the arithmetic circuit unit 5 having the two-input two-output configuration.

The positive input signal line 7a and the negative input signal line 7b are arranged corresponding to the positive multiply-accumulate result signal Sₙ⁺(t) and the negative multiply-accumulate result signal Sₙ⁻(t) that are output from the single analog circuit 3 of the first arithmetic circuit unit 31. Thus, the total number of the plurality of input signal lines 7 is 200.

Moreover, ten analog circuits 3 including positive charge output lines 8a and negative charge output lines 8b are arranged in parallel. Thus, the total number of charge output lines 8 (positive charge output lines 8a and negative charge output lines 8b) arranged so as to intersect with the plurality of input signal lines 7 is 20 (10×2).

As illustrated in FIG. 18, each analog circuit 3 outputs a positive multiply-accumulate result signal Sₙ⁺(t) on the basis of a positive weight charge output from the positive charge output line 8a. Also, each analog circuit 3 outputs a negative multiply-accumulate result signal Sₙ⁻(t) on the basis of a negative weight charge output from the negative charge output line 8b.

It should be noted that the arithmetic circuit units 5 having the one-input one-output configuration, which are illustrated in FIGS. 19 and 20, may be configured as the first arithmetic circuit unit 31 and the second arithmetic circuit unit 32. The present technology can also be applied in this case.

The SRAM 33 stores pixel data for the 784 pixels. Moreover, the SRAM 33 stores outputs (inference results) from the inference apparatus 300. The specific configuration of the SRAM 33 is not limited. Alternatively, another storage device may be used.

In accordance with an instruction from the control unit 42, the SRAMC 34 reads pixel data from the SRAM 33 and outputs the pixel data to the D/A converter 36 via the bus 35. Moreover, the SRAMC 34 receives a signal of the inference result from the A/D converter 40 and writes the signal in the SRAM 33.

The bus 35 is constituted by, for example, an address bus, a data bus, a control bus, and the like (all not shown). The pixel data for the 784 pixels is output to the D/A converter 40 via the bus 35. Moreover, ten outputs (inference results) corresponding to the numbers from 0 to 9, are transmitted from the A/D converter 40, are transmitted to the SRAMC 34 via the bus 35.

The D/A converter 36 is constituted by 784 D/A blocks corresponding to the pixel data for the 784 pixels. The 784 D/A blocks have the same configuration. Using the pixel data (pixel value) as the input value xᵢ, each D/A block generates an analog signal corresponding to the input value xᵢ as an input signal to the first arithmetic circuit unit 31.

In this embodiment, the arithmetic circuit units 5 each having the two-input two-output configuration are configured as the first arithmetic circuit unit 31 and the second arithmetic circuit unit 32. Thus, each of the 784 D/A blocks generates a signal pair as illustrated in FIG. 4 as the analog signal corresponding to the pixel value (input value xᵢ).

The specific configuration of the D/A converter 36 (D/A blocks) is not limited, and may be arbitrarily designed.

The ReLU circuits 37 are activation functions. The ReLU circuits 37 are configured for the respective analog circuits 3 of the first arithmetic circuit unit 31 on a one-to-one basis. The positive multiply-accumulate result signal Sₙ⁺(t) and the negative multiply-accumulate result signal Sₙ⁻(t) output from each analog circuit 3 are input into each ReLU circuit 37.

For example, the ReLU circuit 37 outputs the input value as it is in a case where the input value is equal to or larger than 0, and the ReLU circuit 37 outputs 0 in other cases. That is, referring to FIG. 18, in a case where rising of the positive multiply-accumulate result signal Sₙ⁺(t) is earlier than or at the same time as rising of the negative multiply-accumulate result signal Sₙ⁻(t), two signals for which the difference between the rising timings is maintained are output as the positive and negative signals.

In a case where rising of the positive multiply-accumulate result signal Sₙ⁺(t) is later than rising of the negative multiply-accumulate result signal Sₙ⁻(t), two signals for which the difference between the rising timings is 0 are output as the positive and negative signals.

The positive and negative signals output from the ReLU circuit 37 are signals generated on the basis of the positive multiply-accumulate result signal Sₙ⁺(t) and the negative multiply-accumulate result signal Sₙ⁻(t).

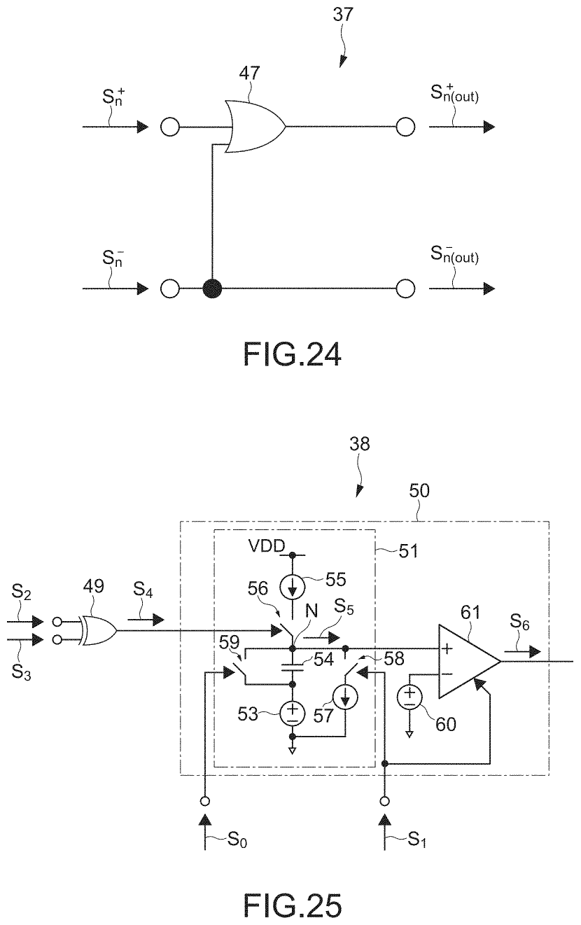

FIG. 24 is a diagram showing a configuration example of the ReLU circuit 37. The ReLU circuit 37 includes a logic circuit.

The logic circuit is roughly classified into a combination circuit and a sequential circuit. The combination circuit is a circuit in which a current output signal depends only on a current input signal and does not depend on past input signals. The combination circuit can include a logical sum circuit (OR circuit), a logical conjunction circuit (AND circuit), and the like.

The sequential circuit is a circuit in which a current output signal depends on a current input signal and past input signals. The sequential circuit can include a D flip-flop, an RS flip-flop, and the like.

As shown in FIG. 24, the ReLU circuit 37 includes a logical sum circuit (OR circuit) 47 that is the combination circuit.

The logical sum circuit 47 performs a logical sum operation on the positive multiply-accumulate result signal Sₙ⁺(t) and the negative multiply-accumulate result signal Sₙ⁻(t) and outputs a signal that is the logical sum operation result as a positive signal Sₙ⁺_{(OUT)}(t).

The logical sum circuit 47 outputs the negative multiply-accumulate result signal Sₙ⁻(t) as it is as a negative signal Sₙ⁻_{(OUT)}(t).

For example, by employing such a configuration, activation processing can be performed without requiring time-to-digital conversion circuits. Accordingly, downsizing and low power consumption of the apparatus can be achieved. As a matter of course, the configuration of the ReLU circuit 37 is not limited to the configuration illustrated in FIG. 24.

The enlargement circuit 38 is a circuit for enlarging an input analog signal. In this embodiment, the difference (time) between the rising timings of the positive signal Sₙ⁺_{(OUT)}(t) and the negative signal Sₙ⁻_{(OUT)}(t) output from the ReLU circuit 37 is enlarged.

FIG. 25 is a diagram showing a configuration example of the enlargement circuit 38.

In the enlargement circuit 38 shown in FIG. 25, the positive signal Sₙ⁺_{(OUT)}(t) output from the ReLU circuit 37 is input as a signal S₂. The negative signal Sₙ⁻_{(OUT)}(t) output from the ReLU circuit 37 is input as a signal S₃.

The enlargement circuit 38 includes a first time length signal output circuit 49 that outputs a signal S4 that is a first time length signal representing a time length between a first timing at which the signal S₂ changes and a second timing at which the signal S₃ changes.

Moreover, the enlargement circuit 38 includes a second time length signal output circuit 50 that outputs, at a timing based on a signal S₁ that is an enable control signal, the signal S4 as a enable control signal that is a second time length signal.

The first time length signal output circuit 49 is an exclusive logical sum circuit (XOR circuit) that performs an exclusive logical sum operation on the signal S₂ and the signal S₃ and is the combination circuit.

The second time length signal output circuit 50 includes a charging/discharging circuit 51 that charges a capacitor 54 with charges on the basis of the signal S4 and discharges the capacitor 54 on the basis of the signal S₁ that is the enable control signal.

The charging/discharging circuit 51 includes a first constant-voltage source 53 that outputs a reference potential V_{ref}. The charging/discharging circuit 51 further includes the capacitor 54 whose one end is electrically connected to the first constant-voltage source 53 and whose other end is electrically connected to a node N.

The charging/discharging circuit 51 further includes a first constant-current source 55 whose one end is electrically connected to a power supply potential VDD on a high-potential side. The charging/discharging circuit 51 further includes a first switch 56 whose input/output path is connected between the other end of the first constant-current source 55 and the node N and whose control terminal is supplied with the signal S4.

The charging/discharging circuit 51 further includes a second constant-current source 57 whose one end is connected to the reference potential. The charging/discharging circuit 51 further includes a second switch 58 whose input/output path is connected between the node N and the other end of the second constant-current source 57 and whose control terminal is supplied with the signal S₁.

The charging/discharging circuit 51 further includes a third switch 59 whose input/output path is connected to the both ends of the capacitor 54 and whose control terminal is supplied with a signal S₀ that is a reset signal.

The second time length signal output circuit 50 includes a comparator 61 whose inverted input terminal is electrically connected to a second constant-voltage source 60 that outputs the reference potential V_{ref} and whose non-inverted input terminal is electrically connected to the node N.

The comparator 61 compares a signal S5 with the reference potential V_{ref} and outputs the high-level enable control signal in a period in which the signal S5 is equal to or larger than the reference potential V_{ref}.

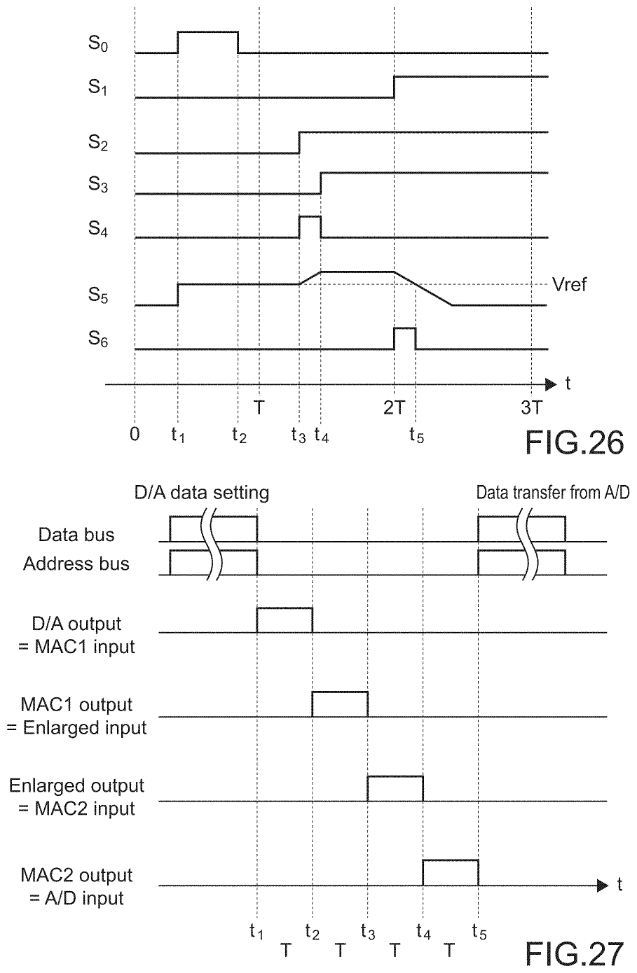

FIG. 26 is a timing chart showing an operation timing of the enlargement circuit 38.

A period from a timing 0 to a prescribed timing T is a reset period. During a period from a timing t1 to timing t2, the signal S₀ that is the reset signal is at the high level.

At the timing t1 when the signal S₀ becomes high level, the third switch 59 in the enlargement circuit 38 enters the ON-state, and therefore the both ends of the capacitor 54 are short-circuited. Thus, the signal S₅ that is the potential of the node N becomes the reference potential V_{ref}.

A period from the timing T to a prescribed timing 2T is a charge period.

At a timing t3, the signal S₂ becomes high level. Since the signal S₂ becomes high level, the first time length signal output circuit 49 that is the exclusive logical sum circuit outputs the high-level signal S₄.

Since the signal S₄ becomes high level, the first switch 56 enters the ON-state. Since the first switch 56 enters the ON-state, the first constant-current source 55 charges the capacitor 54. Thus, the signal S₅ that is the potential of the node N rises in a straight line form.

At a timing t4, the signal S₃ becomes high level. Since the signal S₃ becomes high level, the first time length signal output circuit 49 that is the exclusive logical sum circuit outputs the low-level signal S₄.

Since the signal S₄ becomes low level, the first switch 56 enters the OFF-state. Since the first switch 56 enters the OFF-state, the capacitor 54 is not charged. Thus, the signal S₅ that is the potential of the node N stops increasing and becomes constant.

Here, assuming that the current value of the first constant-current source 55 is denoted by I_{charge}, the capacitance value of the capacitor 54 is denoted by C, and the time length from the timing t3 to the timing t4 is denoted by ΔT_{charge}, a voltage V_{c} of the capacitor 54 is expressed by the following expression (27).

V_{c}=(I_{charge}/C)*ΔT_{charge}+V_{ref} (27)

A period from the timing 2T to a prescribed timing 3T is the output period.

At the timing 2T, the signal S₁ that is the enable control signal becomes high level.

In the enlargement circuit 38, since the signal S₁ becomes high level, the second switch 58 enters the ON-state. Since the second switch 58 enters the ON-state, the second constant-current source 57 discharges the capacitor 54. Thus, the signal S₅ that is the potential of the node N falls in a straight line form.

At the timing 2T, the potential of the signal S₅ is higher than the reference potential V_{ref} in accordance with the above-mentioned expression (3). Thus, the comparator 61 outputs the high-level enable control signal.

At the timing t5, the signal S₅ that is the potential of the node N of the enlargement circuit 38 is lower than the reference potential V_{ref}. Thus, the comparator 61 outputs the low-level enable control signal.

Here, assuming that the current value of the second constant-current source 57 is denoted by I_{discharge}, a time length ΔT_{discharge} from the timing 2T to the timing t5 is expressed by the following expression (28).

$$Δ {T}_{discharge} = ( {V}_{c} - {V}_{ref} ) / ( {I}_{discharge} / C ) = ( {I}_{charge} / {I}_{discharge} ) * Δ {T}_{charge} \qquad ( 28 )$$

Thus, the time length ΔT_{discharge} is proportional to the time length ΔT_{charge}. That is, the discharge time is proportional to the charge time.

Provided that I_{discharge}=I_{charge} is established, the charging/discharging circuit 51 is capable of setting the time length ΔT_{discharge} to be equal to the time length ΔT_{charge}. That is, the charging/discharging circuit 51 is capable of setting the discharge time to be equal to the charge time.

Provided that I_{discharge}<I_{charge} is established, the charging/discharging circuit 51 is capable of setting the time length ΔT_{discharge} to be longer than the time length ΔT_{charge}.

That is, the charging/discharging circuit 51 is capable of setting the discharge time to be longer than the charge time. Accordingly, the charging/discharging circuit 51 can realize an amplification function with respect to time information of the input.

By employing such a configuration and making adjustment such that I_{discharge}<I_{charge} is established, enlargement processing can be performed without requiring time-to-digital conversion circuits. That is, input time information can be amplified. As a result, downsizing and low power consumption of the apparatus can be achieved. As a matter of course, the configuration of the enlargement circuit 38 is not limited to the configuration illustrated in FIG. 25.

Referring back to FIG. 23, on the basis of differences between ten pairs of positive multiply-accumulate result signals Sₙ⁺(t) and negative multiply-accumulate result signals Sₙ⁻(t) output from the respective neuron circuits 10 of the second arithmetic circuit unit 32, the difference circuit 39 outputs ten multiply-accumulate result signals (analog signals including time information) representing a total multiply-accumulate result signal. The specific configuration of the difference circuit 39 is not limited.

The A/D converter 40 is constituted by ten A/D blocks. The ten A/D blocks have the same configuration.

Each A/D block converts each multiply-accumulate result signal output from the difference circuit 39 into a digital signal. That is, a digital signal having a value corresponding to time information included in the multiply-accumulate result signal is generated and output.

The specific configuration of the A/D converter 40 (A/D blocks) is not limited, and may be arbitrarily designed.

FIG. 27 is a timing chart showing an operation example at the time of inference by the inference apparatus 300.

In FIG. 27, the first arithmetic circuit unit 31 will be referred to as MAC (analog multiply-accumulate matrix) 1. Moreover, the second arithmetic circuit unit 32 will be referred to as MAC2.

Moreover, each of intervals T from t1 to t5 is the input period T (=the output period T) shown in FIG. 10, FIG. 17, and the like.

Before Time t1: The control unit 42 makes an instruction to the SRAMC 34 and sets the data for the 784 pixels from the SRAM 33 to registers of the D/A converter 36 sequentially (784 times).

The control unit 42 instructs the timer 41 to “inform of a timing at intervals T having a time width determined in advance”. The first timing corresponds to t1 in the figure.

Time t1: The control unit 42 instructs the D/A converter 36 to start an operation. For example, each D/A block of the D/A converter 36 generates a signal pair (see FIG. 4) corresponding to the value stored in the registers and outputs the signal pair to the first arithmetic circuit unit 31.

Time t2: The output from the first arithmetic circuit unit 31 starts and is input into the enlargement circuit 38 via the ReLU circuit 37.

Time t3: The output from the enlargement circuit 38 starts and is input into the second arithmetic circuit unit 32.

Time t4: The output from the second arithmetic circuit unit 32 starts and is input into the A/D converter 40 from the difference circuit 39. At the same time, the control unit 42 instructs the SRAMC 34 to cause the SRAMC 34 to store ten outputs of the A/D converter 40 in the SRAM 33.

In this manner, an analogical result with respect to a total of 784 inputs (28×28) are calculated.

[Equal-Length Wiring Configuration]

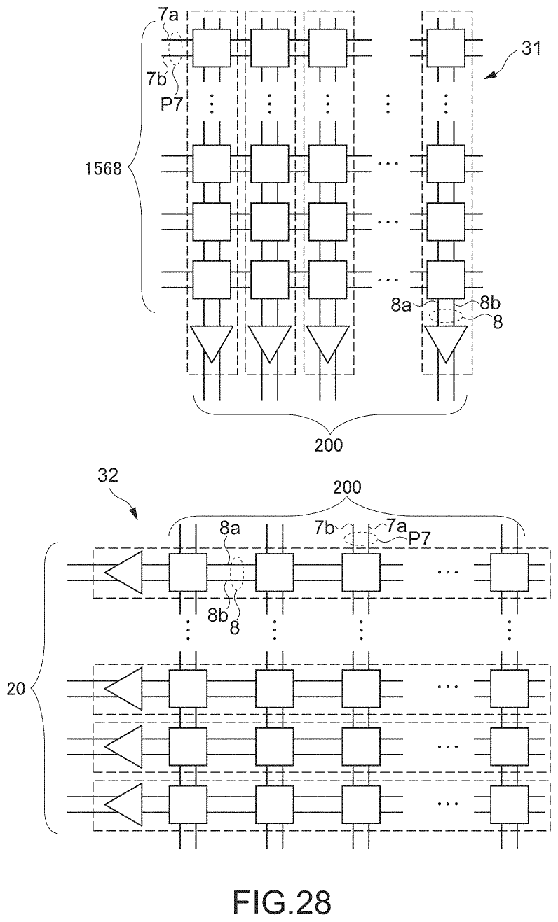

FIG. 28 is a schematic diagram showing the first arithmetic circuit unit 31 and the second arithmetic circuit unit 32 of the inference apparatus 300.

As described above, the first arithmetic circuit unit 31 is the arithmetic circuit unit having the two-input two-output configuration. Seven hundred eighty-four input signal line pairs P7 (positive input signal lines 7a and negative input signal lines 7b) are arranged corresponding to the 784-pixels data.

One hundred pairs of charge output lines 8 (positive charge output lines 8a and negative charge output lines 8b) are arranged so as to intersect with the 784 input signal line pairs P7.

The second arithmetic circuit unit 32 is also the arithmetic circuit unit having the two-input two-output configuration. One hundred input signal line pairs P7 (positive input signal lines 7a and negative input signal lines 7b) are arranged corresponding to 100 pairs of positive multiply-accumulate result signals Sₙ⁺(t) and negative multiply-accumulate result signals Sₙ⁻(t) output from the first arithmetic circuit unit 31.

Ten pairs of charge output lines 8 (positive charge output lines 8a and negative charge output lines 8b) are arranged so as to intersect with the 100 input signal line pairs P7.

Here, with respect to the arithmetic circuit unit 5 (31, 32), the “plurality of input lines” and the “plurality of output lines” are defined as follows.

The “plurality of input lines” is lines into each of which an electrical signal corresponding to an input value is input.

For example, in the arithmetic circuit unit 5 illustrated in FIGS. 19 and 20, the plurality of input signal lines 7 into which pulse signals corresponding to input values are input corresponds to the “plurality of input lines”.

In the arithmetic circuit unit 5 illustrated in FIGS. 21 and 22, the positive input signal line 7a and the negative input signal line 7b into which the signal pair generated in accordance with the input value is input are respectively the “plurality of input lines”.

That is, in the arithmetic apparatus 200 having the two-input two-output configuration, all the positive input signal lines 7a and the negative input signal lines 7b are the “plurality of input lines” irrespective of whether they are positive or negative.

Thus, for example, in a case where an N-number of input signal line pair P7 are arranged, a total of 2N (N×2) signal lines are the “plurality of input lines”.

The “plurality of output lines” is lines that are arranged in parallel so as to intersect with the “plurality of input lines”. That is, the “plurality of output lines” is lines that are arranged so as to have a crossbar configuration with respect to the “plurality of input lines”.

Moreover, each of the “plurality of output lines” is a line that outputs a multiply-accumulate signal generated on the basis of electrical signals input into the “plurality of input lines”.

It should be noted that the multiply-accumulate signal includes an arbitrary signal representing a sum of product values obtained by multiplying input values by weight values. For example, the multiply-accumulate signal includes a charge corresponding to a product value obtained by multiplying an input value xᵢ by a weight value wᵢ, a positive weight charge corresponding to a product value (wᵢ⁺*xᵢ) obtained by multiplying an input value xᵢ by a positive weight value wᵢ⁺, a negative weight charge corresponding to a product value (wᵢ⁻*xᵢ) obtained by multiplying an input value xᵢ by a negative weight value wᵢ⁻, and the like.

Moreover, the multiply-accumulate signal also includes, for example, a multiply-accumulate result signal generated on the basis of a positive weight charge and a negative weight charge.

Signal lines that are a plurality of signal lines arranged in parallel so as to intersect with the “plurality of input lines” and each output a multiply-accumulate signal are the “plurality of output lines”.

For example, in the arithmetic circuit unit 5 illustrated in FIGS. 19 and 20, the positive charge output lines 8a and the negative charge output lines 8b are respectively the “plurality of output lines”. Similarly, in the arithmetic circuit unit 5 illustrated in FIGS. 21 and 22, the positive charge output lines 8a and the negative charge output lines 8b are respectively the “plurality of output lines”.

That is, both in the arithmetic apparatus 100 having the one-input one-output configuration and the arithmetic apparatus 200 having the two-input two-output configuration, all the positive charge output lines 8a and the negative charge output lines 8b are the “plurality of output lines” irrespective of whether they are positive or negative.

Thus, for example, in a case where an M-number of pairs of charge output lines 8 are arranged, a total of 2M (M×2) signal lines are the “plurality of output lines”.

In the first arithmetic circuit unit 31 shown in FIG. 28, the positive input signal lines 7a and the negative input signal lines 7b included in the 784 input signal line pairs P7 are respectively the “plurality of input lines”. Moreover, the positive charge output lines 8a and the negative charge output lines 8b included in the 100 pairs of charge output lines 8 are respectively the “plurality of output lines”.

Thus, a total of 1568 (784×2) signal lines are the “plurality of input lines” and a total of 200 (100×2) signal lines are the “plurality of output lines”.

In the second arithmetic circuit unit 32, the positive input signal lines 7a and the negative input signal lines 7b included in the 100 input signal line pairs P7 are respectively the “plurality of input lines”. Moreover, the positive charge output lines 8a and the negative charge output lines 8b included in the ten pairs of charge output lines 8 are respectively the “plurality of output lines”.

Thus, a total of 200 (100×2) signal lines are the “plurality of input lines” and a total of 20 (10×2) signal lines are the “plurality of output lines”.

The “plurality of input lines” and the “plurality of output lines” were defined in the above-mentioned manner with respect to the arithmetic circuit unit 5 (31, 32) and an “equal-length wiring configuration” to be described below was newly devised as a physical arrangement configuration of two arithmetic circuit units 5 that are in a pre-stage-to-post-stage relationship.

The two arithmetic circuit units 5 that are in the pre-stage-to-post-stage relationship refer to two arithmetic circuit units 5 that are in such a relationship that multiply-accumulate signals output from the “plurality of output lines” of the arithmetic circuit unit 5 in the pre-stage or signals generated on the basis of the multiply-accumulate signals output from the “plurality of output lines” of the arithmetic circuit unit in the pre-stage are input into the “plurality of input lines” of the arithmetic circuit unit 5 in the post-stage as electrical signals corresponding to input values.

That is, the first arithmetic circuit unit 31 and the second arithmetic circuit unit 32 shown in FIG. 28 and the like are in the pre-stage-to-post-stage relationship.

Multiply-accumulate result signals (positive multiply-accumulate result signals Sₙ⁺(t) and negative multiply-accumulate result signals Sₙ⁻(t)) output from the first arithmetic circuit unit 31 are input into the second arithmetic circuit unit 32 via the ReLU circuits 37 and the enlargement circuit 38. Thus, signals generated on the basis of the multiply-accumulate signals (positive weight charge and negative weight charge) output from the “plurality of output lines” of the first arithmetic circuit unit 31 are input into the “plurality of input lines” of the second arithmetic circuit unit 32.

Hereinafter, “plurality of input lines” and the “plurality of output lines” will be denoted by new signs and the equal-length wiring configuration will be described. It should be noted that as to the application of the present technology, the number of “plurality of input lines” and the number of “plurality of output lines” are not limited.

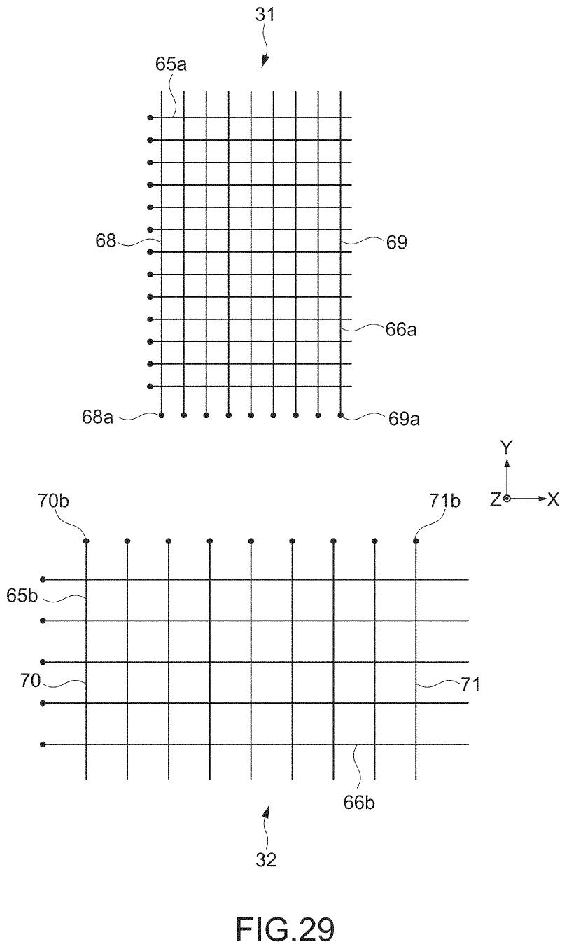

FIG. 29 is a schematic diagram showing an example of the equal-length wiring configuration.

As to the first arithmetic circuit unit 31, a plurality of input lines 65a is arranged in parallel using a predetermined direction as the extending direction. In the example shown in FIG. 29, the plurality of input lines 65a is arranged in parallel using the X direction in the XYZ-coordinate system as the extending direction. It should be noted that the plurality of input lines 65a is arranged in parallel so as to be arranged side by side in the Y direction orthogonal to the extending direction.

In the present disclosure, the “extending direction” of the signal lines is a concept including a direction that is a reference for the direction in which the signal line extends. For example, in a case where the signal lines extend straight in a predetermined direction, such a predetermined direction is the “extending direction”.

The present technology is not limited thereto. In a case where signal lines extend using a predetermined direction as the reference and are slightly deviated from the direction or slightly winding from the middle or have small steps or the like from the middle, such a predetermined direction is also the “extending direction” of the signal lines.

That is, a state in which a single direction can be determined as the direction in which the signal lines extend as all the signal lines are viewed can be referred to as a state in which the signal lines are arranged using a single direction as the “extending direction”.

In the present disclosure, the “extending direction” can be referred to as a main direction that is a reference of the direction in which the signal lines extend.

As to the first arithmetic circuit unit 31, a plurality of output lines 66a is arranged in parallel so as to intersect with the plurality of input lines 65a, using a direction different from the extending direction of the plurality of input lines 65a as the extending direction. In the example shown in FIG. 29, the plurality of output lines 66a is arranged in parallel using the Y direction as the extending direction. It should be noted that the plurality of output lines 66a is arranged in parallel so as to be arranged side by side in the X direction orthogonal to the extending direction.

Typically, the extending direction of the plurality of input lines 65a and the extending direction of the plurality of output lines 66a are designed to be orthogonal to each other. As a matter of course, the present technology is not limited thereto, and the plurality of input lines 65a and the plurality of output lines 66a may be each arranged so as to intersect with each other at an arbitrary angle.

Also as to the second arithmetic circuit unit 32, a plurality of input lines 65b is arranged in parallel using a predetermined direction as the extending direction. Moreover, a plurality of output lines 66b is arranged in parallel so as to intersect with the plurality of input lines 65b, using a direction different from the extending direction of the plurality of input lines 65b as the extending direction.

As shown in FIG. 29, as the equal-length wiring configuration, each circuit is arranged such that the extending direction of the plurality of input lines 65a of the first arithmetic circuit unit 31 and the extending direction of the plurality of output lines 66b of the second arithmetic circuit unit 32 are parallel to each other.

In the example shown in FIG. 29, the extending direction of the plurality of input lines 65a of the first arithmetic circuit unit 31 is the X direction. Thus, the second arithmetic circuit unit 32 is arranged such that the extending direction of the plurality of output lines 66b of the second arithmetic circuit unit 32 is parallel to the X direction.

As described above, a first feature of the newly devised equal-length wiring configuration can be that the extending direction of the plurality of input lines 65a of the first arithmetic circuit unit 31 and the extending direction of the plurality of output lines 66b of the second arithmetic circuit unit 32 are parallel to each other.

The extending direction of the plurality of input lines 65a of the first arithmetic circuit unit 31 corresponds to a first direction. Moreover, the extending direction of the plurality of output lines 66b of the second arithmetic circuit unit 32 corresponds to a second direction. In the example shown in FIG. 29, the first direction and the second direction are both parallel to the X direction and are parallel to each other.

It should be noted that in the example shown in FIG. 29, both in the first arithmetic circuit unit 31 and the second arithmetic circuit unit 32, the plurality of input lines and the plurality of output lines are arranged to be orthogonal to each other. In a case where such an arrangement is employed, when the equal-length wiring configuration is realized, the extending direction of the plurality of output lines 66a of the first arithmetic circuit unit 31 and the extending direction of the plurality of input lines 65b of the second arithmetic circuit unit 32 are parallel to each other.

Next, the focus is placed on end portions of two endmost output lines 68 and 69, which are located at endmost positions of the plurality of output lines 66a arranged in parallel in the first arithmetic circuit unit 31, the end portions being on the side of the second arithmetic circuit unit 32.

In the example shown in FIG. 29, the plurality of output lines 66a is arranged in parallel so as to be arranged side by side in the X direction. Thus, the two endmost output lines 68 and 69 located at the endmost positions are the output line 66a positioned on the leftmost side in the figure and the output line 66a positioned on the rightmost side in the figure.

The end portions of the two endmost output lines 68 and 69, which are on the side of the second arithmetic circuit unit 32, will be referred to as a first end portion 68a and a second end portion 68a, respectively.

Moreover, the focus is placed on end portions of two endmost input lines 70 and 71, which are located at endmost positions of the plurality of input lines 65b arranged in parallel in the second arithmetic circuit unit 32, the end portions being on the side of the first arithmetic circuit unit 31.

In the example shown in FIG. 29, the plurality of input lines 65b is arranged in parallel so as to be arranged side by side in the X direction. Thus, the two endmost input lines 70 and 71 located at the endmost positions are the input line 65b positioned on the leftmost side in the figure and the input line 65b positioned on the rightmost side.

The end portions of the two endmost input lines 70 and 71, which are on the side of the first arithmetic circuit unit 32, will be referred to as a third end portion 70b and a fourth end portion 71b.

It should be noted that the end portions of the output lines can be defined by end portions of wiring members arranged as the output lines, for example. Alternatively, the end portions of the output lines may be defined on the basis of, for example, input end portions of next elements that receive multiply-accumulate signals output from the output lines. For example, in the examples shown in FIGS. 5 and 7 and the like, the end portions of the output lines can be defined on the basis of input end portions to the neuron circuit 10.

Moreover, the end portions of the input lines can be defined by end portions of wiring members arranged as the input lines, for example. Alternatively, the end portions of the input lines may be defined on the basis of, for example, output end portions of the previous elements that output multiply-accumulate signals input into the input lines (or signals generated on the basis of the multiply-accumulate signals).

Otherwise, the equal-length wiring configuration according to the present technology may be realized with respect to arbitrary end portions that output multiply-accumulate signals of portions that constitute the output lines and arbitrary end portions into which multiply-accumulate signals of portions that constitute the input lines (or signals generated on the basis of the multiply-accumulate signals).

Here, a configuration in which a position in the X direction (first direction) of at least one of the first end portion 68a or the second end portion 69a of the first arithmetic circuit unit 31 is a position between a position in the X direction (first direction) of the third end portion 70b of the second arithmetic circuit unit 32 and a position in the X direction (first direction) of the fourth end portion 71b will be referred to as an “AA configuration” for the sake of convenience.

Moreover, a configuration in which the position in the X direction (first direction) of at least one of the third end portion 70b or the fourth end portion 71b of the second arithmetic circuit unit 32 is a position between a position in the X direction (first direction) of the first end portion 68a of the first arithmetic circuit unit 31 and a position in the X direction (first direction) of the second end portion 69a will be referred to as a “BB configuration” for the sake of convenience.

A second feature of the newly devised equal-length wiring configuration is that the AA configuration or the BB configuration is realized.

It should be noted that, for example, in a case where a three-dimensional coordinate system having a “certain direction” as a single coordinate axis is set in an actual three-dimensional space, a “position in the certain direction” can be defined with a coordinate value corresponding to the “certain direction”.

Thus, in the example shown in FIG. 29, an x-coordinate value in the XYZ-coordinate system in the figure can be defined as the position in the X direction (first direction).

Moreover, a state in which “a position A is a position between a position B and a position C” in the “certain direction” corresponds a state in which a coordinate value of the position A corresponding to the “certain direction” is equal to or larger than a coordinate value of the position B and equal to or smaller than the coordinate value of the position C. Thus, the state in which “the position A is the position between the position B and the position C” in the “certain direction” also include a state in which the coordinate value of the position A is equal to the coordinate value of the position B or the coordinate value of the position C.

Hereinafter, the position of each end portion in the X direction (first direction) will be simply referred to as the position of each end portion in some cases.

In the example shown in FIG. 29, the positions of the first end portion 68a and the second end portion 69a are both configured to be positions between the position of the third end portion 70b and the position of the fourth end portion 71b. That is, the AA configuration is realized.

Moreover, the positions of the first end portion 68a and the second end portion 69a are both configured to be positions different from both of the position of the third end portion 70b and the position of the fourth end portion 71b. That is, no end portions exist at the same positions in the X direction as the first end portion 68a and the second end portion 69a.

It can also be said that the positions of the third end portion 70b and the fourth end portion 71b are both configured to be positions different from both of the position of the first end portion 68a and the position of the second end portion 69a.

Here, a distance (width) in the X direction (first direction) between the two endmost output lines 68 and 69, i.e., a distance (width) in the X direction (first direction) between the first end portion 68a and the second end portion 69a will be referred to as a width of an output end of the first arithmetic circuit unit 31.

Moreover, a distance (width) in the X direction (first direction) between the two endmost input lines 70 and 71, i.e., a distance (width) in the X direction (first direction) between the third end portion 70b and the fourth end portion 71b will be referred to as a width of an input end of the second arithmetic circuit unit 32.

In the example shown in FIG. 29, the width of the input end of the second arithmetic circuit unit 32 is larger than the width of the output end of the first arithmetic circuit unit 31. Moreover, as viewed in the Y direction, the width of the output end of the first arithmetic circuit unit 31 is entirely included in the width of the input end of the second arithmetic circuit unit 32.

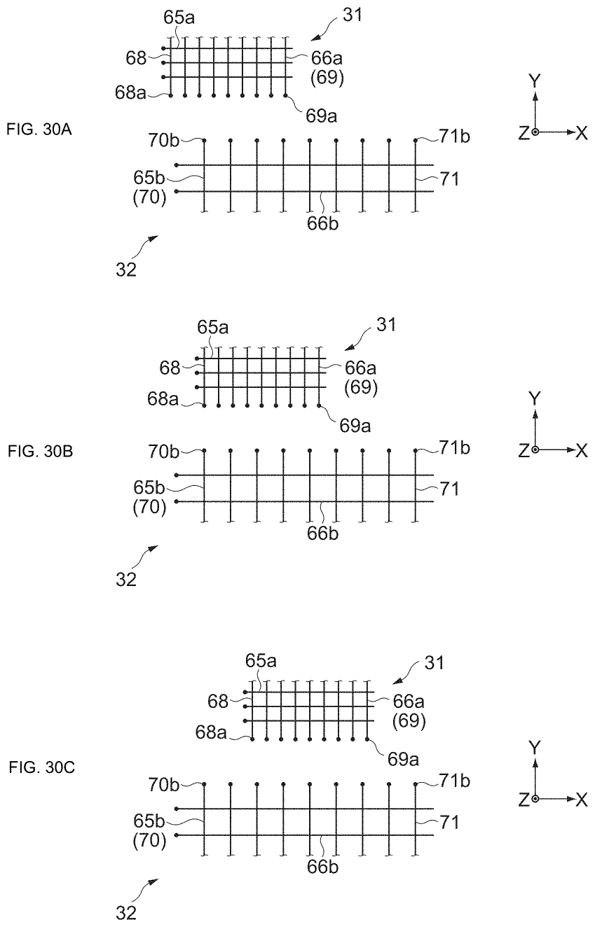

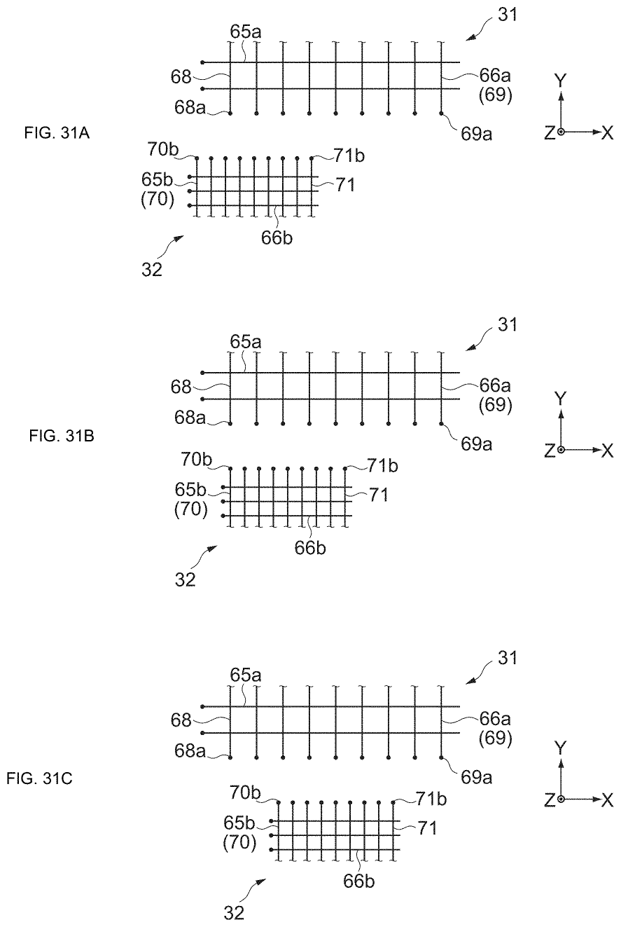

FIGS. 30 and 31 are schematic diagrams showing another example of the equal-length wiring configuration.

In FIG. 30A to C, the extending direction of the plurality of input lines 65a of the first arithmetic circuit unit 31 and the extending direction of the plurality of output lines 66b of the second arithmetic circuit unit 32 are parallel to each other (both are parallel to the X direction).

In FIG. 30A, the position of the second end portion 69a of the first arithmetic circuit unit 31 is configured to be a position between the position of the third end portion 70b and the position of the fourth end portion 71b of the second arithmetic circuit unit 32 (AA configuration).

It can also be said that the position of the third end portion 71b of the second arithmetic circuit unit 32 is configured to a position between the position of the first end portion 68a and the position of the second end portion 69a of the first arithmetic circuit unit 31 (BB configuration).

Moreover, the positions of the first end portion 68a and the second end portion 69a of the first arithmetic circuit unit 31 are both configured to be positions different from both of the position of the third end portion 70b and the position of the fourth end portion 71b of the second arithmetic circuit unit 32.

It can also be said that the positions of the third end portion 70b and the fourth end portion 71b are both configured to be positions different from both of the position of the first end portion 68a and the position of the second end portion 69a.

In FIG. 30B, the position of the second end portion 69a of the first arithmetic circuit unit 31 is configured to be a position between the position of the third end portion 70b and the position of the fourth end portion 71b of the second arithmetic circuit unit 32 (AA configuration).

Moreover, the position of the first end portion 68a of the first arithmetic circuit unit 31 is configured to be the same position as the position of the third end portion 70b of the second arithmetic circuit unit 32.

It can also be said that in this configuration, the position of the first end portion 68a is a position between the position of the third end portion 70b and the position of the fourth end portion 71b (AA configuration). Moreover, it can also be said that the position of the third end portion 70b is a position between the position of the first end portion 68a and the position of the second end portion 68b (BB configuration).

FIG. 30C shows the same configuration as the equal-length wiring configuration illustrated in FIG. 29.

In the examples shown in FIGS. 29 and 30, a case where pitches of the plurality of input lines 65b arranged in parallel in the second arithmetic circuit unit 32 are larger than pitches of the plurality of output lines 66a arranged in parallel in the first arithmetic circuit unit 31 is shown as an example.

That is, a case where the width of the input end of the second arithmetic circuit unit 32 is larger than the width of the output end of the first arithmetic circuit unit 31 is shown as an example.

The present technology is not limited such a configuration, and as shown in FIG. 31, the equal-length wiring configuration can be realized also in a case where the pitches of the plurality of input lines 65b arranged in parallel in the second arithmetic circuit unit 32 are smaller than the pitches of the plurality of output lines 66a arranged in parallel in the first arithmetic circuit unit 31.

That is, the equal-length wiring configuration can be realized also in a case where the width of the input end of the second arithmetic circuit unit 32 is smaller than the width of the output end of the first arithmetic circuit unit 31.

In FIG. 31A to C, the extending direction of the plurality of input lines 65a of the first arithmetic circuit unit 31 and the extending direction of the plurality of output lines 66b of the second arithmetic circuit unit 32 are parallel to each other (both are parallel to the X direction).

In FIG. 31A, the position of the first end portion 68a of the first arithmetic circuit unit 31 is configured to a position between the position of the third end portion 70b and the position of the fourth end portion 71b of the second arithmetic circuit unit 32 (AA configuration).

It can also be said that the position of the fourth end portion 71b of the second arithmetic circuit unit 32 is configured to be a position between the position of the first end portion 68a and the position of the second end portion 69a of the first arithmetic circuit unit 32 (BB configuration).

Moreover, the positions of the first end portion 68a and the second end portion 69a of the first arithmetic circuit unit 31 are both configured to be positions different from both of the position of the third end portion 70b and the position of the fourth end portion 71b of the second arithmetic circuit unit 32.

It can also be said that the positions of the third end portion 70b and the fourth end portion 71b are both configured to be positions different from both of the position of the first end portion 68a and the position of the second end portion 68b.

In FIG. 31B, the position of the second end portion 69a of the first arithmetic circuit unit 31 is configured to a position between the position of the third end portion 70b and the position of the fourth end portion 71b of the second arithmetic circuit unit 32 (AA configuration).

Moreover, the position of the first end portion 68a of the first arithmetic circuit unit 31 is configured to be the same position as the position of the third end portion 70b of the second arithmetic circuit unit 32.

It can also be said that in this configuration, the position of the first end portion 68a is a position between the position of the third end portion 70b and the position of the fourth end portion 71b (AA configuration). Moreover, it can also be said that the position of the third end portion 70b is a position between the position of the first end portion 68a and the position of the second end portion 69a (BB configuration).

In FIG. 31C, the positions of the third end portion 70b and the fourth end portion 71b of the second arithmetic circuit unit 32 are both configured to be positions between the position of the first end portion 68a and the position of the second end portion 69a of the first arithmetic circuit unit 31 (BB configuration).

Moreover, the positions of the first end portion 68a and the second end portion 69a are both configured to be positions different from both of the position of the third end portion 70b and the position of the fourth end portion 71b.

It can also be said that the positions of the third end portion 70b and the fourth end portion 71b are both configured to be positions different from both of the position of the first end portion 68a and the position of the second end portion 69a.

In the example shown in FIG. 30C, the width of the input end of the second arithmetic circuit unit 32 is smaller than the width of the output end of the first arithmetic circuit unit 31. Moreover, as viewed in the Y direction, the width of the input end of the second arithmetic circuit unit 32 is entirely included in the width of the output end of the first arithmetic circuit unit 31. Also with such a configuration, the equal-length wiring configuration can be realized.

As illustrated in FIGS. 30 and 31, the equal-length wiring configuration can be realized in a case where the pitches of the plurality of output lines 66a arranged in parallel in the first arithmetic circuit unit 31 and the pitches of the plurality of input lines 65b arranged in parallel in the second arithmetic circuit unit 32 are different from each other.

The present technology is not limited thereto, and the equal-length wiring configuration can be realized also in a case where the pitches of the plurality of output lines 66a arranged in parallel in the first arithmetic circuit unit 31 and the pitches of the plurality of input lines 65b arranged in parallel in the second arithmetic circuit unit 32 are equal to each other.

In the examples shown in FIGS. 30 and 31, the first arithmetic circuit unit 31 and the second arithmetic circuit unit 32 are each configured such that the end portions on the input side of the plurality of input lines (65a, 65b) are located in the same straight line and the end portions on the output side of the plurality of output lines (66a, 66b) are located in the same straight line.

In such a case, a feature of the newly devised equal-length wiring configuration can be that the straight line direction in which the end portions on the output side of the plurality of output lines 66a of the first arithmetic circuit unit 31 are arranged side by side and the straight line direction in which the end portions on the input side of the plurality of input lines 65b of the second arithmetic circuit unit 32 are arranged side by side are configured to be parallel to each other (both are parallel to the X direction).

As a matter of course, the equal-length wiring configuration can be realized also in a case where the end portions on the input side of the plurality of input lines (65a, 65b) are not located in the same straight line or in a case where the end portions on the output side of the plurality of output lines (66a, 66b) are not located in the same straight line.

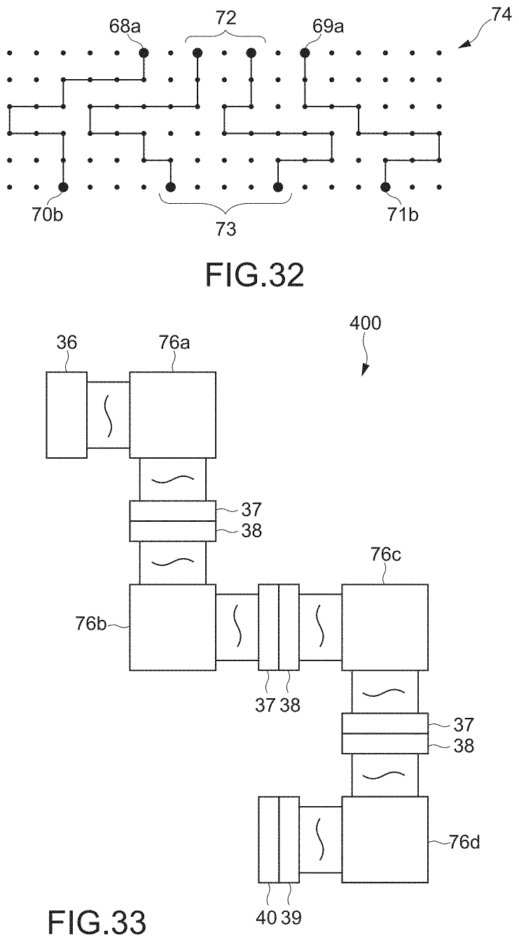

FIG. 32 is a schematic diagram showing an equal-length wiring example in a case where the equal-length wiring configuration is realized.

In FIG. 32, the equal-length wiring configuration illustrated in FIGS. 29 and 30C is realized.

That is, the positions of the first end portion 68a and the second end portion 69a are both configured to be positions between the position of the third end portion 70b and the position of the fourth end portion 71b.

Moreover, the positions of the first end portion 68a and the second end portion 69a are both configured to be positions different from both of the position of the third end portion 70b and the position of the fourth end portion 71b.

In addition, the pitches of the plurality of input lines 65b arranged in parallel in the second arithmetic circuit unit 32 are larger than the pitches of the plurality of output lines 66a arranged in parallel in the first arithmetic circuit unit 31.

A region between the end portions 68a, 72, and 69a of the plurality of output lines 66a of the first arithmetic circuit unit 31 and the end portions 70b, 73, and 71b of the plurality of input lines 65b of the second arithmetic circuit unit 32, which are shown in FIG. 32, will be referred to as an equal-length wiring region 74.

This equal-length wiring region 74 is divided in in a grid form such that a plurality of grid (lattice) squares having the same size is arranged side by side. As shown in FIG. 32, equal-length wires can be arranged from the end portions 68a, 72, and 69a of the output lines 66a to the end portions 70b, 73, and 71b of the corresponding input lines 65b so as to have an equal length equivalent to one side of the grid square×12.

As a matter of course, the example shown in FIG. 32 is illustrative and the equal-length wiring can be realized also with another wiring configuration.

As described above, the equal-length wiring configuration as illustrated in FIGS. 29 to 31 are realized with respect to the first arithmetic circuit unit 31 and the second arithmetic circuit unit 32 that are the pre-stage-to-post-stage relationship. Accordingly, it is very advantageous for causing the wires from the respective end portions of the plurality of output lines 66a of the first arithmetic circuit unit 31 to the respective end portions of the corresponding plurality of input lines 65b of the second arithmetic circuit unit 32 to be equal-length wires.

Moreover, it is possible to shorten the lengths of the wires from the respective end portions of the plurality of output lines 66a of the first arithmetic circuit unit 31 to the respective end portions of the corresponding plurality of input lines 65b of the second arithmetic circuit unit 32, and unnecessary wire lengths can be saved.

Making the wire lengths from the end portions of the output lines 66a to the end portions of the corresponding input lines 65b equal leads to making the parasitic capacitances, which are produced due to the wiring portions, equal. Accordingly, delay times of analog signals can be made to equal, and transmission errors of analog signals can be reduced.

Since information is transmitted using a timing (point of time) or a pulse width (period of time) especially in a time-axis analog multiply-accumulate method, the arithmetic operation accuracy can be greatly improved by reducing irregularities in the delay time.

Moreover, the wire lengths from the end portions of the output lines 66a to the end portions of the corresponding input lines 65b can be shortened, and therefore the timing delay compensation by external circuits can be reduced. As a result, the latency can be shortened.

Moreover, it is also advantageous to set the inputs into the second arithmetic circuit unit 32 to have the same condition because the wire lengths can be shortened.

It should be noted that there can also be a case where all the wire lengths from the end portions of the output lines 66b to the end portions of the input lines 65a are not equal. Moreover, there can also be a case where all the wire lengths are not precisely equal and have some irregularities in the length.

However, by employing the newly devised equal-length wiring configuration, it is possible to set many wires from the end portions of the output lines 66a to the end portions of the input lines 65b to be equal or set many wires from the end portions of the output lines 66a to the end portions of the input lines 65b to be variable in a sufficiently small range using a predetermined length as a reference. As a result, the above-mentioned effects can be sufficiently exerted.

It can also be said that the equal-length wiring configuration according to the present technology is a technology that enables, in the arithmetic apparatus that constitutes the plurality of arithmetic circuit units 5 according to the analog method that inputs and outputs analog signals, the wires between the arithmetic circuit units 5 to be set to have an equal length (equal capacity, equal delay time) and to be shortened by imposing a suitable limitation on the arrangement of the arithmetic circuit units 5.

The features of the equal-length wiring configurations illustrated in FIGS. 29 to 31 can also be defined by using other expressions.

For example, an edge connecting the first end portion 68a and the second end portion 69b is defined as an output edge of the first arithmetic circuit unit 31. An edge connecting the third end portion 70b and the fourth end portion 71b is defined as an input edge of the second arithmetic circuit unit 32.

Then, for example, the configuration of in FIG. 30C or FIG. 31C can be expressed as a configuration in which normal lines, which are drawn from both ends of shorter one of the output edge of the first arithmetic circuit unit 31 and the input edge of the second arithmetic circuit unit 32 to longer one, do not depart from both ends of the longer one.

In this manner, the features of the equal-length wiring configuration according to the present technology may be defined using the expressions, which are the output edge of the first arithmetic circuit unit 31, the input edge of the second arithmetic circuit unit 32, and the normal lines from the both ends.

Hereinafter, the two arithmetic circuit units 5 that are in the pre-stage-to-post-stage relationship, in which the equal-length wiring configuration is realized, will be expressed as the two arithmetic circuit units 5 configured as the “first arithmetic circuit unit” and the “second arithmetic circuit unit” in some cases.

FIG. 33 is a schematic diagram showing another configuration example of the inference apparatus. It should be noted that the illustrations of the circuit configuration preceding the D/A converter 36 and the circuit configuration following the A/D converter 40 are omitted.

Regarding an inference apparatus 400 shown in FIG. 33, a network circuit in which four arithmetic circuit units 76a to 76d are connected in four stages is realized.

The ReLU circuits 37 and the enlargement circuit 38 are arranged between the arithmetic circuit units that are in the pre-stage-to-post-stage relationship.

The difference circuit 39 is arranged between the arithmetic circuit unit 76d in the last stage and the A/D converter 40.

The present technology can also be applied to such an inference apparatus 400.

For example, it is sufficient that the equal-length wiring configuration is realized with respect to at least a pair of two arithmetic circuit units that are in the pre-stage-to-post-stage relationship, which are two arithmetic circuit units of the four arithmetic circuit units 76a to 76d.

That is, it is sufficient that the at least a pair of two arithmetic circuit units that are in the pre-stage-to-post-stage relationship, out of the four arithmetic circuit units 76a to 76d, is configured as the “first arithmetic circuit unit” and the “second arithmetic circuit unit”.

As a matter of course, the equal-length wiring configuration may be realized with respect to all the pairs of two arithmetic circuit units that are in the pre-stage-to-post-stage relationship and those pairs may be configured as the “first arithmetic circuit unit” and the “second arithmetic circuit unit”. In this case, the realized equal-length wiring configurations themself do not need to be the same configuration. For example, the equal-length wiring configurations may be selected as appropriate from the variations illustrated in FIGS. 30 and 31 and may be realized.

It should be noted that the two arithmetic circuit units that are in the pre-stage-to-post-stage relationship can also be expressed as follows.

Two arithmetic circuit units of the plurality of arithmetic circuit units, which are in such a relationship that the multiply-accumulate signals output from the plurality of output lines of one arithmetic circuit unit of two arithmetic circuit units or signals generated on the basis of the multiply-accumulate signals output from the plurality of output lines of the one arithmetic circuit unit of the two arithmetic circuit units are input into the plurality of input lines of another arithmetic circuit unit of the two arithmetic circuit units as the electrical signals corresponding to the input values.

At least a pair of two arithmetic circuit units that is in such a relationship may be configured as the “first arithmetic circuit unit” and the “second arithmetic circuit unit”.

The present technology can be applied to an arithmetic apparatus including two or more arbitrary number of arithmetic circuit units.

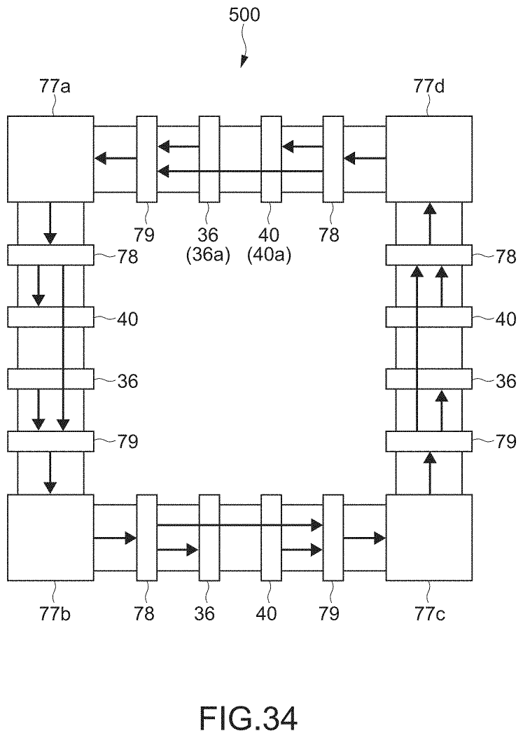

In an inference apparatus 500 shown in FIG. 34, a network circuit in which four arithmetic circuit units 77a to 77d are connected in a ring form is realized.

An output switch 78, an A/D converter 40, a D/A converter 36, and an input switch 79 are arranged between arithmetic circuit units that are in the pre-stage-to-post-stage relationship.

Referring to circuits between the arithmetic circuit units 77a and 77b that are in the pre-stage-to-post-stage relationship, the output switch 78 is capable of switching an output destination of a multiply-accumulate result signal from the arithmetic circuit unit 77a to any one of the A/D converter 40 and the input switch 79. The input switch 79 switches either the output from the D/A converter 36 or the output from the output switch 78 and outputs a signal to the arithmetic circuit unit 77b.

The configurations between the other two arithmetic circuit units that are in the pre-stage-to-post-stage relationship are similar.

That is, in the inference apparatus 500, whether to connect the output of the arithmetic circuit unit in the pre-stage to the arithmetic circuit unit in the post-stage directly or to output a signal through the D/A converter 40 can be selected in all the positions between the arithmetic circuit units 77a and 77b, between the arithmetic circuit units 77b and 77c, between the arithmetic circuit units 77c and 77d, and between the arithmetic circuit units 77d and 77a.

Moreover, data that is an analogical target, such as pixel data, can be input in any one of the positions between the arithmetic circuit units 77a and 77b, between the arithmetic circuit units 77b and 77c, between the arithmetic circuit units 77c and 77d, and between the arithmetic circuit units 77d and 77a via the D/A converter 36.

It should be noted that the ReLU circuits, the enlargement circuits, the difference circuits, and the like may be arranged as appropriate.

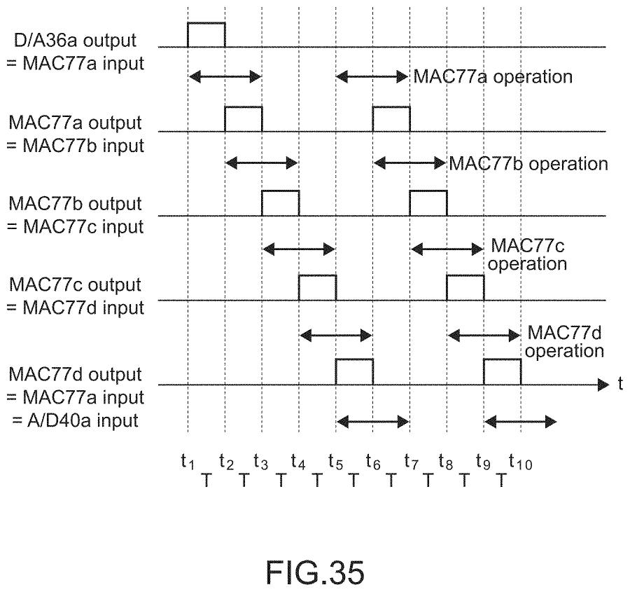

FIG. 35 is a timing chart showing an operation example at the time of inference by the inference apparatus 500.

Here, a case where data is input into the inference apparatus 500 from a D/A converter 36a located between the arithmetic circuit units 77d and 77a, loops twice, and is output from an A/D converter 40a will be taken as an example.

Time from t1 to t2: The output from the D/A converter 36a is input into the arithmetic circuit unit 77a.

Time from t2 to t3: The output from the arithmetic circuit unit 77a is input into the arithmetic circuit unit 77b.

Time from t3 to t4: The output from the arithmetic circuit unit 77b is input into the arithmetic circuit unit 77c.

Time from t4 to t5: The output from the arithmetic circuit unit 77c is input into the arithmetic circuit unit 77d.

Time from t5 to t6: The output from the arithmetic circuit unit 77d is input into the arithmetic circuit unit 77a.

Time from t6 to t7: The output from the arithmetic circuit unit 77a is input into the arithmetic circuit unit 77b.

Time from t7 to t8: The output from the arithmetic circuit unit 77b is input into the arithmetic circuit unit 77c.

Time from t8 to t9: The output from the arithmetic circuit unit 77c is input into the arithmetic circuit unit 77d.

Time from t9 to t10: The output from the arithmetic circuit unit 77d is input into the A/D converter 40a.

As shown in FIG. 35, regarding each arithmetic circuit unit, there is a non-operation time in which the arithmetic circuit unit is out of operation. For example, as for the arithmetic circuit unit 77a, a period of from t3 to t5 is the non-operation time.

Each arithmetic circuit unit update the weight values through a writing circuit or the like (not shown) during the non-operation time. Accordingly, arithmetic circuit units to which different weight values are set can be continuously connected unlike simple loops.

Moreover, the number of output/input signals can also be reduced when it is equal or smaller than the number of inputs/outputs of each arithmetic circuit unit.

The present technology can also be applied to such an inference apparatus 500.

For example, it is sufficient that the equal-length wiring configurations are realized with respect to the at least a pair of two arithmetic circuit units that are in the pre-stage-to-post-stage relationship, out of the four arithmetic circuit units 77a to 77d, and the pair is configured as the “first arithmetic circuit unit” and the “second arithmetic circuit unit”.

As a matter of course, the equal-length wiring configurations may be realized with respect to all the pairs of two arithmetic circuit units that are in the pre-stage-to-post-stage relationship and the pairs may be configured as the “first arithmetic circuit unit” and the “second arithmetic circuit unit”.

Accordingly, the above-mentioned effects are exerted.

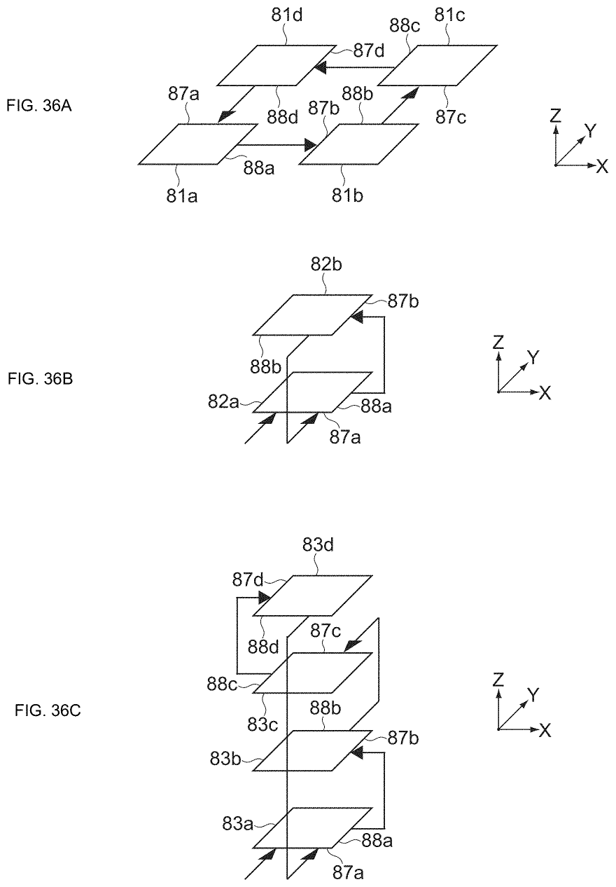

FIGS. 36 to 38 are schematic diagrams showing variation examples of the arrangement configuration of the plurality of arithmetic circuit units, which are other configuration examples of the arithmetic apparatus according to the present technology.

As to the arithmetic apparatus to be described below, a plurality of input lines and a plurality of output lines are arranged in each of arithmetic circuit units 81 to 86, using a predetermined plane as a reference plane. Conversely, the plane on which the plurality of input lines and the plurality of output lines that intersects with the plurality of input lines are arranged can also be referred to as the reference plane.

The reference plane can be arbitrarily set to the inside of a three-dimensional space.

Hereinafter, an XYZ-coordinate system is newly set to the three-dimensional space. This coordinate system is not related to the coordinate system shown in FIG. 29 and the like.

Moreover, in each of the arithmetic circuit units 81 to 86, a side on which analog signals are input will be referred to as an input edge 87. The input edge 87 corresponds to a position at which the end portions of the plurality of input lines are arranged side by side and is not always configured to have a straight line shape.

FIGS. 36 to 38 show the arrows toward the input edge 87. The extending direction of the line of each of the arrows in contact with the input edges 87 is a signal input direction and is an extending direction of the plurality of input lines.

Moreover, in each of the arithmetic circuit units 81 to 86, a side on which the multiply-accumulate signal is output will be referred to as an output edge 88. The output edge 88 corresponds to a position at which the end portions of the plurality of output lines are arranged side by side and is not always configured to have a straight line shape.

FIGS. 36 to 38 show the arrows from the output edge 88. The direction of the line of each of the arrows in contact with the output edge 88 is a signal output direction and is an extending direction of the plurality of output lines.

In the example shown in FIG. 36A, four arithmetic circuit units 81a to 81d are configured using the plane parallel to an XY-plane as the reference plane. That is, in each arithmetic circuit unit, the plurality of input lines and the plurality of output lines are arranged on a plane parallel to the XY-plane.

The four arithmetic circuit units 81a to 81d are arranged on the same plane. That is, the four arithmetic circuit units 81a to 81d are configured such that the respective reference planes are positioned on the same plane.

The following pairs of arithmetic circuit units are configured as the “first arithmetic circuit unit” and the “second arithmetic circuit unit”. It should be noted that (→) denotes the output direction of analog signals.

Arithmetic circuit unit 81a→Arithmetic circuit unit 81b

Arithmetic circuit unit 81b→Arithmetic circuit unit 81c

Arithmetic circuit unit 81c→Arithmetic circuit unit 81d

Arithmetic circuit unit 81d→Arithmetic circuit unit 81a

Here, the reference plane of the “first arithmetic circuit unit” will be referred to as a first reference plane and the reference plane of the “second arithmetic circuit unit” will be referred to as a second reference plane. Then, the arithmetic apparatus shown in FIG. 36A has a configuration in which the first reference plane and the second reference plane are positioned on the same plane.

The configuration example of FIG. 36A has a configuration capable of looping analog signals and repeating the input/output as in the inference apparatus 500 shown in FIG. 34.

As a matter of course, the present technology is not limited to the configuration capable of looping, and a configuration in which once analog signals pass through the arranged arithmetic circuit units, the analog signals are output via the A/D converter may be employed.

The same applies to each of the arithmetic apparatuses illustrated in FIGS. 36 to 38.

In the example shown in FIG. 36B, two arithmetic circuit units 82a and 82b are configured using the plane parallel to the XY-plane as the reference plane.

The arithmetic circuit units 82a and 82b are arranged side-by-side in the Z direction that is a direction of a normal line with respect to the reference plane. That is, a double-stage configuration in which the two arithmetic circuit units 82a and 82b are stacked in the height direction is provided.

As shown in FIG. 36B, a signal is input from an input edge 87a on the front side of the arithmetic circuit unit 82a in the first stage and is output from an output edge 88a on the right-hand side. The output signal input into an input edge 87b on the right-hand side of the arithmetic circuit unit 82b in the second stage via a vertical wire. The input signal is output from an output edge 88b on the front side of the arithmetic circuit unit 82b in the second stage and is input into the input edge 87a of the arithmetic circuit unit 82a in the first stage via a vertical wire.

The arithmetic circuit units 82a and 82b are configured as the “first arithmetic circuit unit” and the “second arithmetic circuit unit”. Thus, the arithmetic apparatus shown in FIG. 36B has a configuration in which the first reference plane and the second reference plane are arranged to be parallel to each other.

In the example shown in FIG. 36C, four arithmetic circuit units 83a to 83d are configured using the plane parallel to the XY-plane as the reference plane.

The arithmetic circuit units 83a to 83d are arranged side-by-side in the Z direction that is a direction of a normal line with respect to the reference plane. That is, a four-stage configuration in which the four arithmetic circuit units 83a to 83d are stacked in the height direction is provided.

As shown in FIG. 36C, a path for analog signals is as follows.

(1) Input into the input edge 87a on the front side of the arithmetic circuit unit 83a in the first stage

(2) Output from the output edge 88a on the right-hand side of the arithmetic circuit unit 83a in the first stage

(3) Input into the input edge 87b on the right-hand side of the arithmetic circuit unit 83b in the second stage via a vertical wire

(4) Output from the output edge 88b on the deep side of the arithmetic circuit unit 83b in the second stage

(5) Input into an input edge 87c on the deep side of the arithmetic circuit unit 83c in the third stage via a vertical wire

(6) Output from an output edge 88c on the left-hand side of the arithmetic circuit unit 83c in the third stage

(7) Input into the input edge 87ad on the left-hand side of the arithmetic circuit unit 83d in the fourth stage via a vertical wire

(8) Output from an output edge 88d on the front side of the arithmetic circuit unit 83d in the fourth stage

(9) Input into the input edge 87a on the front side of the arithmetic circuit unit 83a in the first stage via a vertical wire

It should be noted that the wire connecting the arithmetic circuit unit 83a in the first stage and the arithmetic circuit unit 83b in the second stage and the wire connecting the arithmetic circuit unit 83c in the third stage and the arithmetic circuit unit 83d in the fourth stage may be left or may be right.

Moreover, simplification and shortening of the analog wires can be achieved by setting the wire connecting the arithmetic circuit unit 83d in the fourth stage and the arithmetic circuit unit 83a in the first stage and the wire connecting the arithmetic circuit unit 83b in the second stage and the arithmetic circuit unit 83c in the third stage to pass through the edges opposite to each other, respectively.

The following pairs of arithmetic circuit units are configured as the “first arithmetic circuit unit” and the “second arithmetic circuit unit”.

Arithmetic circuit unit 83a→Arithmetic circuit unit 83b

Arithmetic circuit unit 83b→Arithmetic circuit unit 83c

Arithmetic circuit unit 83c→Arithmetic circuit unit 83d

Arithmetic circuit unit 83d→Arithmetic circuit unit 83a

Thus, the arithmetic apparatus shown in FIG. 36C has a configuration in which the first reference plane and the second reference plane are arranged to be parallel to each other.

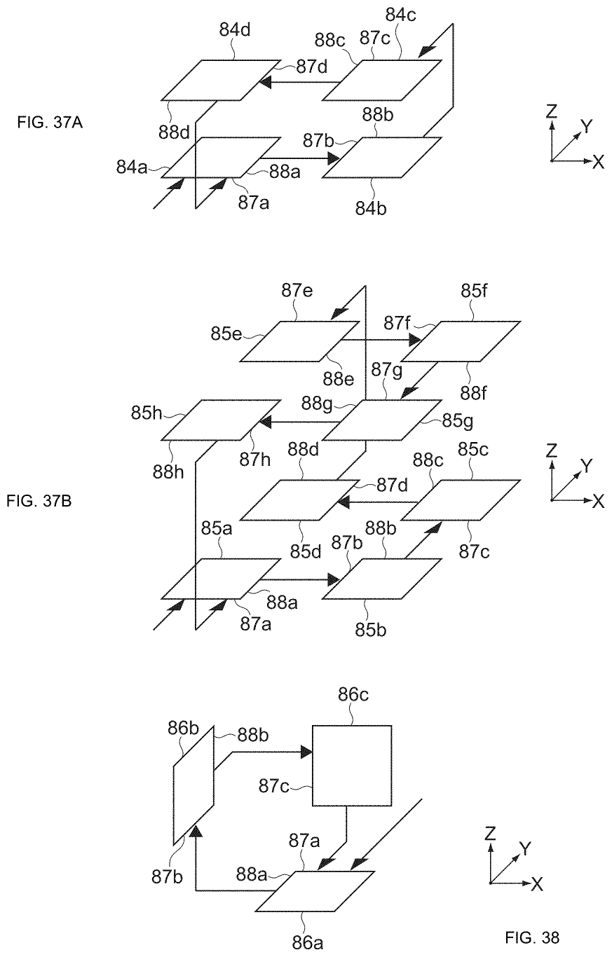

In the example shown in FIG. 37A, four arithmetic circuit units 84a to 84d are configured using the plane parallel to the XY-plane as the reference plane.

The arithmetic circuit units 84a and 84b are arranged on the same plane.

The arithmetic circuit units 84d and 84c are arranged on the same plane.

The arithmetic circuit units 84a and 84d and the arithmetic circuit units 84b and 84c are arranged side-by-side in the Z direction that is a direction of a normal line with respect to the reference plane.

That is, in this example, a configuration in which four arithmetic circuit units arranged side by side on the same plane are stacked in two stages in the height direction is provided.

As shown in FIG. 37A, a path for analog signals is as follows.

(1) Input into the input edge 87a on the front side of the arithmetic circuit unit 84a on the left-hand side in the first stage

(2) Output from the output edge 88a on the right-hand side of the arithmetic circuit unit 84a on the left-hand side in the first stage

(3) Input into the input edge 87b on the left-hand side of the arithmetic circuit unit 84b on the right-hand side in the first stage

(4) Output from the output edge 88b on the deep side of the arithmetic circuit unit 84b on the right-hand side in the first stage

(5) Input into the input edge 87c on the deep side of the arithmetic circuit unit 84c on the right-hand side in the second stage via a vertical wire

(6) Output from the output edge 88c on the left-hand side of the arithmetic circuit unit 84c on the right-hand side in the second stage

(7) Input into an input edge 87d on the right-hand side of the arithmetic circuit unit 84d on the left-hand side in the second stage

(8) Output from the output edge 88d on the front side of the arithmetic circuit unit 84d on the left-hand side in the second stage

(9) Input into the input edge 87a on the front side of the arithmetic circuit unit 84a on the left-hand side in the first stage via a vertical wire

The following pairs of arithmetic circuit units are configured as the “first arithmetic circuit unit” and the “second arithmetic circuit unit”.

Arithmetic circuit unit 84a→Arithmetic circuit unit 84b

Arithmetic circuit unit 84b→Arithmetic circuit unit 84c

Arithmetic circuit unit 84c→Arithmetic circuit unit 84d

Arithmetic circuit unit 84d→Arithmetic circuit unit 84a

Thus, the arithmetic apparatus shown in FIG. 37A has both a configuration in which the first reference plane and the second reference plane are positioned on the same plane and a configuration in which the first reference plane and the second reference plane are arranged to be parallel to each other.

In the example shown in FIG. 37B, eight arithmetic circuit units 85a to 85h are configured using the plane parallel to the XY-plane as the reference plane.

The four arithmetic circuit units 85a to 85d are arranged on the same plane.

The four arithmetic circuit units 85e to 85h are arranged on the same plane.

The arithmetic circuit units 85a to 85d and the arithmetic circuit units 85e to 85h are arranged side-by-side in the Z direction that is a direction of a normal line with respect to the reference plane.

That is, in this example, a configuration in which four arithmetic circuit units arranged side by side on the same plane are stacked in two stages in the height direction is provided.

As shown in FIG. 37B, a path for analog signals is as follows.

(1) Input into the input edge 87a on the front side of the arithmetic circuit unit 85a on the left front side in the first stage

(2) Output from the output edge 88a on the right-hand side of the arithmetic circuit unit 85a on the left front side in the first stage

(3) Input into the input edge 87b on the left-hand side of the arithmetic circuit unit 85b on the right front side in the first stage

(4) Output from the output edge 88b on the deep side of the arithmetic circuit unit 85b on the right front side in the first stage

(5) Input into the input edge 87c on the front side of the arithmetic circuit unit 85c on the right deep side in the first stage

(6) Output from the output edge 88c on the left-hand side of the arithmetic circuit unit 85c on the right deep side in the first stage

(7) Input into the input edge 87d on the right-hand side of the arithmetic circuit unit 85d on the left deep side in the first stage

(8) Output from an output edge 88d on the deep side of the arithmetic circuit unit 85d on the left deep side in the first stage

(9) Input into an input edge 87e on the deep side of the arithmetic circuit unit 85e on the left deep side in the second stage via a vertical wire

(10) Output from an output edge 88e on the right-hand side of the arithmetic circuit unit 85e on the left deep side in the second stage

(11) Input into an input edge 87f on the left-hand side of the arithmetic circuit unit 85f on the right deep side in the second stage

(12) Output from an output edge 88f on the front side of the arithmetic circuit unit 85f on the right deep side in the second stage

(13) Input into an input edge 87g on the deep side of the arithmetic circuit unit 85g on the right front side in the second stage

(14) Output from an output edge 88g on the left-hand side of the arithmetic circuit unit 85g on the right front side in the second stage

(15) Input into an input edge 87h on the right-hand side of the arithmetic circuit unit 85h on the left front side in the second stage

(16) Output from an output edge 88h on the front side of the arithmetic circuit unit 85h on the left front side in the second stage

(17) Input into the input edge 87a on the front side of the arithmetic circuit unit 85a on the right front side in the first stage via a vertical wire

The following pairs of arithmetic circuit units are configured as the “first arithmetic circuit unit” and the “second arithmetic circuit unit”.

Arithmetic circuit unit 85a→Arithmetic circuit unit 85b

Arithmetic circuit unit 85b→Arithmetic circuit unit 85c

Arithmetic circuit unit 85c→Arithmetic circuit unit 85d

Arithmetic circuit unit 85d→Arithmetic circuit unit 85e

Arithmetic circuit unit 85e→Arithmetic circuit unit 85f

Arithmetic circuit unit 85f→Arithmetic circuit unit 85g

Arithmetic circuit unit 85g→Arithmetic circuit unit 85h

Arithmetic circuit unit 85h→Arithmetic circuit unit 85a

Thus, the arithmetic apparatus shown in FIG. 37B has both a configuration in which the first reference plane and the second reference plane are positioned on the same plane and a configuration in which the first reference plane and the second reference plane are arranged to be parallel to each other.

In the example shown in FIG. 38A, the following three arithmetic circuit units are configured.

Arithmetic circuit unit 86a: configured using the plane parallel to the XY-plane as the reference plane

Arithmetic circuit unit 86b: configured using a plane parallel to a YZ-plane as the reference plane

Arithmetic circuit unit 86c: configured using a plane parallel to a ZX-plane as the reference plane

The arithmetic circuit unit 86b is disposed at a position that is on the left-hand side and the upper side as compared to the arithmetic circuit unit 86a.

The arithmetic circuit unit 86c is disposed at a position that is on the deep side and the upper side as compared to the arithmetic circuit unit 86a.

As shown in FIG. 38A, a path for analog signals is as follows.

(1) Input into the input edge 87a on the deep side of the arithmetic circuit unit 86a

(2) Output from the output edge 88a on the left-hand side of the arithmetic circuit unit 86a

(3) Input into the input edge 87b on the lower side of the arithmetic circuit unit 86b via a vertical wire

(4) Output from the output edge 88b on the deep side of the arithmetic circuit unit 86b

(5) Input into the input edge 87c on the left-hand side of the arithmetic circuit unit 86c via a wire extending leftward

(6) Output from the output edge 88c on the lower side of the arithmetic circuit unit 86c

(7) Input into the input edge 87a on the deep side of the arithmetic circuit unit 86a via a wire extending forward

The following pairs of arithmetic circuit units are configured as the “first arithmetic circuit unit” and the “second arithmetic circuit unit”.

Arithmetic circuit unit 86a→Arithmetic circuit unit 86b

Arithmetic circuit unit 86b→Arithmetic circuit unit 86c

Arithmetic circuit unit 86c→Arithmetic circuit unit 86a

Thus, the arithmetic apparatus shown in FIG. 36C has a configuration in which the first reference plane and the second reference plane are arranged to be perpendicular to each other.

For example, the arrangement configuration as illustrated in FIG. 38 may be realized in a case where the arithmetic circuit units can be configured in a vertical plane.

In the arithmetic apparatus illustrated in FIGS. 36 to 38, it is sufficient that at least one of the two arithmetic circuit units that are in the pre-stage-to-post-stage relationship is configured as the “first arithmetic circuit unit” and the “second arithmetic circuit unit”.

As described above, in the arithmetic apparatus according to this embodiment, the equal-length wiring configuration is realized with respect to the two arithmetic circuit units that are in the pre-stage-to-post-stage relationship. Accordingly, the operation accuracy can be improved in an analog circuit that performs a multiply-accumulate operation.

It should be noted that as in Patent Literature 1 described above, there have been literatures showing figures and the like for conceptionally describing transmission and the like of input signals or multiply-accumulate signals. However, there have been no literatures referring to actual physical arrangement configurations, wires, and the like in the design for a plurality of arithmetic circuit units.

In view of this, actual circuit configurations in an arithmetic apparatus having a plurality of arithmetic circuit units have been examined. Specifically, arrangements and wirings efficient in terms of electric power and the like when a plurality of analog arithmetic circuit units that inputs and outputs analog signals including time information corresponding to input values is mounted on the same chip have been examined.

As a result, the focus was placed on a plurality of input lines and a plurality of output lines arranged so as to intersect with each other, which were included in arithmetic circuit units, and the equal-length wiring configuration according to the present technology was newly devised.

As a matter of course, the application of the present technology is not limited to the case where the plurality of analog arithmetic circuit units is mounted on the single chip. The present technology can also be applied to a case where a plurality of analog arithmetic circuit units is mounted on a plurality of chips such as stacked chips or to a three-dimensional semiconductor, and the above-mentioned effects can be exerted.

### Other Embodiments

The present technology is not limited to the embodiment described above, and various other embodiments can be realized.

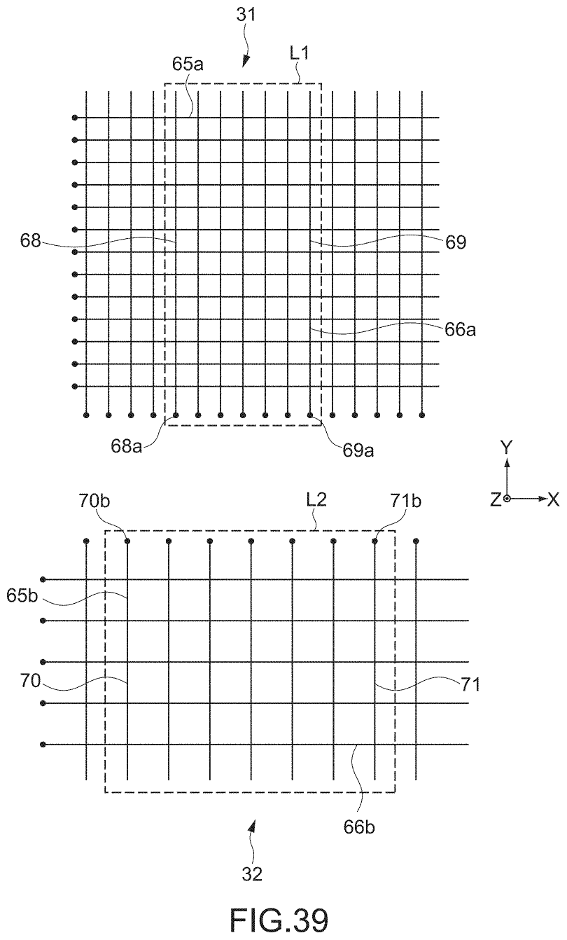

FIG. 39 is a schematic diagram for describing another embodiment of the equal-length wiring configuration.

In the arithmetic apparatus shown in FIG. 39, signal lines of signal lines included in each of the first arithmetic circuit unit 31 and the second arithmetic circuit unit 32, which are actually used for a multiply-accumulate operation, are selected as appropriate.

For example, as shown in FIG. 39, in the first arithmetic circuit unit 31, seven signal lines included in a valid region L1 are used as the plurality of output lines 66a during an actual multiply-accumulate operation. Moreover, in the second arithmetic circuit unit 32, seven signal lines included in a valid region L2 are used as the plurality of input lines 65b during an actual multiply-accumulate operation.

Then, equal-length wiring configurations according to the present technology are realized with respect to the plurality of output lines 66a and the plurality of input lines 65b, which are actually used, in the valid regions L1 and L2.

That is, the “plurality of input lines” and the “plurality of output lines” according to the present technology may be defined as signal lines of the arranged signal lines, which are used during the actual multiply-accumulate operation.

Regarding the inference apparatus 500 illustrated in FIG. 34, the fact that the number of output/input signals can be reduced when it is equal to or smaller than the number of inputs/outputs of each arithmetic circuit unit has been mentioned above. This fact is the matter that can be applied not only to the inference apparatus 500 but also to the inference apparatus 300 illustrated in FIG. 23, the inference apparatus 400 illustrated in FIG. 33, and another arbitrary inference apparatus (arithmetic apparatus) according to the present technology.

In the above description, the arithmetic apparatus according to the time-axis analog multiply-accumulate method in which information is transmitted using the timing (point of time) or the pulse width (period of time) has been exemplified. However, the present technology can also be applied to an arithmetic apparatus according to an analog multiply-accumulate method in which information is transmitted using voltage or current.

Realizing the equal-length wiring configurations with respect to the two arithmetic circuit units that are in the pre-stage-to-post-stage relationship can reduce irregularities in the delay time (wiring delay) of analog signals (current or voltage). Accordingly, a standby time until all input signals of the arithmetic circuit units become stable can be reduced and the latency can be shortened.

In the above description, the inference apparatus has been exemplified as the arithmetic apparatus including the plurality of arithmetic circuit units. The present technology is not limited thereto, and the present technology can also be applied to another arithmetic apparatus including a plurality of arithmetic circuit units.

In the above description, the case of outputting the multiply-accumulate result signal on the basis of the timing at which the voltage retained by the accumulation unit increases beyond the threshold value has been exemplified. However, a configuration to output the multiply-accumulate result signal on the basis of the timing at which the voltage retained by the accumulation unit decreases beyond the threshold voltage may be employed. For example, charging is performed in advance until the voltage of the capacitor that functions as the accumulation unit reaches a predetermined preset value. After the sum of charges each corresponding to the product value of the signal value and the weight value is accumulated, the capacitor is discharged at a predetermined rate. In such a case, the multiply-accumulate result signal can be output on the basis of a timing at which the voltage retained by the capacitor decreases below the threshold value. As a matter of course, the present technology is not limited to such a configuration. It should be noted that in the present disclosure, discharging the capacitor is included in charging the capacitor with negative charges.

In the above description, the case where the pair of output lines is used has been described. The present technology is not limited thereto, and three or more output lines may be provided. That is, the present technology described above can be applied also in a case where one or more any number of output lines are used. For example, the multiplication unit includes a resistor that is connected between an associated input line and any one of the one or more output lines and defines a weight value, and outputs a charge corresponding to the product value to the output line to which the resistor is connected. As a matter of course, the present technology is not limited thereto.

The configurations of the arithmetic apparatus, the multiply-accumulate devices, the analog circuits, the synapse circuits, the neuron circuits, the equal-length wiring configurations, and the like, the method of generating multiply-accumulate result signals, and the like described above with reference to the drawings are merely an embodiment, and can be arbitrarily modified without departing from the gist of the present technology. That is, any other configurations, methods, and the like for carrying out the present technology may be employed.

In the present disclosure, concepts defining the shape, the size, the positional relationship, the state, and the like, such as “center”, “middle”, “uniform”, “equal”, “the same”, “orthogonal”, “parallel”, “perpendicular”, “symmetric”, “extending”, “axial”, “rectangular parallelepiped shape”, “curved shape”, “curve line shape”, “curve line shape”, and “lens shape”, are concepts including “substantially center”, “substantially middle”, “substantially uniform”, “substantially equal”, “substantially the same”, “substantially orthogonal”, “substantially parallel”, “substantially perpendicular”, “substantially symmetric”, “substantially extending”, “substantially axial”, “substantially rectangular parallelepiped shape”, “substantially curved surface shape”, “substantially curve line shape”, “substantially curve line shape”, “substantially lens shape” and the like.

For example, predetermined ranges (e.g., a range of error and a predetermined range of ±10%) and the like with reference to “completely center”, “completely middle”, “completely uniform”, “completely equal”, “completely the same”, “completely orthogonal”, “completely parallel”, “completely perpendicular”, “completely symmetric”, “completely extending”, “completely axial”, “completely axial”, “completely rectangular parallelepiped shape”, “completely curved surface shape”, “completely curve line shape”, “completely curve line shape”, “completely lens shape” and the like are also included.

At least two of the features of the present technology described above may be combined. In other words, various features described in the respective embodiments may be arbitrarily combined across the embodiments. Moreover, the various effects described above are not limitative but are merely illustrative, and other effects may be provided.

It should be noted that the present technology can also take the following configurations.

(1) An arithmetic apparatus, including

a plurality of arithmetic circuit units each including
a plurality of input lines which is arranged in parallel using a predetermined direction as an extending direction and into which electrical signals corresponding to input values are respectively input, and
a plurality of output lines which is arranged in parallel so as to intersect with the plurality of input lines, using a direction different from the predetermined direction as an extending direction, and each of which outputs a multiply-accumulate signal representing a sum of product values obtained by multiplying the input values, which are generated on the basis of the electrical signals input into the plurality of input lines, by weight values, in which

the plurality of arithmetic circuit units includes a first arithmetic circuit unit and a second arithmetic circuit unit,

the multiply-accumulate signals output from the plurality of output lines of the first arithmetic circuit unit or signals generated on the basis of the multiply-accumulate signals output from the plurality of output lines of the first arithmetic circuit unit are input into the plurality of input lines of the second arithmetic circuit unit as the electrical signals corresponding to the input values,

a first direction that is the extending direction of the plurality of input lines of the first arithmetic circuit unit and a second direction that is the extending direction of the plurality of output lines of the second arithmetic circuit unit are configured to be parallel to each other, and

assuming that end portions of two endmost output lines, which are located at endmost positions of the plurality of output lines arranged in parallel in the first arithmetic circuit unit, are defined as a first end portion and a second end portion and end portions of two endmost input lines, which are located at endmost positions of the plurality of input lines arranged in parallel in the second arithmetic circuit unit, are defined as a third end portion and a fourth end portion, the end portions of the two endmost output lines being located on a side of the second arithmetic circuit unit, the end portions of the two endmost input lines being located on a side of the first arithmetic circuit unit,
a position in the first direction of at least one of the first end portion or the second end portion is configured to be a position between a position in the first direction of the third end portion and a position in the first direction of the fourth end portion

or
a position in the first direction of at least one of the third end portion or the fourth end portion is configured to be a position between a position in the first direction of the first end portion and a position in the first direction of the second end portion.
   (2) The arithmetic apparatus according to (1), in which

both the position in the first direction of the first end portion and the position in the first direction of the second end portion are configured to be positions between the position in the first direction of the third end portion and the position in the first direction of the fourth end portion.

(3) The arithmetic apparatus according to (1), in which

both the position in the first direction of the third end portion and the position in the first direction of the fourth end portion are configured to be positions between the position in the first direction of the first end portion and the position in the first direction of the second end portion.

(4) The arithmetic apparatus according to any one of (1) to (3), in which

a position in the first direction of at least one of the first end portion or the second end portion is configured to be a position different from both of the position in the first direction of the third end portion and the position in the first direction of the fourth end portion.

(5) The arithmetic apparatus according to any one of (1) to (4), in which

a position in the first direction of at least one of the third end portion or the fourth end portion is configured to be a position different from both of the position in the first direction of the first end portion and the position in the first direction of the second end portion.

(6) The arithmetic apparatus according to any one of (1) to (5), in which

the extending direction of the plurality of output lines of the first arithmetic circuit unit and the extending direction of the plurality of input lines of the second arithmetic circuit unit are configured to be parallel to each other.

(7) The arithmetic apparatus according to any one of (1) to (6), in which

two arithmetic circuit units of the plurality of arithmetic circuit units, which are in such a relationship that the multiply-accumulate signals output from the plurality of output lines of one arithmetic circuit unit of two arithmetic circuit units or signals generated on the basis of the multiply-accumulate signals output from the plurality of output lines of the one arithmetic circuit unit of the two arithmetic circuit units are input into the plurality of input lines of another arithmetic circuit unit of the two arithmetic circuit units as the electrical signals corresponding to the input values, are configured as the first arithmetic circuit unit and the second arithmetic circuit unit.

(8) The arithmetic apparatus according to any one of (1) to (7), in which

in each of the plurality of arithmetic circuit units, the plurality of input lines and the plurality of output lines are arranged using a predetermined plane as a reference plane, and a first reference plane that is the reference plane of the first arithmetic circuit unit and a second reference plane that is the reference plane of the second arithmetic circuit unit are positioned on a same plane.

(9) The arithmetic apparatus according to any one of (1) to (7), in which

in each of the plurality of arithmetic circuit units, the plurality of input lines and the plurality of output lines are arranged using a predetermined plane as a reference plane, and a first reference plane that is the reference plane of the first arithmetic circuit unit and a second reference plane that is the reference plane of the second arithmetic circuit unit are arranged to be parallel to each other.

(10) The arithmetic apparatus according to any one of (1) to (7), in which

in each of the plurality of arithmetic circuit units, the plurality of input lines and the plurality of output lines are arranged using a predetermined plane as a reference plane, and a first reference plane that is the reference plane of the first arithmetic circuit unit and a second reference plane that is the reference plane of the second arithmetic circuit unit are arranged to be perpendicular to each other.

(11) The arithmetic apparatus according to any one of (1) to (10), in which

in each of the plurality of arithmetic circuit units, end portions on an input side of the plurality of input lines are located in a same straight line and end portions on an output side of the plurality of output lines are located on a same straight line, and

a straight line direction in which the end portions on the output side of the plurality of output lines of the first arithmetic circuit unit are arranged side by side and a straight line direction in which the end portions on the input side of the plurality of input lines of the second arithmetic circuit unit are arranged side by side are configured to be parallel to each other.

(12) The arithmetic apparatus according to any one of (1) to (11), in which

pitches of the plurality of output lines arranged in parallel in the first arithmetic circuit unit and pitches of the plurality of input lines arranged in parallel in the second arithmetic circuit unit are configured to be different from each other.

(13) The arithmetic apparatus according to any one of (1) to (12), in which

each of the plurality of arithmetic circuit units includes
a plurality of multiplication units that generates, on the basis of the electrical signals respectively input into the plurality of input lines, charges corresponding to product values obtained by multiplying the input values by the weight values and outputs the charges to the output lines as the multiply-accumulate signals,
an accumulation unit that accumulates the charges corresponding to the product values respectively output to the output lines by the plurality of multiplication units,
a charging unit that charges the accumulation unit in which the charges corresponding to the product values are accumulated, and
an output unit that performs, after the charging unit starts charging, threshold determination on a voltage retained by the accumulation unit with a predetermined threshold, to thereby output a multiply-accumulate result signal including information regarding a timing corresponding to a sum of the product values obtained by multiplying the input values by the weight values.
   (14) The arithmetic apparatus according to (13), in which

a positive charge output line and a negative charge output line are arranged as the output lines,

the plurality of multiplication units includes at least one of a positive weight multiplication unit that generates a positive weight charge corresponding to a product value obtained by multiplying the input value by a positive weight value and outputs the positive weight charge to the positive charge output line as the multiply-accumulate signal or a negative weight multiplication unit that generates a negative weight charge corresponding to a product value obtained by multiplying the input value by a negative weight value and outputs the negative weight charge to the negative charge output line as the multiply-accumulate signal,

the accumulation unit includes a positive charge accumulation unit capable of accumulating the positive weight charge output to the positive charge output line by the positive weight multiplication unit and a negative charge accumulation unit capable of accumulating the negative weight charge output to the negative charge output line by the negative weight multiplication unit,

the charging unit charges the positive charge accumulation unit and the negative charge accumulation unit, and

the output unit performs threshold determination with respect to each of the positive charge accumulation unit and the negative charge accumulation unit with the predetermined threshold, to thereby output the multiply-accumulate result signal.

(15) A multiply-accumulate system, including:

a plurality of arithmetic circuit units each including
a plurality of input lines which is arranged in parallel using a predetermined direction as an extending direction and into which electrical signals corresponding to input values are respectively input, and
a plurality of output lines which is arranged in parallel so as to intersect with the plurality of input lines, using a direction different from the predetermined direction as an extending direction, and each of which outputs a multiply-accumulate signal representing a sum of product values obtained by multiplying the input values, which are generated on the basis of the electrical signals input into the plurality of input lines, by weight values; and

a network circuit configured by connecting the plurality of arithmetic circuit units, in which

the plurality of arithmetic circuit units includes a first arithmetic circuit unit and a second arithmetic circuit unit,

the multiply-accumulate signals output from the plurality of output lines of the first arithmetic circuit unit or signals generated on the basis of the multiply-accumulate signals output from the plurality of output lines of the first arithmetic circuit unit are input into the plurality of input lines of the second arithmetic circuit unit as the electrical signals corresponding to the input values,

a first direction that is the extending direction of the plurality of input lines of the first arithmetic circuit unit and a second direction that is the extending direction of the plurality of output lines of the second arithmetic circuit unit are configured to be parallel to each other, and

assuming that end portions of two endmost output lines, which are located at endmost positions of the plurality of output lines arranged in parallel in the first arithmetic circuit unit, are defined as a first end portion and a second end portion and end portions of two endmost input lines, which are located at endmost positions of the plurality of input lines arranged in parallel in the second arithmetic circuit unit, are defined as a third end portion and a fourth end portion, the end portions of the two endmost output lines being located on a side of the second arithmetic circuit unit, the end portions of the two endmost input lines being located on a side of the first arithmetic circuit unit,
a position in the first direction of at least one of the first end portion or the second end portion is configured to be a position between a position in the first direction of the third end portion and a position in the first direction of the fourth end portion

or
a position in the first direction of at least one of the third end portion or the fourth end portion is configured to be a position between a position in the first direction of the first end portion and a position in the first direction of the second end portion.

### REFERENCE SIGNS LIST

T input period
θ threshold
P1 signal line pair
P7 input signal line pair
1 signal line
3 analog circuit
5 arithmetic circuit unit
7 input signal line
7a positive input signal line
7b negative input signal line
8 charge output line
8a positive charge output line
8b negative charge output line
9 synapse circuit
10 neuron circuit
11 accumulation unit
12 signal output unit
15 charging unit
17 resistor
23 signal generation unit
31 first arithmetic circuit unit
32 second arithmetic circuit unit
65a, 65b plurality of input lines
66a, 66b plurality of output lines
68, 69 endmost output line
68a first end portion
69a second end portion
70, 71 endmost input line
70b third end portion
71b fourth end portion
74 equal-length wiring region
76a to 76d, 77a to 77d, 81 to 86 arithmetic circuit unit
100, 200 arithmetic apparatus
300, 400, 500 inference apparatus

1. An arithmetic apparatus, comprising
a plurality of arithmetic circuit units each including
a plurality of input lines which is arranged in parallel using a predetermined direction as an extending direction and into which electrical signals corresponding to input values are respectively input, and
a plurality of output lines which is arranged in parallel so as to intersect with the plurality of input lines, using a direction different from the predetermined direction as an extending direction, and each of which outputs a multiply-accumulate signal representing a sum of product values obtained by multiplying the input values, which are generated on a basis of the electrical signals input into the plurality of input lines, by weight values, wherein
the plurality of arithmetic circuit units includes a first arithmetic circuit unit and a second arithmetic circuit unit,
the multiply-accumulate signals output from the plurality of output lines of the first arithmetic circuit unit or signals generated on a basis of the multiply-accumulate signals output from the plurality of output lines of the first arithmetic circuit unit are input into the plurality of input lines of the second arithmetic circuit unit as the electrical signals corresponding to the input values,
a first direction that is the extending direction of the plurality of input lines of the first arithmetic circuit unit and a second direction that is the extending direction of the plurality of output lines of the second arithmetic circuit unit are configured to be parallel to each other, and
assuming that end portions of two endmost output lines, which are located at endmost positions of the plurality of output lines arranged in parallel in the first arithmetic circuit unit, are defined as a first end portion and a second end portion and end portions of two endmost input lines, which are located at endmost positions of the plurality of input lines arranged in parallel in the second arithmetic circuit unit, are defined as a third end portion and a fourth end portion, the end portions of the two endmost output lines being located on a side of the second arithmetic circuit unit, the end portions of the two endmost input lines being located on a side of the first arithmetic circuit unit,
a position in the first direction of at least one of the first end portion or the second end portion is configured to be a position between a position in the first direction of the third end portion and a position in the first direction of the fourth end portion
or
a position in the first direction of at least one of the third end portion or the fourth end portion is configured to be a position between a position in the first direction of the first end portion and a position in the first direction of the second end portion.

2. The arithmetic apparatus according to claim 1, wherein
both the position in the first direction of the first end portion and the position in the first direction of the second end portion are configured to be positions between the position in the first direction of the third end portion and the position in the first direction of the fourth end portion.

3. The arithmetic apparatus according to claim 1, wherein
both the position in the first direction of the third end portion and the position in the first direction of the fourth end portion are configured to be positions between the position in the first direction of the first end portion and the position in the first direction of the second end portion.

4. The arithmetic apparatus according to claim 1, wherein
a position in the first direction of at least one of the first end portion or the second end portion is configured to be a position different from both of the position in the first direction of the third end portion and the position in the first direction of the fourth end portion.

5. The arithmetic apparatus according to claim 1, wherein
a position in the first direction of at least one of the third end portion or the fourth end portion is configured to be a position different from both of the position in the first direction of the first end portion and the position in the first direction of the second end portion.

6. The arithmetic apparatus according to claim 1, wherein
the extending direction of the plurality of output lines of the first arithmetic circuit unit and the extending direction of the plurality of input lines of the second arithmetic circuit unit are configured to be parallel to each other.

7. The arithmetic apparatus according to claim 1, wherein
two arithmetic circuit units of the plurality of arithmetic circuit units, which are in such a relationship that the multiply-accumulate signals output from the plurality of output lines of one arithmetic circuit unit of two arithmetic circuit units or signals generated on a basis of the multiply-accumulate signals output from the plurality of output lines of the one arithmetic circuit unit of the two arithmetic circuit units are input into the plurality of input lines of another arithmetic circuit unit of the two arithmetic circuit units as the electrical signals corresponding to the input values, are configured as the first arithmetic circuit unit and the second arithmetic circuit unit.

8. The arithmetic apparatus according to claim 1, wherein
in each of the plurality of arithmetic circuit units, the plurality of input lines and the plurality of output lines are arranged using a predetermined plane as a reference plane, and
a first reference plane that is the reference plane of the first arithmetic circuit unit and a second reference plane that is the reference plane of the second arithmetic circuit unit are positioned on a same plane.

9. The arithmetic apparatus according to claim 1, wherein
in each of the plurality of arithmetic circuit units, the plurality of input lines and the plurality of output lines are arranged using a predetermined plane as a reference plane, and
a first reference plane that is the reference plane of the first arithmetic circuit unit and a second reference plane that is the reference plane of the second arithmetic circuit unit are arranged to be parallel to each other.

10. The arithmetic apparatus according to claim 1, wherein
in each of the plurality of arithmetic circuit units, the plurality of input lines and the plurality of output lines are arranged using a predetermined plane as a reference plane, and
a first reference plane that is the reference plane of the first arithmetic circuit unit and a second reference plane that is the reference plane of the second arithmetic circuit unit are arranged to be perpendicular to each other.

11. The arithmetic apparatus according to claim 1, wherein
in each of the plurality of arithmetic circuit units, end portions on an input side of the plurality of input lines are located in a same straight line and end portions on an output side of the plurality of output lines are located on a same straight line, and
a straight line direction in which the end portions on the output side of the plurality of output lines of the first arithmetic circuit unit are arranged side by side and a straight line direction in which the end portions on the input side of the plurality of input lines of the second arithmetic circuit unit are arranged side by side are configured to be parallel to each other.

12. The arithmetic apparatus according to claim 1, wherein
pitches of the plurality of output lines arranged in parallel in the first arithmetic circuit unit and pitches of the plurality of input lines arranged in parallel in the second arithmetic circuit unit are configured to be different from each other.

13. The arithmetic apparatus according to claim 1, wherein
each of the plurality of arithmetic circuit units includes
a plurality of multiplication units that generates, on a basis of the electrical signals respectively input into the plurality of input lines, charges corresponding to product values obtained by multiplying the input values by the weight values and outputs the charges to the output lines as the multiply-accumulate signals,
an accumulation unit that accumulates the charges corresponding to the product values respectively output to the output lines by the plurality of multiplication units,
a charging unit that charges the accumulation unit in which the charges corresponding to the product values are accumulated, and
an output unit that performs, after the charging unit starts charging, threshold determination on a voltage retained by the accumulation unit with a predetermined threshold, to thereby output a multiply-accumulate result signal including information regarding a timing corresponding to a sum of the product values obtained by multiplying the input values by the weight values.

14. The arithmetic apparatus according to claim 13, wherein
a positive charge output line and a negative charge output line are arranged as the output lines,
the plurality of multiplication units includes at least one of a positive weight multiplication unit that generates a positive weight charge corresponding to a product value obtained by multiplying the input value by a positive weight value and outputs the positive weight charge to the positive charge output line as the multiply-accumulate signal or a negative weight multiplication unit that generates a negative weight charge corresponding to a product value obtained by multiplying the input value by a negative weight value and outputs the negative weight charge to the negative charge output line as the multiply-accumulate signal,
the accumulation unit includes a positive charge accumulation unit capable of accumulating the positive weight charge output to the positive charge output line by the positive weight multiplication unit and a negative charge accumulation unit capable of accumulating the negative weight charge output to the negative charge output line by the negative weight multiplication unit,
the charging unit charges the positive charge accumulation unit and the negative charge accumulation unit, and
the output unit performs threshold determination with respect to each of the positive charge accumulation unit and the negative charge accumulation unit with the predetermined threshold, to thereby output the multiply-accumulate result signal.

15. A multiply-accumulate system, comprising:
a plurality of arithmetic circuit units each including
a plurality of input lines which is arranged in parallel using a predetermined direction as an extending direction and into which electrical signals corresponding to input values are respectively input, and
a plurality of output lines which is arranged in parallel so as to intersect with the plurality of input lines, using a direction different from the predetermined direction as an extending direction, and each of which outputs a multiply-accumulate signal representing a sum of product values obtained by multiplying the input values, which are generated on a basis of the electrical signals input into the plurality of input lines, by weight values; and
a network circuit configured by connecting the plurality of arithmetic circuit units, wherein
the plurality of arithmetic circuit units includes a first arithmetic circuit unit and a second arithmetic circuit unit,
the multiply-accumulate signals output from the plurality of output lines of the first arithmetic circuit unit or signals generated on a basis of the multiply-accumulate signals output from the plurality of output lines of the first arithmetic circuit unit are input into the plurality of input lines of the second arithmetic circuit unit as the electrical signals corresponding to the input values,
a first direction that is the extending direction of the plurality of input lines of the first arithmetic circuit unit and a second direction that is the extending direction of the plurality of output lines of the second arithmetic circuit unit are configured to be parallel to each other, and
assuming that end portions of two endmost output lines, which are located at endmost positions of the plurality of output lines arranged in parallel in the first arithmetic circuit unit, are defined as a first end portion and a second end portion and end portions of two endmost input lines, which are located at endmost positions of the plurality of input lines arranged in parallel in the second arithmetic circuit unit, are defined as a third end portion and a fourth end portion, the end portions of the two endmost output lines being located on a side of the second arithmetic circuit unit, the end portions of the two endmost input lines being located on a side of the first arithmetic circuit unit,
a position in the first direction of at least one of the first end portion or the second end portion is configured to be a position between a position in the first direction of the third end portion and a position in the first direction of the fourth end portion
or
a position in the first direction of at least one of the third end portion or the fourth end portion is configured to be a position between a position in the first direction of the first end portion and a position in the first direction of the second end portion.
